(19) United States
(12) Patent Application Publication
(10) Pub. No.: US 2009/0080073 A1
(43) Pub. Date: Mar. 26, 2009

(54) Antireflection film, polarizing plate, and image display device

(75) Inventors: Kiyoshi Irita, Kanagawa (JP); Masaki Noro, Kanagawa (JP); Hiroyuki Yoneyama, Kanagawa (JP)

Correspondence Address: BUCHANAN, INGERSOLL & ROONEY PC, POST OFFICE BOX 1404, ALEXANDRIA, VA, 22313-1404, US

(73) Assignee: Fujifilm Corporation, Minato-ku, TOKYO (JP)

(21) Appl. No.: 11/887,133

(22) PCT Filed: Mar. 20, 2006
(86) PCT No.: PCT/JP2006/306050

§ 371 Date: Sep. 24, 2007

(30) Foreign Application Priority Data
Mar. 22, 2005 (JP) 2005-081784

(51) Int. Cl. G02B 1/11; B32B 7/02; C08F 290/06; C08L 27/12

(52) U.S. Cl. 359/485; 428/213; 524/544

(57) ABSTRACT

An antireflection film comprising a transparent support and a low-refractivity layer as an outermost layer, the low-refractivity layer being formed by a specific fluoropolymer-containing composition, and a polarizing plate and an image display device comprising the antireflection film.

### TECHNICAL FIELD

The present invention relates to an antireflection film, a polarizing plate comprising the antireflection film, and an image display device.

### BACKGROUND ART

In general, an antireflection film is disposed on the outermost surface of image display devices such as cathode-ray tube (CRT) display devices, plasma display panels (PDP), electroluminescent display devices (ELD) and liquid-crystal display devices (LCD). This is for preventing contrast reduction or image reflection caused by external light reflection on the displays, by reducing the reflectivity owing to the principle of optical interference thereon.

The antireflection film of the type is generally produced by forming, on a support, a low-refractivity layer having a suitable thickness and having a refractivity lower than that of the support. For realizing its low refractivity, the material for the low-refractivity layer is desired to have a refractivity as low as possible. Since the antireflection film is disposed on the outermost surface of displays, it is desired to have high scratch resistance. In order to realize high scratch resistance of thin films having a thickness of 100 nm or so, the films must have high mechanical strength and must be adhesive to underlying layers.

For lowering the refractivity of a material, there may be employed (1) a method of introducing a fluorine atom into the material, or (2) a method of lowering the density of the material (by introducing pores into the material). However, these are problematic in that the film strength and the interfacial adhesiveness may lower and the film scratch resistance tends to lower, and therefore, it is a difficult problem to satisfy both low refractivity and high scratch resistance.

For increasing the mechanical strength of films in some degree, a method of using fluorine-containing sol-gel films may be employed, as in JP-A 2002-265866 and JP-A 2002-317152. However, this has significant limitations in that (1) curing the films requires long-time heating and the production load is therefore great, and (2) the films are not resistant to saponification solution (alkali-processing solution), and therefore in TAC surface saponification, the saponification treatment could not be attained after the formation of an antireflection film.

JP-A 11-189621, JP-A 11-228631 and JP-A 2000-313709 describe a method of improving the scratch resistance of films by introducing a polysiloxane structure into a fluorine polymer so as to lower the friction coefficient of the film surface. The method may be effective in some degree for the improvement of scratch resistance of the films, but is still unsatisfactory in that films essentially not having high strength and high interfacial adhesiveness could not be improved to have sufficient scratch resistance by the method.

JP-A 2003-222702 describes a method of forming an antireflection film by the use of a perfluoro-olefin-type fluoropolymer having a polysiloxane structure and additionally having a functional group for crosslinking reaction both introduced thereinto. According to the method, the scratch resistance of the film could be improved while the refractivity thereof is kept low within a practicable range. However, the method is still problematic in that the constitutional ratio of the perfluoro-olefin moiety, which is said to be desirable therein, could not produce satisfactory scratch resistance of the film.

WO-2004-017105A1 describes a method for improving the film strength and the interfacial adhesiveness of films and improving the scratch resistance thereof by using a fluoropolymer and inorganic particles as combined.

On the other hand, another property which an antireflection film is desired to have is stain resistance, in addition to the scratch resistance thereof. The method of introducing a polysiloxane structure into a fluoropolymer mentioned above is advantageous for forming a stain-resistant surface, since a layer distribution of the polysiloxane structure localized in the surface of the film may be formed to thereby lower the surface free energy of the film. However, the method is silent on the condition for satisfying both the scratch resistance and the stain resistance of the film produced therein, and in many cases, it is difficult to satisfy both the two properties.

### DISCLOSURE OF THE INVENTION

An object of the invention is to provide an antireflection film having a sufficient antireflection property and having improved scratch resistance and satisfactory stain resistance. Another object is to provide a polarizing plate and an image display device comprising the antireflection film.

We, the present inventors have assiduously studied and, as a result, have found that, when a fluoropolymer having a specific structure is used in forming a low-refractivity layer, then the film strength may be remarkably improved with suppressing the increase in the refractivity of the layer itself and with no limitation on thermal curing and saponification treatment taking a long time for the layer.

We have further found that, when the fluoropolymer having a specific structure is combined with inorganic particles and a monofunctional monomer, then a low-refractivity layer may be formed more favorably.

According to the invention, there are provided an antireflection film having a constitution mentioned below, a polarizing plate and an image display device, and the above-mentioned objects are thereby attained.

1. An antireflection film comprising: a transparent support, and a low-refractivity layer as an outermost layer of the antireflection film, the low-refractivity layer being formed by a fluoropolymer-containing composition, wherein the fluoropolymer is a copolymer represented by formula (1) in which its backbone chain comprises only carbon atoms:

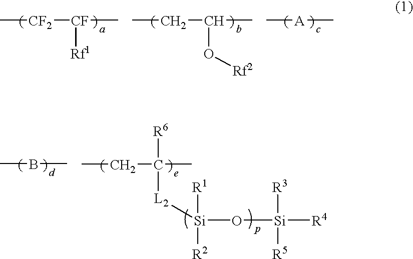

wherein Rf¹ represents a perfluoroalkyl group having from 1 to 5 carbon atoms; Rf² represents a linear, branched or alicyclic structure-having fluoroalkyl group having from 1 to 30 carbon atoms and optionally having an ether bond; A represents a constitutive unit having a reactive group capable of participating in crosslinking reaction; B represents a constitutive component; R¹ and R² may be the same or different, each representing an alkyl group or an aryl group; p indicates an integer of from 10 to 500; R³ to R⁵ each independently represent a substituted or unsubstituted monovalent organic group or a hydrogen atom; R⁶ represents a hydrogen atom or a methyl group; L₂ represents a linking group having from 1 to 20 carbon atoms, or a single bond; a to d each indicate the molar fraction (%) of the respective constitutive components except the polysiloxane-containing polymerization unit, satisfying 10≦a+b≦55, 10≦a≦55, 0≦b≦45, 10≦c≦50, 0≦d≦40; e indicates a mass fraction (%) of the polysiloxane-containing polymerization unit to the mass of all the other components, satisfying 0.01≦e≦20.

2. The antireflection film of above 1, wherein the low-refractivity layer comprises at least one type of inorganic particles having a mean particle size of from 30% to 100% of a thickness of the low-refractivity layer.

3. The antireflection film of above 2, wherein the inorganic particles are hollow silica particles having a refractive index of from 1.17 to 1.40.

4. The antireflection film of any of above 1 to 3, wherein the reactive group capable of participating in crosslinking reaction in the fluoropolymer is a (meth)acryloyl group.

5. The antireflection film of any of above 1 to 4, wherein the fluoropolymer-containing composition further comprises a monomer having a tri-functional or more poly-functional group capable of curing with ionizing radiation in one molecule.

6. The antireflection film of any of above 1 to 5,

wherein the fluoropolymer has a number-average molecular weight of 20,000 or more.

7. The antireflection film of any of above 1 to 6, further comprising at least one hard coat layer between the transparent support and the low-refractivity layer.

8. The antireflection film of above 7, wherein at least one hard coat layer is a light-diffusive layer and the light-diffusive layer is such that, in the goniophotometer scattered light profile thereof, the scattered light intensity at 30° to the light intensity at a going-out angle 0° is from 0.01 to 0.2%.

9. The antireflection film of any of above 1 to 8, which has at least one high-refractivity layer between the transparent support and the low-refractivity layer and in which the high-refractivity layer contains inorganic particles comprising essentially titanium oxide and containing at least one element selected from cobalt, aluminium and zirconium, and has a refractive index of from 1.50 to 2.40.

10. A polarizing plate comprising: a polarizer; and two protective films for protecting both sides of the polarizer, wherein one of the two protective films is an antireflection film of any of above 1 to 9.

11. The polarizing plate of above 10, wherein the film except the antireflection film of the two protective films of the polarizer is an optically-compensatory film having, on a transparent support, an optically-compensatory layer that contains an optically-anisotropic layer, and the optically-anisotropic layer comprises a compound having a discotic structure unit and has a negative birefringence, and the disc face of the discotic structure unit is inclined relative to the transparent support surface and the angle between the disc face of the discotic structure unit and the transparent support surface varies in the depth direction of the optically-anisotropic layer.

12. An image display device comprising an antireflection film of any of above 1 to 9 or an polarizing plate of any of above 10 or 11 is used as the outermost surface of a display panel.

13. An NT, STN, VA, IPS or OCB-mode transmission-type, reflection-type or semitransmission-type liquid-crystal display device having at least one polarizing plate of above 10 or 11.

### BRIEF DESCRIPTION OF THE DRAWINGS

FIGS. 1A and 1B each is a schematic cross-sectional view showing the layer constitution of an antireflection film;

FIG. 2 is a schematic cross-sectional view showing one embodiment of a die coater favorably used in the invention;

FIG. 3A is an enlarged view of the die coater of FIG. 2;

FIG. 3B is a schematic cross-sectional view showing an ordinary slot die;

FIG. 4 is a perspective view showing a slot die and around it for use in a coating step in the production method of the invention;

FIG. 5 is a cross-sectional view schematically showing a relationship between the vacuum chamber and the web in FIG. 4; and

FIG. 6 is a cross-sectional view schematically showing a relationship between the vacuum chamber and the web in FIG. 4.

1 denotes an antireflection film; 2 denotes a transparent support; 3 denotes a hard coat layer; 4 denotes an antiglare hard coat layer; 5 denotes a low-refractivity layer (outermost layer); 6 denotes a mat agent particles; 7 denotes a middle-refractivity layer; 8 denotes a high-refractivity layer; 10 denotes a coater; 11 denotes a backup roll; W denotes a web; 13 denotes a slot die; 14 denotes a coating liquid; 14a denotes a bead; 14b denotes a coating film; 15 denotes a pocket; 16 denotes a slot; 16a denotes a slot opening; 17 denotes a tip lip; 18 denotes a land; 18a denotes an upstream lip land; 18b denotes a downstream lip land; I_{UP} denotes a land length of upstream lip land 18a; I_{LO} denotes a land length of downstream lip land 18b; LO denotes an overbite length (difference between the distance from downstream lip land 18b to web W and the distance from upstream lip land 18a to web W); G_{L} denotes a gap between tip lip 17 and web W (gap between downstream lip land 18b and web W); 30 denotes an ordinary slow die; 31a denotes an upstream lip land; 31b denotes a downstream lip land; 32 denotes a pocket; 33 denotes a slot; 40 denotes a vacuum chamber; 40a denotes a back plate; 40b denotes a side plate; 40c denotes a screw; G_{B} denotes a gap between back plate 40a and web W; G_{S} denotes a gap between side plate 40b and web W.

### BEST MODE FOR CARRYING OUT THE INVENTION

The basic constitution of one preferred embodiment of the antireflection film of the invention is described with reference to the drawings attached hereto.

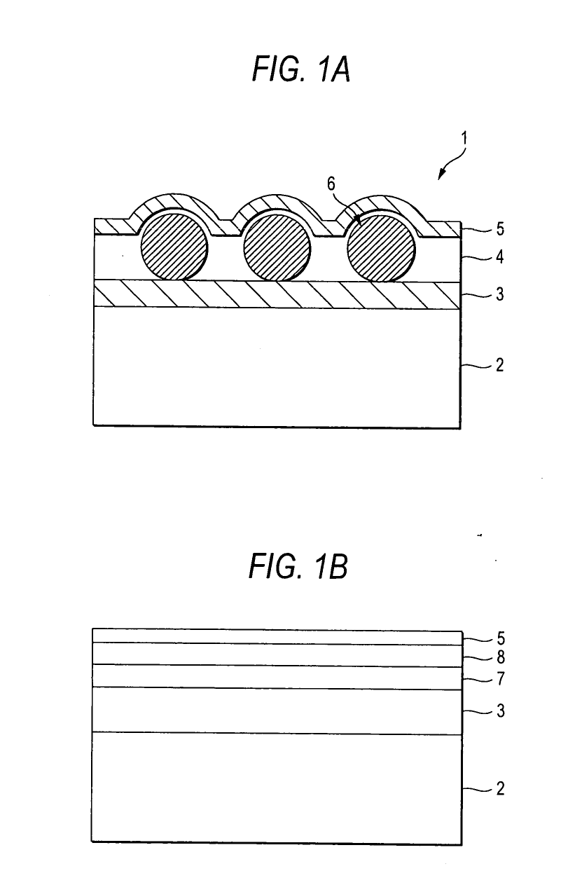

A cross-sectional view schematically shown in FIG. 1A is one example of an antireflection film of the invention. In this, the antireflection film 1 has a layer constitution comprising a transparent support 2, a hard coat layer 3, an antiglare hard coat layer 4 and a low-refractivity layer laminated in that order. The antiglare hard coat layer 4 contains mat particles 6 dispersed therein; and the part except the mat particles 6 of the antiglare hard coat layer is preferably formed of a material having a refractive index of from 1.50 to 2.00, and the refractive index of the low-refractivity layer is preferably from 1.20 to 1.49.

The hard coat layer in the invention may be such an antiglare hard coat layer or may also be a non-antiglare hard coat layer; and it may be a single layer or may have a multi-layered structure, and, for example, it may be formed of from 2 to 4 layers. The hard coat layer may not exist in the film. Accordingly, the hard coat layer 3 and the antiglare hard coat layer 4 in FIG. 1A are not indispensable, but preferably any one of these hard coat layers is formed in the film for the purpose of enhancing the mechanical strength of the film. The low-refractivity layer is formed as the outermost layer of the film.

A cross-sectional view schematically shown in FIG. 1B is another example of an antireflection film of the invention. In this, the antireflection film 1 has a layer constitution of a transparent support 2, a hard coat layer 3, a middle-refractivity layer 7, a high-refractivity layer 8 and a low-refractivity layer 5 (outermost layer) laminated in that order. The transparent support 2, the middle-refractivity layer 7, the high-refractivity layer 8 and the low-refractivity layer 5 satisfy the following relationship in point of their refractivity.

Refractive index of high-refractivity layer>refractive index of middle-refractivity layer>refractive index of transparent support>refractive index of low-refractivity layer.

In the layer constitution as in FIG. 1B, it is desirable that the middle-refractivity layer satisfies the following numerical formula (I), the high-refractivity layer satisfies the following numerical formula (II) and the low-refractivity layer satisfies the following numerical formula (III), as in JP-A 59-50401, for completing an antireflection film having a better antireflection capability.

(hλ/4)×0.7<n₁d₁<(hλ/4)×1.3 (I)

In the numerical formula (I), h indicates a positive integer (generally 1, 2 or 3); n1 indicates the refractive index of the middle-refractivity layer; and d1 indicates the layer thickness (nm) of the middle-refractivity layer. λ represents an wavelength (nm) of visible light, falling within a range of from 380 nm to 680 nm.

(iλ/4)×0.7<n₂d₂<(iλ/4)×1.3 (II)

In the numerical formula (II), i indicates a positive integer (generally 1, 2 or 3); n2 indicates the refractive index of the high-refractivity layer; and d2 indicates the layer thickness (nm) of the high-refractivity layer. λ represents an wavelength (nm) of visible light, falling within a range of from 380 nm to 680 nm.

(jλ/4)×0.7<n₃d₃<(jλ/4)×1.3 (III)

In the numerical formula (III), j indicates a positive odd number (generally 1); n3 indicates the refractive index of the low-refractivity layer; and d3 indicates the layer thickness (nm) of the low-refractivity layer. λ represents an wavelength (nm) of visible light, falling within a range of from 380 nm to 680 nm.

More preferably in the layer constitution as in FIG. 1B, the middle-refractivity layer satisfies the following numerical formula (IV), the high-refractivity layer satisfies the following numerical formula (V) and the low-refractivity layer satisfies the following numerical formula (VI). Here, λ=500 nm, h=1, i=2, and j=1.

(hλ/4)×0.80<n₁d₁<(hλ/4)×1.00 (IV)

(iλ/4)×0.75<n₂d₂<(iλ/4)×0.95 (V)

(j/4)×0.95<n₃d₃<(j/4)×1.05 (VI)

The high refractivity, the middle refractivity and the low refractivity as referred to herein are meant to indicate a relative difference in the refractive index of the respective layers. In FIG. 1B, the high-refractivity layer serves as a light interference layer, and the illustrated constitution gives an antireflection film having an extremely excellent antireflection capability.

### [Low-Refractivity Layer]

The low-refractivity layer in the invention is described below.

The refractive index of the low-refractivity layer of the antireflection film of the invention is from 1.20 to 1.49, preferably from 1.30 to 1.44.

Preferably, the low-refractivity layer satisfies the following numerical formula (VII) in order to keep its low refractive index.

(mλ/4)×0.7<n₁d₁<(mλ/4)×1.3 (VII)

wherein m indicates a positive odd number; n1 indicates the refractive index of the low-refractivity layer; and d1 indicates the layer thickness (nm) of the low-refractivity layer. λ represents an wavelength (nm), falling within a range of from 500 nm to 550 nm.

Satisfying the above numerical formula (VII) means the existence of m (positive odd number, generally 1) that satisfies the numerical formula (VII) within the above-mentioned wavelength range.

The low-refractivity layer of the antireflection film of the invention is formed by applying a composition that contains a specific fluoropolymer onto a transparent support and curing it thereon, in which the specific fluoropolymer comprises (a) at least one fluorine-containing vinyl monomer unit, (b) at least one polymerization unit having a reactive group capable of participating in crosslinking reaction in the side branch and (c) at least one polymerization unit having a graft moiety that contains a polysiloxane repetitive unit of the following formula (6) in the side branch. The fluoropolymer is described in detail hereinunder.

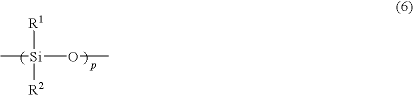

In formula (6), R¹ and R² may be the same or different, each representing an alkyl group or an aryl group. The alkyl group preferably has from 1 to 4 carbon atoms, and its examples are a methyl group, a trifluoromethyl group, an ethyl group. The aryl group preferably has from 6 to 20 carbon atoms, and its examples are a phenyl group, a naphthyl group. Of those, preferred are a methyl group and a phenyl group; and more preferred is a methyl group. p indicates an integer of from 2 to 500, preferably from 3 to 350, more preferably 8 to 250.

The polymer having a polysiloxane structure of formula (6) in the side branch may be produced, for example, according to a method comprising introducing a polysiloxane having a corresponding reactive group (e.g., epoxy group, amino group to acid anhydride group, mercapto group, carboxyl group, hydroxyl group) on one end thereof (e.g., Silaplane Series by Chisso) into a polymer having a reactive group such as an epoxy group, a hydroxyl group, a carboxyl group or an acid anhydride group through polymer reaction, or a method of polymerizing it with a polysiloxane-containing silicone macromer, as in J. Appl. Polym. Sci., 2000, 78, 1995, JP-A 56-28219. In the invention any of these methods may be employed favorably. More preferably, in the invention, the polymer is produced according to the method of polymerization with a silicone macromer.

The silicone macromer may be any one having a polymerizing group capable of copolymerizing with a fluorine-containing olefin. Preferably, it has a structure of any of the following formulae (2) to (5):

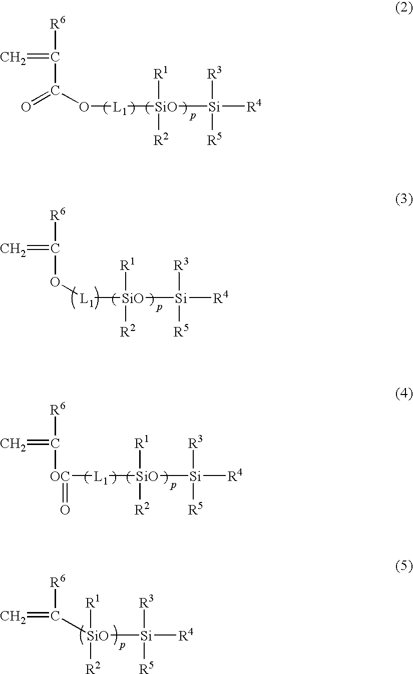

In formulae (2) to (5), R¹, R² and p have the same meanings as in formula (1), and their preferred ranges are also the same as those mentioned hereinabove for formula (1). R³ to R⁵ each independently represent a substituted or unsubstituted monovalent organic group or a hydrogen atom, preferably an alkyl group having from 1 to 10 carbon atoms (e.g., methyl, ethyl, octyl), an alkoxy group having from 1 to 10 carbon atoms (e.g., methoxy, ethoxy, propyloxy), an aryl group having from 6 to 20 carbon atoms (e.g., phenyl, naphthyl), more preferably an alkyl group having from 1 to 5 carbon atoms. R⁶ represents a hydrogen atom or a methyl group. L₁ represents a single bond or a linking group having from 1 to 20 carbon atoms, including a substituted or unsubstituted, linear, branched or alicyclic alkylene group, or a substituted or unsubstituted arylene group; preferably, it is an unsubstituted linear alkylene group having from 1 to 20 carbon atoms, more preferably an ethylene group or a propylene group. These compounds may be produced, for example, according to the method described in JP-A 6-322053.

Compounds of formulae (2) to (5) are all preferably used in the invention. Of those, more preferred are the compounds having a structure of formula (2), (3) or (4) from the viewpoint of the copolymerizability thereof with fluoro-olefins. Preferably, the polysiloxane-containing polymerization unit accounts for from 0.01 to 20% by mass fraction (%) to the mass of all the other components in the copolymer, more preferably from 0.1 to 10% by mass, even more preferably from 0.5 to 5% by mass.

Preferred examples of the polymerization units of the polymer graft sites that contain a polysiloxane moiety at the side branch for use in the invention are mentioned below, to which, however, the invention should not be limited.

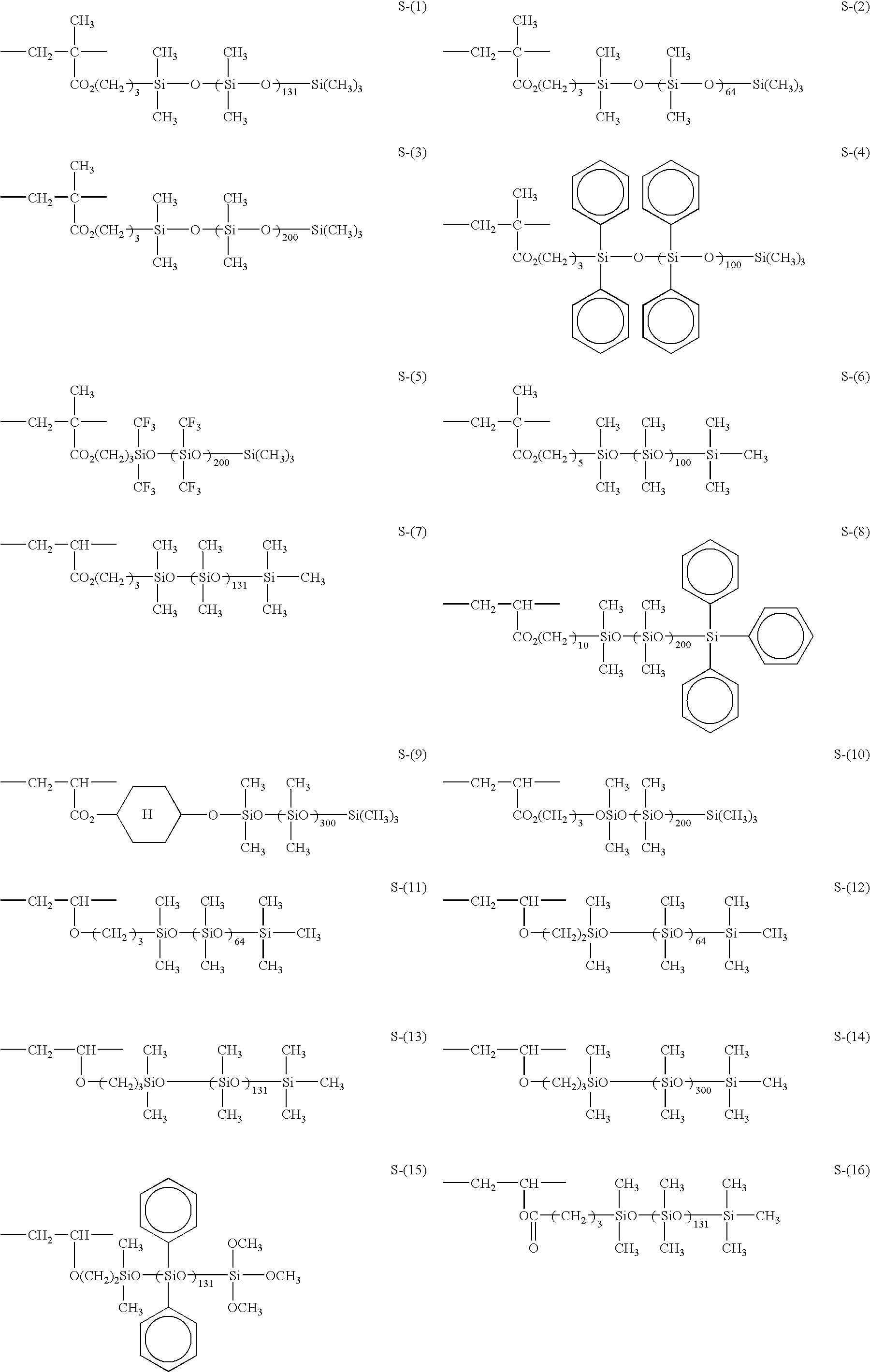

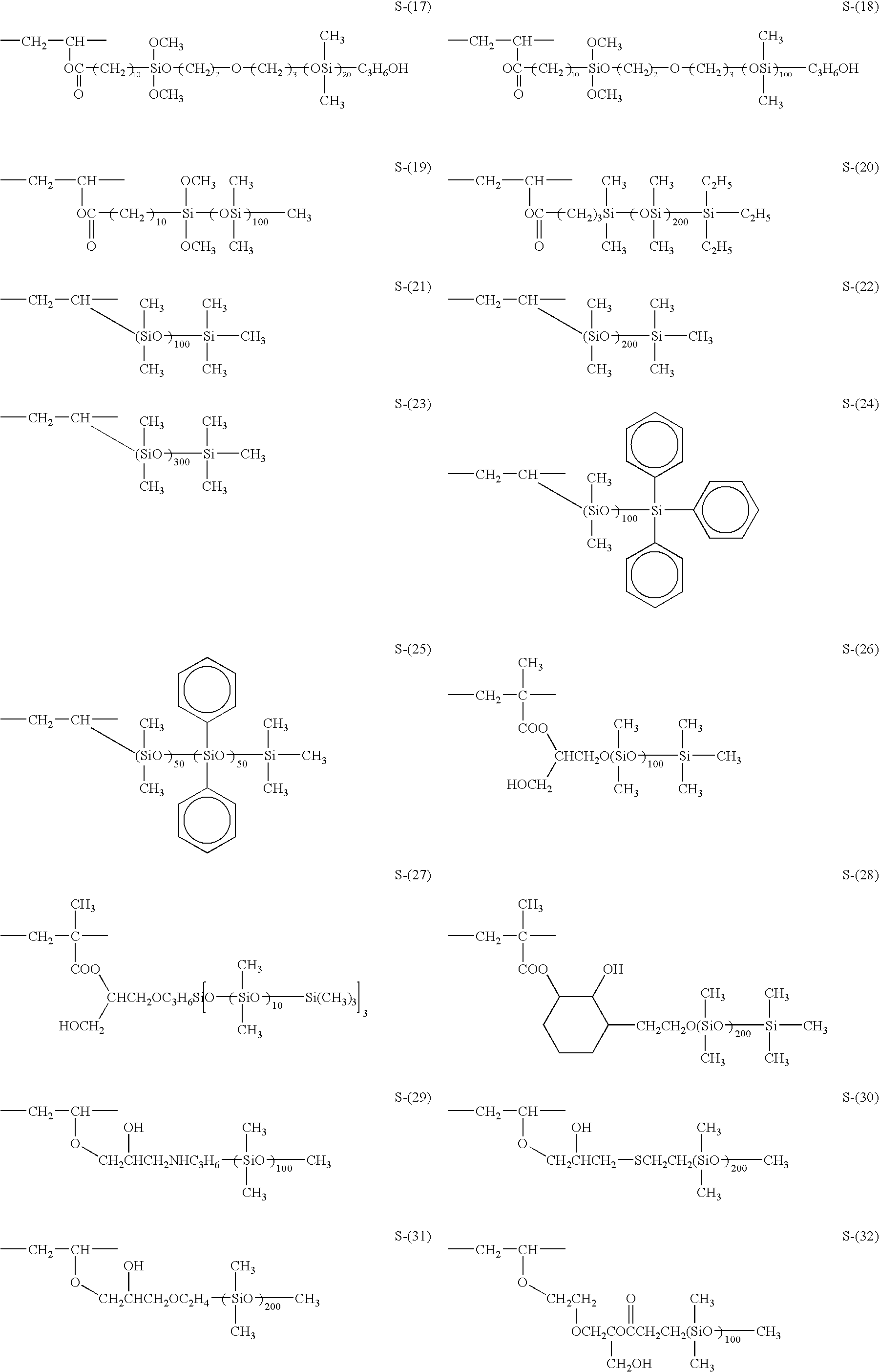

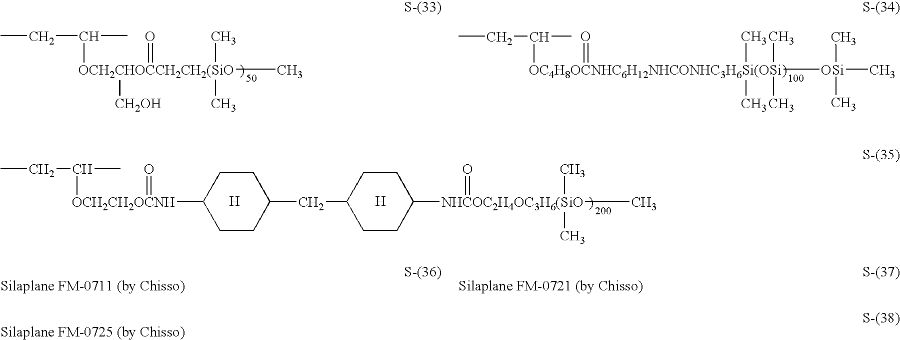

Not specifically defined in point of its structure, the fluorovinyl monomer polymerization units to be in the fluoropolymer that constitutes the low-refractivity layer in the invention is preferably a fluoro-olefin, more preferably a perfluoro-olefin.

The perfluoro-olefin preferably has from 3 to 7 carbon atoms, more preferably perfluoropropylene or perfluorobutylene from the viewpoint of its polymerization reactivity, and even more preferably perfluoropropylene from the viewpoint of its availability.

The perfluoro-olefin content of the polymer may be from 10 to 55 mol %. For ensuring the low refractivity of the material, it is desirable to increase the rate of perfluoro-olefin introduction into the polymer, but the introduction limit may be from 50 to 70 mol % or so in ordinary solution radical polymerization from the viewpoint of the polymerization reactivity therein, and further increasing the introduction rate will be difficult. In the invention, the perfluoro-olefin content of the polymer is preferably from 10 to 55 mol %, more preferably from 40 to 55 mol %.

In the invention, a fluorovinyl ether represented by the following formula (M1) may be copolymerized for ensuring the low refractivity of the material. The copolymerization component may be introduced into the polymer in a copolymerization ratio of from 0 to 45 mol %, preferably from 0 to 30 mol %, more preferably from 0 to 20 mol %.

In particular, when the film hardness of the low-refractivity layer is desired to be kept high (for example, it corresponds to a case where the low-refractivity layer contains a large quantity of a low-refractivity filler and its film strength is preferably increased by it rather than lowering the refractive index of the layer by a binder polymer to be in the layer), the rate of introduction of the copolymer component of a fluorovinyl ether of formula (M1) into the polymer is preferably 0 mol %. This is because the rate of introduction into the polymer of a polymerization unit having a reactive group capable of participating in crosslinking reaction in the side branch, which will be mentioned hereinunder, may be increased by removing the copolymer component.

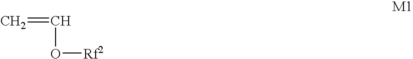

In formula (M1), Rf² represents a fluoroalkyl group having from 1 to 30 carbon atoms, preferably a fluoroalkyl group having from 1 to 20 carbon atoms, more preferably from 1 to 15 carbon atoms. It may be linear (e.g., —CF₂CF₃, —CH₂(CF₂)₄H, —CH₂(CF₂)₈CF₃, —CH₂CH₂(CF₂)₄H), or may have a branched structure (e.g., CH(CF₃)₂, CH₂CF(CF₃)₂, CH(CH₃)CF₂CF₃, CH(CH₃)(CF₂)₅CF₂H), or may have an alicyclic structure (preferably a 5-membered or 6-membered group, e.g., perfluorocyclohexyl or perfluoropentyl, or an alkyl group substituted with any of these), or may have an ether bond (e.g., CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H).

The monomer of formula (M1) may be produced, for example, according to a method of reacting a fluoroalcohol with a leaving group-substituted alkyl vinyl ether such as vinyloxyalkyl sulfonate or vinyloxyalkyl chloride, in the presence of a base catalyst, as in Macromolecules, 32 (21), 7122 (1999), or JP-A 2-721; a method of vinyl exchange reaction that comprises mixing a fluoroalcohol with a vinyl ether such as butyl vinyl ester in the presence of a palladium catalyst, as in WO-9205135; or a method comprising reacting a fluoroketone with dibromoethane in the presence of a potassium fluoride catalyst followed by processing it with an alkali catalyst for HBr removal, as in U.S. Pat. No. 3,420,793.

Preferred examples of the constitutive component of formula (MI) are mentioned below.

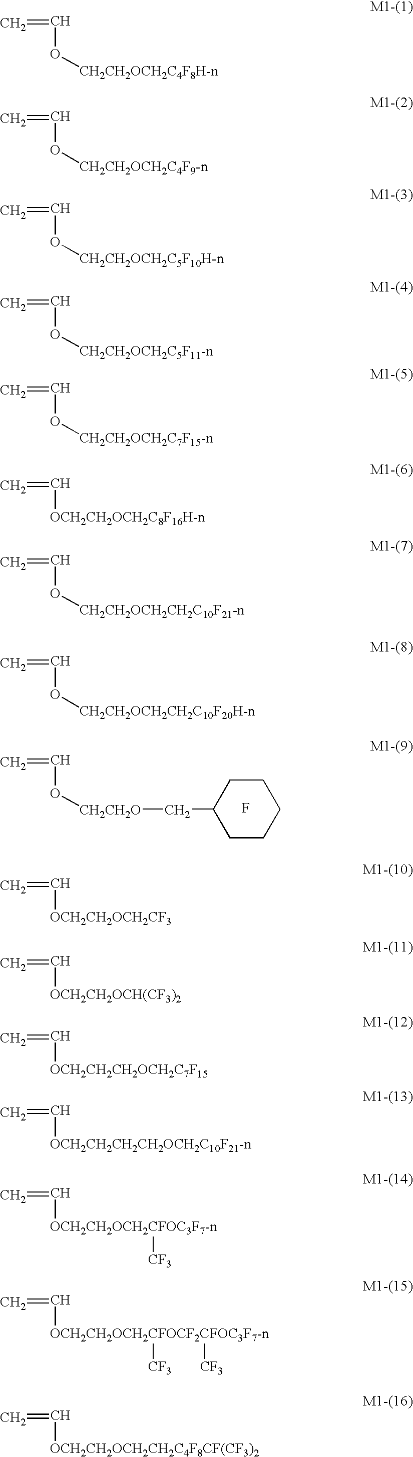

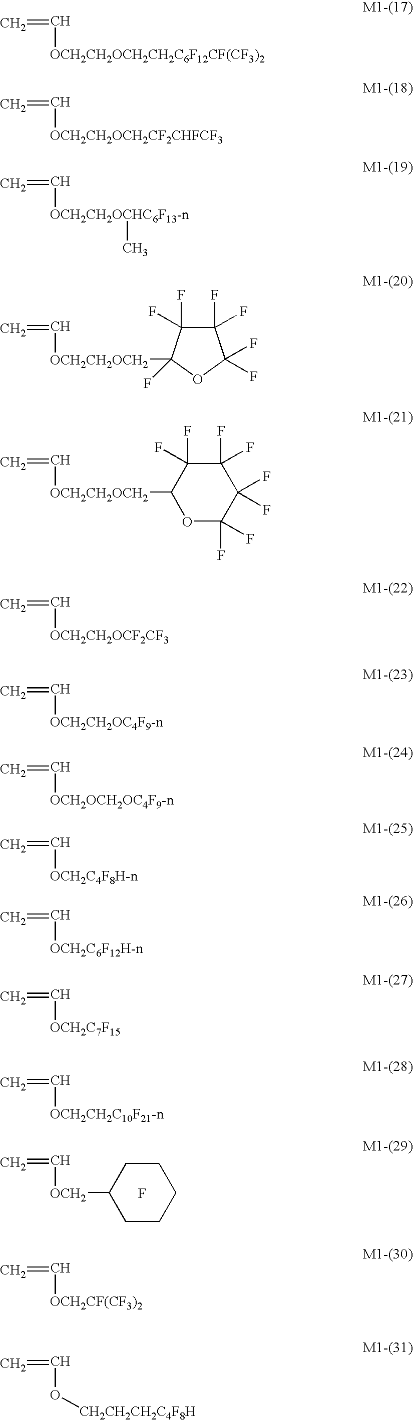

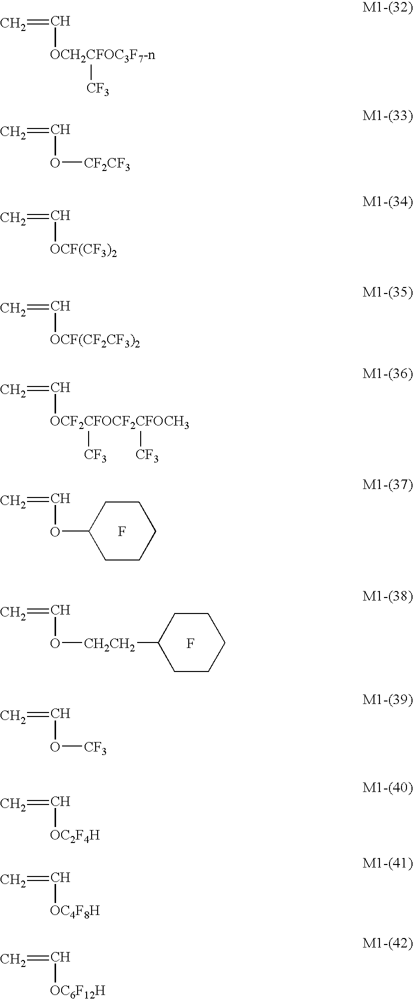

Not specifically defined in point of its constitution, the crosslinking group-having constitutive unit to be in the fluoropolymer that constitutes the low-refractivity layer in the invention is preferably a vinyl group-having compound from the viewpoint of its polymerization reactivity with fluoro-olefins, more preferably vinyl ethers or vinyl esters.

The reactive group capable of participating in crosslinking reaction includes, for example, an active hydrogen-having group (e.g., hydroxyl group, amino group, a carbamoyl group, mercapto group, β-ketoester group, hydrosilyl group, silanol group), a cation-polymerizing group (e.g., epoxy group, oxetanyl group, oxazolyl group, vinyloxy group), an unsaturated double bond-having group capable of undergoing addition or polymerization with an acid anhydride or a radical species (e.g., acryloyl group, methacryloyl group, allyl group), a hydrolyzable group (e.g., active halogen atom, sulfonate).

Of those, an unsaturated double bond-having group may be formed in any ordinary method, for example, according to a method comprising producing a hydroxyl group-having polymer followed by reacting it with an acid halide such as (meth)acrylic acid chloride, or an acid anhydride such as (meth)acrylic acid anhydride, or (meth)acrylic acid; or a method comprising polymerizing a 3-chloropropionate site-having vinyl monomer followed by processing it for dehydrochlorination. Similarly, the other functional group may be introduced into monomers prior to their polymerization to give polymers, or a reactive group such as a hydroxyl group may be introduced into polymers after produced through polymerization.

Of the above-mentioned crosslinking groups, preferred are a hydroxyl group, an epoxy group, a (meth)acryloyl group and a hydrolyzable silyl group; more preferred are an epoxy group and a (meth)acryloyl group; most preferred is a (meth)acryloyl group. The rate of introduction of the crosslinking group-having copolymerization component may be from 10 to 50 mol %, preferably from 20 to 50 mol %, more preferably from 25 to 50 mol %. Preferred examples of the polymerization unit capable of participating in crosslinking reaction are mentioned below, to which, however, the invention should not be limited.

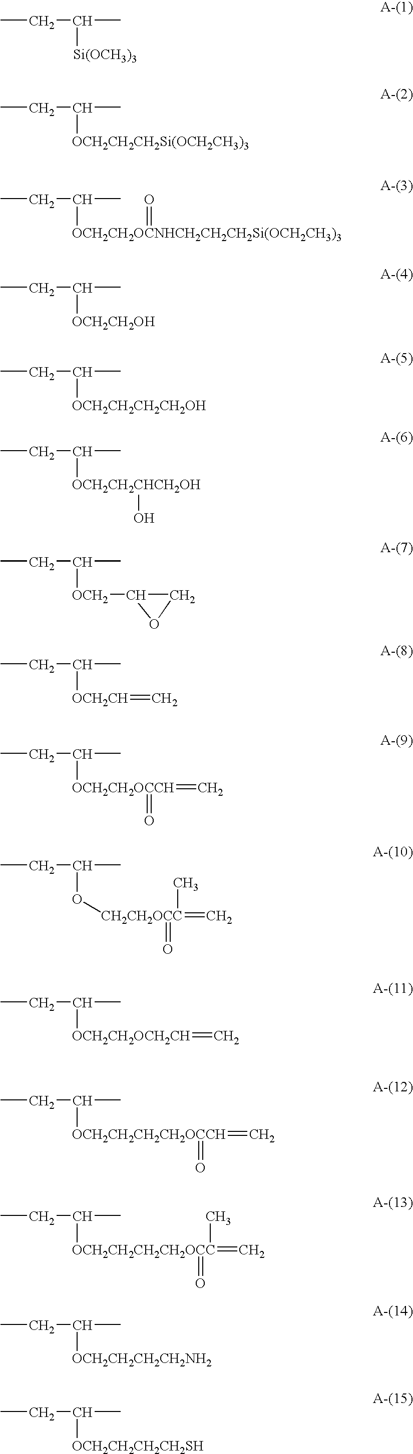

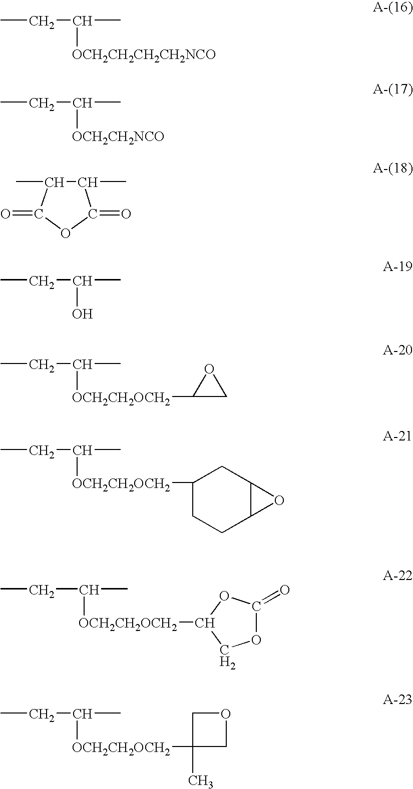

The other copolymerization components than the above may be suitably selected from the viewpoint of the hardness, the adhesiveness to substrate, the solubility in solvent and the transparency of the resulting polymer material.

For example, there are mentioned vinyl ethers such as methyl vinyl ether, ethyl vinyl ether, t-butyl vinyl ether, n-butyl vinyl ether, cyclohexyl vinyl ether, isopropyl vinyl ether; and vinyl esters such as vinyl acetate, vinyl propionate, vinyl butyrate, vinyl cyclohexanecarboxylate. The rate of introduction of these copolymer components is from 0 to 40 mol %, preferably from 0 to 30 mol %, more preferably from 10 to 20 mol %.

Of those mentioned above, especially preferred for use herein are polymers of the following formula (1), and the low-refractivity layer-forming composition in the invention indispensably contain a polymer of formula (1).

Fluoropolymers of formula (1) are described below.

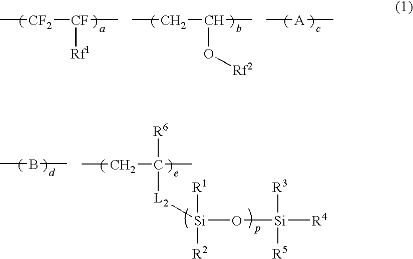

In formula (1), Rf¹ represents a perfluoroalkyl group having from 1 to 5 carbon atoms. To the monomer that constitutes the site of —CF₂CF(Rf⁴)—, examples mentioned hereinabove for perfluoro-olefins may apply. In formula (1), Rf² has the same meaning as that mentioned hereinabove for fluorovinyl ethers (compounds of formula (M1)), and its preferred examples are also the same as those mentioned hereinabove for them. A represents a constitutive unit having a crosslinking group, B represents a constitutive unit, and these are mentioned hereinabove. R¹ to R⁶ are the same as those mentioned hereinabove for formulae (2) to (5). L₂ represents a linking group or a single bond, preferably a linking group having from 1 to 20 carbon atoms, more preferably a linking group of *—COO—(L₁)—, *—O—(L₁)— or *—OCO—(L₁)— in which * indicates the side of the group on which the group bonds to the polymer chain. L₁ has the same meaning as in formulae (2) to (5). p is preferably from 10 to 500, and more preferably from 30 to 300.

a to d each indicate the molar fraction (%) of the respective constitutive components other than the polymerization unit including polysiloxane, satisfying 10≦a+b≦55 (preferably 40≦a+b<55), 10≦a≦55 (preferably 40≦a≦55, more preferably 50≦a≦55), 0≦b≦45 (preferably 0≦b≦30), 10≦c≦50 (preferably 20≦c≦50), 0≦d≦40 (preferably 0≦d<30). e indicates a mass fraction (%) of the polysiloxane-containing polymerization unit to the mass of all the other four components, satisfying 0.01≦e≦20 (preferably 0.1≦e≦10, more preferably 0.5≦e≦5, most preferably 1≦e≦3), provided that a+b+c+d=100.

Preferably, the number-average molecular weight of the fluoropolymer that constitutes the low-refractivity layer of the invention is from 5,000 to 500,000, more preferably from 10,000 to 500,000, even more preferably from 20,000 to 300,000.

The number-average molecular weight is a number-average molecular in terms of polystyrene standard, detected by a differential refractometer of GPC analysis equipment (solvent: THF) using columns TSKgel GMxL, TSKgel G4000HxL and TSKgel G2000HxL (produced by TOSOH CORPORATION).

Specific examples of the polymer useful in the invention are shown in Table 1 and Table 2, to which, however, the invention should not be limited. In Tables 1 and 2, shown are monomer units to be combined to give the corresponding polymers.

In these, shown are the molar fraction (%) of the respective constitutive components except the silicone-containing monomer unit, and the mass fraction (%) of the silicone-containing polymerization unit.

TABLE 1

| Fluoropolymer | | P1 | P2 | P3 | P4 | P5 | P6 | P7 | P8 | P9 | P10 | P11 | P12 |
|---|---|---|---|---|---|---|---|---|---|---|---|---|---|
| Basic Constitution of | hexafluoro- | 50 | 50 | 50 | 50 | 50 | 50 | 50 | 50 | 50 | 50 | 50 | 50 |
| Fluoropolymer (mol | propylene | | | | | | | | | | | | |
| fraction (%)) | M1-(1) | | | | | | | | | | | | |
| | M1-(5) | | | | | | | | | | | | |
| | A-(2) | | | | | | | | | | | | |
| | A-(4) | 5 | 10 | 15 | 5 | 10 | 15 | | | | | | |
| | A-(5) | | | | | | | 5 | 10 | 5 | 10 | | |
| | A-(6) | | | | | | | | | | | | |
| | A-(7) | | | | | | | | | | | | |
| | A-(8) | | | | | | | | | | | | |
| | A-(9) | 45 | 40 | 35 | | | | | | | | 50 | |
| | A-(10) | | | | 45 | 40 | 35 | | | | | | 50 |
| | A-(12) | | | | | | | 45 | 40 | 45 | 40 | | |
| | A-(13) | | | | | | | | | | | | |
| | ethyl vinyl ether | | | | | | | | | | | | |
| | t-butyl vinyl ether | | | | | | | | | | | | |
| Silicone- | S-(36) | 2 | | | | 2 | | | | | | | 2 |
| Containing | S-(37) | | 2 | | | | 2 | | | | 2 | 2 | |
| Polymerization Unit | S-(38) | | | 1 | 1 | | | | | | | | |
| (mass fraction (%)) | S-(5) | | | | | | | | | | | | |
| | S-(11) | | | | | | | 1 | | | | | |
| | S-(16) | | | | | | | | 2 | | | | |
| | S-(17) | | | | | | | | | 1 | | | |

| | | | | | | | | | | | | |
|---|---|---|---|---|---|---|---|---|---|---|---|---|
| Number-Average Molecular Weight | 1.9 | 3.1 | 3.3 | 4.5 | 2.5 | 5.1 | 3.5 | 2.8 | 4.5 | 4.2 | 3.2 | 3.7 |
| (×10000) | | | | | | | | | | | | |

| Fluoropolymer | | P13 | P14 | P15 | P16 | P17 | P18 | P19 | P20 |
|---|---|---|---|---|---|---|---|---|---|
| Basic Constitution of | hexafluoro- | 50 | 50 | 45 | 45 | 45 | 45 | 50 | 50 |
| Fluoropolymer (mol | propylene | | | | | | | | |
| fraction (%)) | M1-(1) | | | 10 | 10 | | | | |
| | M1-(5) | | | | | 10 | 10 | | |
| | A-(2) | | | | | | | | |
| | A-(4) | | | | 5 | 5 | | 5 | |
| | A-(5) | | | | | | 5 | | |
| | A-(6) | | | | | | | | |
| | A-(7) | | | | | | | | |
| | A-(8) | | | | | | | | |
| | A-(9) | | | 45 | 40 | | | 35 | 35 |
| | A-(10) | | | | | 40 | | | |
| | A-(12) | 50 | | | | | 40 | | |
| | A-(13) | | 50 | | | | | | |
| | ethyl vinyl ether | | | | | | | 10 | 15 |
| | t-butyl vinyl ether | | | | | | | | |
| Silicone- | S-(36) | | | 2 | | | | | |
| Containing | S-(37) | | 1 | | 1 | 2 | | | |
| Polymerization Unit | S-(38) | 1 | | | | | 1 | | |
| (mass fraction (%)) | S-(5) | | | | | | | | |
| | S-(11) | | | | | | | 1 | |
| | S-(16) | | | | | | | | |
| | S-(17) | | | | | | | | 1 |

| | | | | | | | | |
|---|---|---|---|---|---|---|---|---|
| Number-Average Molecular Weight | 2.8 | 3.1 | 7.1 | 6.3 | 4.1 | 3.5 | 4.8 | 1.6 |
| (×10000) | | | | | | | | |

TABLE 2

| Fluoropolymer | | P21 | P22 | P23 | P24 | P25 | P26 | P27 | P28 | P29 | P30 | P31 | P32 |
|---|---|---|---|---|---|---|---|---|---|---|---|---|---|
| Basic Constitution of | hexafluoro- | 50 | 50 | 45 | 45 | 50 | 50 | 50 | 50 | 50 | 50 | 50 | 50 |
| Fluoropolymer (mol | propylene | | | | | | | | | | | | |
| fraction (%)) | M1-(1) | | | 10 | | | | | | | | | |
| | M1-(5) | | | | 10 | | | | | | | | |
| | A-(2) | | | | | | | 10 | 10 | | | | |
| | A-(4) | 5 | | | | | | | | | | 5 | |
| | A-(5) | | | | | | | | | | | | 5 |
| | A-(6) | | | | | | | | | 5 | 10 | | |
| | A-(7) | | | | | | | | | | | | |
| | A-(8) | 45 | 40 | 45 | 45 | 10 | 10 | | | 45 | 40 | | |
| | A-(9) | | | | | 40 | | 40 | | | | 35 | |
| | A-(10) | | | | | | | | 40 | | | | |
| | A-(12) | | | | | | 40 | | | | | | 40 |
| | A-(13) | | | | | | | | | | | | |
| | ethyl vinyl ether | | 10 | | | | | | | | | | |
| | t-butyl vinyl ether | | | | | | | | | | | 10 | 5 |
| Silicone- | S-(36) | 3 | | | | 2 | 1 | | | | | | |
| Containing | S-(37) | | | 3 | | | | 2 | | | | | |
| Polymerization Unit | S-(38) | | | | 2 | | | | 1 | | | | |
| (mass fraction (%)) | S-(5) | | 2 | | | | | | | | | | 1 |
| | S-(11) | | | | | | | | | 1 | | | |
| | S-(16) | | | | | | | | | | | 1 | |
| | S-(17) | | | | | | | | | | 1 | | |

| | | | | | | | | | | | | |
|---|---|---|---|---|---|---|---|---|---|---|---|---|
| Number-Average Molecular Weight | 1.6 | 3.5 | 3.0 | 4.6 | 2.6 | 6.8 | 2.7 | 9.1 | 2.6 | 3.6 | 1.9 | 2.4 |
| (×10000) | | | | | | | | | | | | |

| Fluoropolymer | | P33 | P34 | P35 | P36 | P37 | P38 | P39 | P40 |
|---|---|---|---|---|---|---|---|---|---|
| Basic Constitution of | hexafluoro- | 50 | 50 | 45 | 50 | 50 | 50 | 50 | 45 |
| Fluoropolymer (mol | propylene | | | | | | | | |
| fraction (%)) | M1-(1) | | | 10 | | | | | |
| | M1-(5) | | | | 5 | | | | 10 |
| | A-(2) | | | | | 10 | 30 | 40 | 45 |
| | A-(4) | | | | | | | | |
| | A-(5) | | | | | | | 10 | |
| | A-(6) | | | | 5 | | 10 | | |
| | A-(7) | | 50 | 45 | 40 | 40 | | | |
| | A-(8) | | | | | | | | |
| | A-(9) | 25 | | | | | | | |
| | A-(10) | 25 | | | | | | | |
| | A-(12) | | | | | | | | |
| | A-(13) | | | | | | | | |
| | ethyl vinyl ether | | | | | | 10 | | |
| | t-butyl vinyl ether | | | | | | | | |
| Silicone- | S-(36) | 2 | | | | | | | |
| Containing | S-(37) | | 2 | | | 2 | | | |
| Polymerization Unit | S-(38) | | | 1 | | | | | 1 |
| (mass fraction (%)) | S-(5) | | | | | | | | |
| | S-(11) | | | | 2 | | | | |
| | S-(16) | | | | | | | 2 | |
| | S-(17) | | | | | | 2 | | |

| | | | | | | | | |
|---|---|---|---|---|---|---|---|---|
| Number-Average Molecular Weight | 3.3 | 4.1 | 2.2 | 3.5 | 4.3 | 4.6 | 2.2 | 1.9 |
| (×10000) | | | | | | | | |

The fluoropolymer of formula (1) for use in the invention may be produced in various polymerization methods of, for example, solution polymerization, precipitation polymerization, suspension polymerization, bulk polymerization or emulsion polymerization. The methods may be carried out in any known mode of batch, semi-continuous or continuous polymerization.

To start the polymerization, employable is a method of using a radical initiator, or a method of exposing the system to light or radiation.

The polymerization methods and the polymerization initiation methods are described, for example, in Teiji Tsuruta, Methods of Polymer Synthesis, revised edition (published by Nikkan Kogyo Shinbun, 1971); Takayuki Ohtsu & Masaetsu Kinoshita, Experimental Methods of Polymer Synthesis (published by Kagaku Dojin, 1972, pp. 124-154).

Of the above-mentioned polymerization methods, especially preferred is a solution polymerization method that uses a radical initiator. The solvent usable in the solution polymerization method includes, for example, ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, 1-butanol. One or more such various organic solvents may be used either singly or as combined, or a mixed solvent thereof with water may also be used.

The polymerization temperature must be set in relation to the molecular weight of the polymer to be produced and to the type of the initiator used. It may be from 0° C. or lower to 100° C. or higher, but is preferably from 50 to 100° C.

In case where the copolymerization reactivity of the silicone macromer used is not good, then the monomer may be dropwise added to the system or may be divided into plural portions to be separately and intermittently added to the system.

The reaction pressure may be determined suitably, but generally falls between 0.01 and 10 MPa, preferably between 0.05 and 5 MPa, more preferably between 0.1 and 2 MPa. The reaction time may fall between 5 and 30 hours or so.

The polymer produced may be directly used in the invention as it is in a reaction solution thereof, or may be purified through reprecipitation or liquid-liquid separation before: use in the invention.

A curing catalyst or a curing agent may be suitably added to the low-refractivity layer-forming composition in the invention. They may be appropriately selected depending on the curing reactivity of the crosslinking site of the polymer of formula (1) to be in the composition.

Especially preferably for use in the invention, the reactive group capable of participating in crosslinking reaction in the fluoropolymer for use in the invention is a radical-polymerizing (meth)acryloyl group. In this case, a radical polymerization initiator is preferably added to the composition, and the radical polymerization initiator may be any one capable of generating a radical under the action of heat thereon (thermal radical initiator) or one capable of generating a radical under the action of light thereon (photoradical initiator). From the viewpoint of the storage stability and the reactivity thereof, especially preferred is a photoradical initiator, with which the polymer is crosslinked through irradiation with light.

When a compound that initiates radical polymerization by the action of light thereon is used, then the coating film may be cured through irradiation with active energy rays. Examples of the photoradical polymerization initiator are acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, rofin dimers, onium salts, borate salts, active esters, active halogens, inorganic complexes and coumarins.

Examples of acetophenones include 2,2-diethoxyacetophenone, 2,2-diethoxyacetophenone, p-dimethylacetophenone, 1-hydroxydimethylphenyl ketone, 1-hydroxydimethyl-n-isopropylphenyl ketone, 1-hydroxycyclohexyl phenyl ketone, 2-methyl-4-methylthio-2-morpholinopropiophenone, 2-benzyl-2-dimethylamino-1-(4-morpholinophenyl)butanone, 4-phenoxydichloroacetophenone, 4-t-butyldichloroacetophenone.

Examples of benzoins include benzoin, benzoin methyl ether, benzoin ethyl ether, benzoin isopropyl ether, benzyldimethyl ketal, benzoin benzenesulfonates, benzoin toluenesulfonates, benzoin toluenesulfonates, benzoin methyl ether, benzoin ethyl ether, benzoin isopropyl ether.

Examples of benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone), 3,3′,4,4′-tetra(t-butylperoxycarbonyl)benzophenone.

One example of phosphine oxides is 2,4,6-trimethylbenzoyldiphenylphosphine oxide.

Examples of active esters include 1,2-octanedione, 1[4-phenylthio-2-(O-benzoyloxime)], sulfonates, cyclic active ester compounds.

Examples of onium salts include aromatic diazonium salts, aromatic iodonium salts, aromatic sulfonium salts.

Examples of borate salts includes cationic dyes and ion complexes.

As examples of active halogens, known are S-triazines and oxathiazole compounds, including 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-Br-4-(di(ethylacetate)aminophenyl)-4,6-bis(trichloromethyl)-s-triazine, 2-trihalomethyl-5-(p-methoxyphenyl)-1,3,4-oxadiazole.

One example of inorganic complexes is (η⁵-2,4-cyclopentadien-1-yl)-bis(2,6-difluoro-3-(1H-pyrrol-1-yl)phenyl)titanium.

Examples of coumarins are 3-ketocoumarins.

These initiators may be used singly or as combined.

Other various examples are described in the Latest UV Curing Technology (published by the Technology Information Association, 1991, p. 159), and are useful in the invention.

Some photo-cleavable photoradical polymerization initiators are commercially available, and their preferred examples for use herein are Ciba-Speciality Chemicals' Irgacure (e.g., 651, 184, 819, 907, 1870 (CGI-403/Irg-184=7/3 mixed initiator), 500, 369, 1173, 2959, 4265, 4263, OXE01), Nippon Kayaku's Kayacure (e.g., DETX-S, BS-100, BDMK, CTX, BMS, 2-EAQ, ABQ, CPTX, EPD, ITX, QTX, BTC, MCA), Sartomer's Esacure (e.g., KIP100F, KB1, EB3, BP, X33, KT046, KT37, KIP150, TZT).

In the present invention, to promote the curing of the low refractivity layer, initiators which have a large molecular weight and are difficult to evaporate from the coated layer are preferred, exemplified by an oligomer type polymerization initiator. As the oligomer type radiation curable polymerization initiator, there is no special limitation so long as it has a moiety that generates photo-radicals by radiation irradiation. For the suppression of evaporation, the molecular weight of the polymerization initiator is preferably 250 to 10,000, and more preferably 300 to 10,000. Still more preferably, the mass average molecular weight thereof is 400 to 10,000. With a mass average molecular weight of 400 or larger, volatility is preferably low, while, with a mass average molecular weight not exceeding 10,000, the hardness of the resulting cured coating film is preferably high enough. As special examples of the oligomer type radiation sensitive polymerization initiator, oligo[2-hydroxy-2-methyl-1-{4-(1-methylvinyl)phenyl}propanone] represented by the following formula (5) can be mentioned.

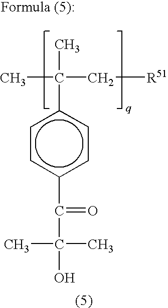

In the foregoing formula (5), R⁵¹ represents a mono-valent group, preferably a mono-valent organic group and q represents an integer of 2 to 45.

As commercially available products of the oligo[2-hydroxy-2-methyl-1-{4-(1-methylvinyl)phenyl}propanone], ‘Ezacure KIP 150’ (CAS-No. 163702-01-0, q=4-6), ‘Ezacure KIP 65LT’ (a mixture of ‘Ezacure KIP 150’ with tripropylene glycol diacrylate), ‘Ezacure KIP 100F’ (a mixture of ‘Ezacure KIP 150’ with 2-hydroxy-2-methyl-1-phenylpropan-1-one), ‘Ezacure KT 37’, ‘Ezacure KT 55’ (these two being mixtures of Ezacure KIP 150’ with a methylbenzophenone derivative), ‘Ezacure KTO 46’ (a mixture of ‘Ezacure KIP 150’ with a methylbenzophenone derivative and 2,4,6-trimethylbenzoyldiphenylphosphine oxide), ‘Ezacure KIP 75/B’ (a mixture of ‘Ezacure KIP 150’ with 2,2-dimethoxy-1,2-diphenylethan-1-one), all being the names of the commercial products of Fratelli Lamberti Co., Ltd., can be mentioned.

Preferably, the photopolymerization initiator is used in an amount of from 0.1 to 15 parts by mass relative to 100 parts by mass of the polyfunctional monomer, more preferably from 1 to 10 parts by mass.

A photosensitizer may be used in addition to the photopolymerization initiator. Specific examples of the photosensitizer are n-butylamine, triethylamine, tri-n-butyl phosphine, Michler's ketone and thioxanthone.

In addition, one or more promoters, such as azide compounds, thiourea compounds and mercapto compounds, may be used optionally as combined.

Some photosensitizers are commercially available, and, for example, they are Nippon Kayaku's Kayacure (DMBI, EPA).

The thermal radical initiator usable herein includes organic or inorganic peroxides, and organic azo and diazo compounds.

Concretely, the organic peroxides include benzoyl peroxide, halogenobenzoyl peroxide, lauroyl peroxide, acetyl peroxide, dibutyl peroxide, cumene hydroperoxide, butyl hydroperoxide; the inorganic peroxides include hydrogen peroxide, ammonium persulfate, potassium persulfate; the organic azo compounds include 2,2′-azobisisobutyronitrile, 2,2′-azobis(propionitrile), 1,1-azobis(cyclohexanecarbonitrile): the diazo compounds include diazoaminobenzene, p-nitrobenzene-diazonium.

As so mentioned hereinabove, when the compound of formula (1) has a radical-polymerizable unsaturated double bond, then it does not always require a curing agent to be combined with it. Preferably, however, a polyfunctional unsaturated monomer capable of reacting with the unsaturated bond in the compound (for example, (meth)acrylate monomers derived from polyalcohols, such as dipentaerythritol hexa(meth)acrylates) may be added to the compound as a curing agent. In particular, when the necessity of lowering the refractive index of the binder polymer in the low-refractivity layer by adding a large amount of a low-refractivity inorganic filler to the layer is small, then it is desirable that the compound is combined with a polyfunctional unsaturated monomer added thereto for more enhancing the film strength of the polymer.

In this case, the polyfunctional unsaturated monomer to be added preferably has a bifunctional or more-polyfunctional group capable of curing with ionizing radiation in one molecule, more preferably a trifunctional or more-polyfunctional group therein. Examples of the polyfunctional unsaturated monomer are favorably used as the monomers that will be mentioned hereinunder as examples of a film-forming binder. When an inorganic filler is added to the layer, then the polyfunctional unsaturated monomer to be added to the compound preferably has a hydroxyl group in the molecule for enhancing the dispersion stability of the inorganic filler in the layer.

And, for the purpose of achieving low refractivity, a monomer containing a fluorine atom in the molecule is preferably used; as specific examples, compounds (1) to (4) as set forth in the claims of JP-A 2002-145936 can be used.

Like that of the other curing agent, the amount of the curing agent of the type, if added to the compound, is preferably from 0.5 to 300 parts by mass or so per 100 parts by mass of the fluorocopolymer, more preferably from 5.0 to 100 parts by mass or so relative to 100 parts by mass of the fluorocopolymer.

For example, when the polymer of formula (1) contains a hydrolyzable silyl group as a curable site thereof, then any known acid or base catalyst may be added to it as a catalyst for sol-gel reaction. For example, the catalyst includes inorganic Broensted acids such as hydrochloric acid, sulfuric acid, nitric acid; organic Broensted acids such as oxalic acid, acetic acid, formic acid, methanesulfonic acid, paratoluenesulfonic acid; Lewis acids such as dibutyl tin dilaurate, dibutyl tin diacetate, dibutyl tin dioctanoate, triisopropoxyaluminium, tetrabutoxyzirconium; inorganic bases such as sodium hydroxide, potassium hydroxide, ammonia; and organic bases such as triethylamine, pyridine, tetramethylethylenediamine.

The amount of the curing catalyst to be added may vary depending on the type of the catalyst and the curing site of the polymer, but in general, it is preferably from 0.1 to 15% by mass or so, more preferably from 0.5 to 5% by mass or so of the total solid content of the low-refractivity layer-forming composition.

From the viewpoint of the storage stability of the low-refractivity layer-forming composition, a compound capable of generating a curing promoter such as acid or base by the action of light thereon may be added to the composition. When the compound of the type is in the composition, then the film may be cured through irradiation with active energy rays.

Various examples of such a compound capable of generating an acid by the action of light thereon are described in, for example, Organic Material for Imaging (by Organic Electronics Material Study Society, Bunshin Publishing), pp. 187-198, and JP-A 10-282644, and such known compounds may be used herein.

In this case, a curing agent such as an organic silicate (hydrolyzed and partially condensed products of various alkoxysilanes), which will be mentioned hereinunder, may be used along with the compound, as in JP-A 61-258852. When such a curing agent is added to the composition, then its amount is preferably from 0.5 to 300 parts by mass or so relative to 100 parts by mass of the fluorocopolymer in the composition, more preferably from 5.0 to 100 parts by mass or so relative to 100 parts by mass of the fluorocopolymer.

On the other hand, when the curing site of the copolymer is an active hydrogen-having group such as a hydroxyl group, then a curing agent is preferably added to the composition. The curing agent includes, for example, polyisocyanate-type curing agents, aminoplasts, polybasic acids and their anhydrides.

The polyisocyanate-type curing agents include polyisocyanate compounds such as m-xylylene diisocyanate, toluene-2,4-diisocyanate, hexamethylene diisocyanate, isophorone diisocyanate; silyl isocyanate compounds such as methylsilyl triisocyanate; and partial condensates or polymers of such isocyanate compounds, addition products thereof with polyalcohols or low-molecular polyester films, and blocked polyisocyanate compounds where the isocyanate group is blocked with a blocking agent such as phenol.

The polybasic acids and their anhydrides include aromatic polycarboxylic acids and their anhydrides such as pyromellitic acid, pyromellitic acid anhydride, trimellitic acid, trimellitic acid anhydride, phthalic acid, phthalic acid anhydride; and aliphatic polycarboxylic acids and their anhydrides such as maleic acid, maleic acid anhydride, succinic acid, succinic acid anhydride.

In the invention, the blend ratio of the constitutive components of the composition may be suitably determined. Preferably, the amount of the curing agent may be from 0.5 to 300 parts by mass or so, relative to 100 parts by mass of the fluorocopolymer; more preferably, the amount of the curing agent may be from 5.0 to 100 parts by mass or so relative to 100 parts by mass of the fluorocopolymer. As the case may be, the fluoropolymer and the curing agent may be previously partially condensed together.

If desired, a curing promotion catalyst may be used along with the curing agent for promoting the curing reaction of the composition. Its examples are base or acid catalysts mentioned hereinabove for those of a curing catalyst for a hydrolyzable silyl group. As so mentioned hereinabove, a compound capable of generating such a catalyst by the action of light thereon is also preferably usable for it. The preferred range of its amount to be added is also the same as that mentioned hereinabove for the curing catalyst for a hydrolyzable silyl group.

When the crosslinking site of the polymer has a cation-polymerizing group (e.g., epoxy group, oxetanyl group, oxazolyl group, vinyloxy group), then the same acid catalyst as above may also be added to it as a curing catalyst.

In this case, any other curing agent will be unnecessary. However, a polyfunctional compound capable of reacting with the cation-polymerizing group (e.g., polybasic acid such as pyromellitic acid, trimellitic acid, phthalic acid, maleic acid, succinic acid; compound having plural cation-polymerizing groups in one molecule) may be added to the composition as a curing agent.

When such a curing agent is added to the composition, then its amount may be preferably from 0.5 to 300 parts by mass or so relative to 100 parts by mass of the fluorocopolymer, more preferably from 5.0 to 100 parts by mass or so relative to 100 parts by mass of the fluorocopolymer.

The low-refractivity layer-forming composition in the invention may be prepared by dissolving a polymer of formula (1) in a suitable solvent. In this stage, the concentration of the polymer of formula (1) may be suitably determined depending on the use of the film, but may be from 0.01 to 60% by mass or so, preferably from 0.5 to 50% by mass, more preferably from 1 to 20% by mass or so.

Not specifically defined, the solvent may be any one in which the polymer of formula (1) is uniformly dissolved or dispersed to give a composition with no precipitate therein, and two or more different types of such solvents may be combined for use herein. Preferred examples of the solvent are ketones (e.g., acetone, methyl ethyl ketone, methyl isobutyl ketone, cyclohexanone), esters (e.g., ethyl acetate, butyl acetate), ethers (e.g., tetrahydrofuran, 1,4-dioxane), alcohols (e.g., methanol, ethanol, isopropyl alcohol, butanol, ethylene glycol), aromatic hydrocarbons (e.g., toluene, xylene), water.

Preferably, at least one or more types of inorganic particles are in the low-refractivity layer in the invention for improving the film strength and the coatability.

The amount of the inorganic particles to be in the layer is preferably from 1 mg/m² to 100 mg/m², more preferably from 5 mg/m² to 80 mg/m², eve more preferably from 10 mg/m² to 60 mg/m². If the amount thereof is too small, then the particles may be ineffective for improving the scratch resistance of the film; but if too large, then the surface of the low-refractivity layer may be roughened to have fine projections and recesses, and therefore the film may have black depth and its appearance may worsen and its integrated reflection may lower.

The inorganic particles are added to the low-refractivity layer, and are desired to have a low refractive index. For example, preferred are magnesium fluoride or silica particles. In particular, silica particles are preferred in view of their refractive index, dispersion stability and cost.

Preferably, the mean particle size of the inorganic particles is from 30% to 100%, more preferably from 35% to 80%, even more preferably from 40% to 60% of the thickness of the low-refractivity layer. Accordingly, when the thickness of the low-refractivity layer is 100 nm, then the particle size of the inorganic particles is preferably from 30 nm to 100 nm, more preferably from 35 nm to 80 nm, even more preferably from 40 nm to 60 nm.

When the particle size thereof is within the above-mentioned range, the scratch resistance of the film is improved, the appearance (e.g. black depth) and integrated reflection is kept in good condition without generating fine projections and recesses on the surface of the low-refractivity layer. The silica particles may % be crystalline or amorphous, and may be monodispersed particles or may also be aggregated particles so far as they satisfy the predetermined particle size. Regarding their form, the particles are most preferably spherical, but may be amorphous with no problem.

The mean particle size of the inorganic particles may be measured with a Coulter counter.

For more effectively preventing the increase in the refractivity of the low-refractivity layer, hollow silica particles are preferably used in the layer. The refractive index of the hollow silica particles may be from 1.17 to 1.40, preferably from 1.17 to 1.35, more preferably from 1.17 to 1.30. The refractivity as referred to herein for the particles means the refractivity of the entire particles. In hollow silica particles, therefore, the refractivity of the particles does not mean the refractivity of the silica shell alone. In this case, when the radius of the hollow of the particles is represented by a and the radius of the particle shell is by b, then the porosity x of the particles to be represented by the following numerical formula (VIII) is preferably from 10 to 60%, more preferably from 20 to 60%, most preferably from 30 to 60%.

x=(4πa³/3)/(4πb³/3)×100. (VIII)

When the refractivity of the hollow silica particles is further lowered and the porosity thereof is further increased, then the thickness of the shell may be thin and the mechanical strength of the particles may be low. Therefore, from the viewpoint of the scratch resistance of the layer, particles having a refractive index of 1.17 or more is preferred.

The refractivity of the hollow silica particles is determined with an Abbe's refractometer (by Atago).

The method of manufacturing hollow fine particles is described in, for example, JP-A 2001-233611. The method of manufacturing porous particles are described in, for example, JP-A 2003-327424, JP-A 2003-335515, JP-A 2003-226516 and JP-A 2003-238140.

Preferably, at least one type of silica particles having a mean particle size of less than 25% of the thickness of the low-refractivity layer (these are referred to as “small-size silica particles”) is combined with the silica particles having the above-mentioned particle size (these are referred to as “large-size silica particles”).

Since the small-size silica particles may exist in the space between the large-size silica particles, they may serve as a fixer for the large-size silica particles.

The mean particle size of the small-size silica particles is preferably from 1 nm to 20 nm, more preferably from 5 nm to 15 nm, even more preferably from 10 nm to 15 nm when the thickness of the low-refractivity layer is 100 nm. Using the silica particles of the type is preferred in point of the cost of the materials and of the effect of the particles as fixer.

As so mentioned hereinabove, the inorganic particles for use herein are preferably hollow-structured particles having a mean particle size of from 30% to 100% of the thickness of the low-refractivity layer; and also as so mentioned hereinabove, the refractive index of the particles is preferably from 1.17 to 1.40. Moreover, it is possible to use hollow particles other than the hollow fine particles and besides such particles that have an average particle diameter lying in the range of from 30 to 100% of the thickness of the low refractivity layer. Furthermore, it is also preferred to use two or more kinds of hollow fine particles having different average particle sizes.

The inorganic particles may be processed for physical surface treatment such as plasma discharge treatment or corona discharge treatment, or for chemical surface treatment with surfactant or coupling agent, in order to ensure their dispersion stability in dispersions or coating liquids and in order to enhance their affinity and bonding ability to binder components. More preferably, coupling agent is used for the treatment. The coupling agent is preferably an alkoxymetal compound (e.g., titanium coupling agent, silane coupling agent). Above all, treatment with a silane coupling agent is especially effective.

The coupling agent is used for surface treatment as a surface-treating agent for inorganic particles in the low-refractivity layer before a coating liquid for the layer is prepared, but it is preferably added to the coating liquid for the layer as an additive thereto while the coating liquid is prepared, and it is thereby added to the layer.

It is desirable that the inorganic particles are previously dispersed in a medium before their surface treatment for reducing the load of the surface treatment.

At least one layer of the low-refractivity layer that constitute the antireflection film of the invention and the optional hard coat layer that may be in the film preferably contains an organosilane compound or a hydrolyzate and/or partial condensate of an organosilane compound (sol component) in the coating liquid to form the layer from the viewpoint of the scratch resistance of the layer. Preferably, the sol component is added to all the layers that contain inorganic particles or an inorganic filler, as it forms an organic/inorganic matrix to thereby increase the film strength. After the coating liquid has been applied to a substrate, the sol component therein may be condensed to form a cured product during the heating and drying process, and it may be a binder in the layer formed of the coating liquid. When the cured product has a polymerizing unsaturated bond, then it may form a binder having a three-dimensional structure through irradiation with active rays.

Preferably, the organosilane compound is represented by the following formula [A]:

(R¹⁰)ₘSi(X)₄₋m [A]

In formula [A], R¹⁰ represents a substituted or unsubstituted alkyl group, or a substituted or unsubstituted aryl group. The alkyl group includes methyl, ethyl, propyl, isopropyl, hexyl, decyl, hexadecyl. The alkyl group preferably has from 1 to 30 carbon atoms, more preferably from 1 to 16 carbon atoms, even more preferably 1 to 6 carbon atoms. The aryl group includes phenyl, naphthyl, and is preferably a phenyl group.

X represents a hydroxyl group or a hydrolyzable group. The hydrolyzable group includes, for example, an alkoxy group (preferably having from 1 to 5 carbon atoms, e.g., methoxy, ethoxy), a halogen atom (e.g., Cl, Br, I), and R²COO (where R² is preferably a hydrogen atom or an alkyl group having from 1 to 5 carbon atoms; its examples are CH₃COO, C₂H₅COO). Preferably, it is an alkoxy group, more preferably a methoxy group or an ethoxy group.

m indicates an integer of from 1 to 3, preferably 1 or 2, and further preferably 1.

Multiple R¹⁰'s or X's, if any, in the compound may be the same or different.

Not specifically defined, the substituent that may be in R¹⁰ includes, for example, a halogen atom (e.g., fluorine atom, chlorine atom, bromine atom), a hydroxyl group, a mercapto group, a carboxyl group, an epoxy group, an alkyl group (e.g., methyl, ethyl, i-propyl, propyl, t-butyl), an aryl group (e.g., phenyl, naphthyl), an aromatic heterocyclic group (e.g., furyl, pyrazolyl, pyridyl), an alkoxy group (e.g., methoxy, ethoxy, i-propoxy, hexyloxy), an aryloxy group (e.g., phenoxy), an alkylthio group (e.g., methylthio, ethylthio), an arylthio group (e.g., phenylthio), an alkenyl group (e.g., vinyl, 1-propenyl), an acyloxy group (e.g., acetoxy, acryloyloxy, methacryloyloxy), an alkoxycarbonyl group (e.g., methoxycarbonyl, ethoxycarbonyl), an aryloxycarbonyl group (e.g., phenoxycarbonyl), a carbamoyl group (e.g., carbamoyl, N-methylcarbamoyl, N,N-dimethylcarbamoyl, N-methyl-N-octylcarbamoyl), an acylamino group (e.g., acetylamino, benzoylamino, acrylamino, methacrylamino). These substituents may be further substituted.

Of multiple R¹⁰'s, if any, in the compound, at least one is preferably a substituted alkyl group or a substituted aryl group. In particular, vinyl-polymerizing substituent-having organosilane compounds of the following formula [B] are preferred for use herein.

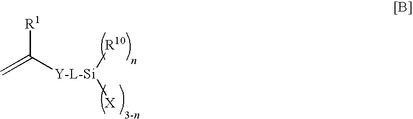

In formula [B], R¹ represents a hydrogen atom, or a methyl group, a methoxy group, an alkoxycarbonyl group, a cyano group, a fluorine atom, or a chlorine atom. The alkoxycarbonyl group includes methoxycarbonyl and ethoxycarbonyl. Preferably, R¹ is a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, even more preferably a hydrogen atom or a methyl group.

Y represents a single bond, or *—COO—**, *—CONH—** or *—O—**, preferably a single bond, *—COO—** or *—CONH—**, more preferably a single bond or *—COO—**, even more preferably *—COO—**. * indicates a position of the group at which the group bonds to ═C(R¹)—; and ** indicates a position of the group wt which the group bonds to L.

L represents a divalent linking chain. Concretely, it represents a substituted or unsubstituted alkylene group, a substituted or unsubstituted arylene group, a substituted or unsubstituted alkylene group having a linking group (e.g., ether, ester, amido) inside it, or a substituted or unsubstituted arylene group having a linking group inside it; preferably, it is a substituted or unsubstituted alkylene group, a substituted or unsubstituted arylene group, an unsubstituted alkylene group having a linking group inside it, more preferably an unsubstituted alkylene group, an unsubstituted arylene group, or an unsubstituted alkylene group having an ether or ester linking group inside it, even more preferably an unsubstituted alkylene group or an unsubstituted alkylene group having an ether or ester linking group inside it. The substituent for these includes a halogen atom, a hydroxyl group, a mercapto group, a carboxyl group, an epoxy group, an alkyl group and an aryl group, and these substituents may be further substituted.

n indicates 0 or 1. Multiple X's, if any, in the compound may be the same or different. n is preferably 0.

R¹⁰ has the same meaning as in formula [A], and is preferably a substituted or unsubstituted alkyl group, or an unsubstituted aryl group, more preferably an unsubstituted alkyl group or an unsubstituted aryl group.

X has the same meaning as in formula [A], and is preferably a halogen atom, a hydroxyl group, or an unsubstituted alkoxy group, more preferably a chlorine atom, a hydroxyl group or an alkoxy group having from 1 to 6 carbon atoms, even more preferably a hydroxyl group or an alkoxy group having from 1 to 3 carbon atoms, still more preferably a methoxy group.

Two or more different types of the compounds of formula [A] and formula [B] may be used herein, as combined. Specific examples of the compounds of formula [A] and formula [B] are shown below, to which, however, the invention should no be limited.

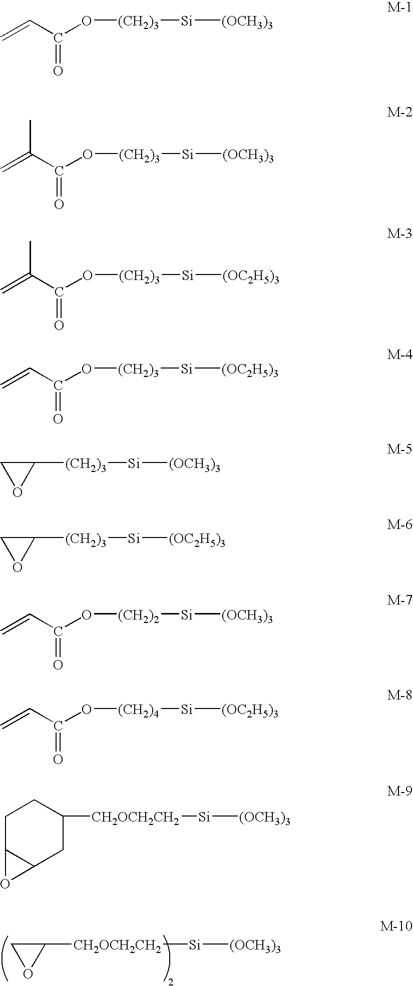

Of these examples, especially preferred are (M-1), (M-2) and (M-5).

Hydrolyzates and/or partial condensates of organosilane compounds for use in the invention are described in detail hereinunder.

Hydrolysis and/or condensation of organosilane is generally effected in the presence of a catalyst. The catalyst includes inorganic acids such as hydrochloric acid, sulfuric acid, nitric acid; organic acids such as oxalic acid, acetic acid, formic acid, methanesulfonic acid, toluenesulfonic acid; inorganic bases such as sodium hydroxide, potassium hydroxide, ammonia; organic bases such as triethylamine, pyridine; metal alkoxides such as aluminium triisopropoxide, zirconium tetrabutoxide; and metal chelate compounds with a center metal of Zr, Ti, Al or the like. The inorganic acid is preferably hydrochloric acid or sulfuric acid; and the organic acid preferably has an acid dissociation constant in water (pKa value at 25° C.) of at most 4.5. More preferred are hydrochloric acid, sulfuric acid, and organic acids having an acid dissociation constant in water of at most 3.0; even more preferred are hydrochloric acid, sulfuric acid, and organic acids having an acid dissociation constant in water of at most 2.5; still more preferred are organic acids having an acid dissociation constant in water of at most 2.5; further more preferred are methanesulfonic acid, oxalic acid, phthalic acid, and malonic acid; especially preferred is oxalic acid

Hydrolysis/condensation of organosilane may be effected in the absence of a solvent or in a solvent. Preferably, it is effected in an organic solvent for uniformly mixing the components therein. For examples, preferably used are alcohols, aromatic hydrocarbons, ethers, ketones, esters.

Preferably, the solvent may dissolve both organosilane and catalyst. Also preferably, the organic solvent is used as a coating liquid or as a part of a coating liquid in view of the processability of the composition. Further preferably, the organic solvent does not detract from the solubility and the dispersibility of the fluoropolymer and other materials when mixed with them.

The alcohols are preferably a monoalcohols or dialcohols; and the monoalcohols are preferably saturated aliphatic alcohols having from 1 to 8 carbon atoms.

Examples of the alcohols are methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether, ethylene glycol acetate monoethyl ether.

Examples of the aromatic hydrocarbons are benzene, toluene, xylene; examples of the ethers are tetrahydrofuran, dioxane; examples of the ketones are acetone, methyl ethyl ketone, methyl isobutyl ketone, diisobutyl ketone; examples of the esters are ethyl acetate, propyl acetate, butyl acetate, propylene carbonate.

One or more of these organic solvents may be used herein either singly or as combined. Not specifically defined, the solid concentration in the reaction may be generally from 1% to 90%, preferably from 20% to 70%.

Water is added to an organosilane in an amount of from 0.3 to 2 mols, preferably from 0.5 to 1 mol relative to one mol of the hydrolyzing group of the organosilane, and this is stirred in the presence or absence of a solvent and in the presence of a catalyst at 25 to 100° C.

In the invention, it is desirable that the hydrolysis is effected in the presence of at least one metal chelate compound that comprises, as a ligand, an alcohol of a formula R₃OH (where R₃ is an alkyl group having from 1 to 10 carbon atoms) and a compound of a formula R₄COCH₂COR₅ (where R₄ is an alkyl group having from 1 to 10 carbon atoms, and R₅ is an alkyl group having from 1 to 10 carbon atoms or an alkoxy group having from 1 to 10 carbon atoms), and a center metal selected from Zr, Ti or Al, with stirring at 25 to 100° C.

Not specifically defined, the metal chelate compound may be any one that comprises, as a ligand, an alcohol of a formula R₃OH (where R₃ is an alkyl group having from 1 to 10 carbon atoms) and a compound of a formula R₄COCH₂COR₅ (where R₄ is an alkyl group having from 1 to 10 carbon atoms, and R₅ is an alkyl group having from 1 to 10 carbon atoms or an alkoxy group having from 1 to 10 carbon atoms), and a center metal selected from Zr, Ti or Al, and any metal chelate compound of the type is preferably used in the invention. Falling within the range, two or more different types of such metal chelate compounds may be combined for use herein. Preferably, the metal chelate compound for use in the invention is selected from a group of compounds represented by Zr(OR₃)p1(R₄COCHCOR₅)p2, Ti(OR₃)q1(R₄COCHCOR₅)q2 and Al(OR₃)r1(R₄COCHCOR₅)r2, and these promotes condensation of hydrolyzates and/or partial condensates of the above-mentioned organosilane compounds.

R₃ and R₄ in the metal chelate compound may be the same or different, each representing an alkyl group having from 1 to 10 carbon atoms, concretely, an ethyl group, an n-propyl group, an i-propyl group, an n-butyl group, a sec-butyl group, a t-butyl group, an n-pentyl group, or a phenyl group. R₅ represents an alkyl group having from 1 to 10 carbon atoms like the above, or represents an alkoxy group having from 1 to 10 carbon atoms, for example, a methoxy group, an ethoxy group, an n-propoxy group, an i-propoxy group, an n-butoxy group, a sec-butoxy group, or a t-butoxy group. p1, p2, q1, q2, r1 and r2 in the metal chelate compound each are an integer defined so as to satisfy p1+p2=4, q1+q2=4, r1+r2=3.

Specific examples of the metal chelate compounds are zirconium chelate compounds such as tri-n-butoxyethylacetacetate zirconium, di-n-butoxybis(ethylacetacetate) zirconium, n-butoxytris(ethylacetacetate) zirconium, tetrakis(n-propylacetacetate) zirconium, tetrakis(acetylacetacetate) zirconium, tetrakis(ethylacetacetate) zirconium; titanium chelate compounds such as diisopropoxy-bis(ethylacetacetate) titanium, diisopropoxy-bis(acetylacetate) titanium, diisopropoxy-bis(acetylacetone) titanium; aluminium chelate compounds such as diisopropoxyethylacetacetate aluminium, diisopropoxyacetylacetonate aluminium, isopropoxybis(ethylacetacetate) aluminium, isopropoxybis(acetylacetonate) aluminium, tris(ethylacetacetate) aluminium, tris(acetylacetonate) aluminium, monoacetylacetonate-bis(ethylacetacetate) aluminium.

Of those metal chelate compounds, preferred are tri-n-butoxyethylacetacetate zirconium, diisopropoxybis(acetylacetonate) titanium, diisopropoxyethylacetacetate aluminium, and tris(ethylacetacetate) aluminium. One or more of these metal chelate compounds may be used either singly or as combined. Partial hydrolyzates of these metal chelate compounds may also be used.

In the invention, the metal chelate compound is used preferably in a ratio thereof to the organosilane of from 0.01 to 50% by mass, more preferably from 0.1 to 50% by mass, even more preferably from 0.5 to 10% by mass. If the ratio is smaller than 0.01% by mass, then it is undesirable since the speed of the condensation reaction of the organosilane compound will be too slow and the durability of the coating film may worsen. On the other hand, if the ratio is larger than 50% by mass, then it is also undesirable since the storage stability of the composition that contains a hydrolyzate and/or a partial condensate of the organosilane compound and the metal chelate compound may worsen.

To the coating liquids for the hard coat layer and the low-refractivity layer in the invention, preferably added are a β-diketone compound and/or a β-diketo-ester compound, in addition to the composition that contains the organosilane hydrolyzate and/or partial condensate and the metal chelate compound mentioned above. This is described below.

β-diketone compounds and/or β-diketo-ester compounds usable in the invention are represented by a formula R₄COCH₂COR₅, and these act as a stability improver for the composition for use in the invention. Specifically, the compound may coordinate with the metal atom in the above-mentioned metal chelate compound (zirconium, titanium and/or aluminium compounds) thereby to prevent the metal chelate compound from promoting the condensation reaction of the hydrolyzate and/or partial condensate of the organosilane compound and to improve the storage stability of the resulting composition. R₄ and R₅ constituting the β-diketone compound and/or the β-diketo-ester compound may have the same meanings as R₄ and R₅ constituting the metal chelate compound.

Specific examples of the β-diketone compounds and/or the β-diketo-ester compounds are acetylacetone, methyl acetacetate, ethyl acetacetate, n-propyl acetacetate, i-propyl acetacetate, n-butyl acetacetate, sec-butyl acetacetate, t-butyl acetacetate, 2,4-hexanedione, 2,4-heptanedione, 3,5-heptanedione, 2,4-octanedione, 2,4-nonanedione, 5-methylhexanedione. Of those, preferred are ethyl acetacetate and acetylacetone; and more preferred is acetylacetone. One or more such β-diketone compounds and/or β-diketo-ester compounds may be used herein either singly or as combined. In the invention, the amount of the β-diketone compound and/or the β-diketo-ester compound is preferably at least 2 mol %, more preferably from 3 to 20 mols relative to 1 mol of the metal chelate compound. If the amount is smaller than 2 mols, then it is unfavorable since the storage stability of the composition may be poor.

The amount of the organosilane hydrolyzate and/or partial condensate to be in the composition is preferably smaller when the composition is to form a relatively thin surface layer, but is preferably larger when it is to form a relatively thick under layer. When the composition (containing the additive, organosilane hydrolyzate and/or partial condensate) is to form a surface layer such as a low-refractivity layer, the amount of the additive is preferably from 0.1 to 50% by mass, more preferably from 0.5 to 20% by mass, most preferably from 1 to 10% by mass of the total solid content of the layer that contains the additive.

When the additive, organosilane compound hydrolyzate and/or partial condensate is added to any other layer than the low-refractivity layer, then its amount is preferably from 0.001 to 50% by mass, more preferably from 0.01 to 20% by mass, even more preferably from 0.05 to 10% by mass, still more preferably from 0.1 to 5% by mass of the total solid content of the layer (containing the additive).

In the invention, a composition that contains the organosilane compound hydrolyzate and/or partial condensate and the metal chelate compound mentioned above is prepared, to which is added a β-diketone compound and/or a β-diketo-ester compound. Then, the resulting liquid mixture is added to at least one coating liquid for a hard coat layer or a low-refractivity layer, and the resulting coating liquid is applied to a substrate to form the intended layer thereon. This is one preferred embodiment of the invention.

The amount of the sol component of the organosilane to the fluoropolymer in the low-refractivity layer in the invention is preferably from 5 to 100% by mass, more preferably from 5 to 40% by mass, even more preferably from 8 to 35% by mass, still more preferably from 10 to 30% by mass. If the amount of the sol component is too small, then it is unfavorable since the effect of the invention may be poor; but if too large, then it is also unfavorable since the refractivity may increase too much or the shape and the surface profile of the film formed may worsen.

In the invention, a dispersion stabilizer is preferably used in the layer-forming coating liquid for preventing the inorganic particles and the inorganic filler from aggregating and depositing therein. For the dispersion stabilizer, usable are polyvinyl alcohol, polyvinyl pyrrolidone, cellulose derivatives, polyamides, phosphates, polyethers, surfactants, silane coupling agents, titanium coupling agents. In particular, silane coupling agents are preferred as effective for enhancing the strength of the cured films. The amount of the silane coupling agent serving as a dispersion stabilizer is not specifically defined. For example, the amount may be at least 1 part by mass relative to 100 parts by mass of the inorganic filler. The method of adding the dispersion stabilizer is not also specifically defined. For example, the stabilizer may be previously hydrolyzed before it is added to the composition, or the silane coupling agent serving as a dispersion stabilizer may be mixed with an inorganic filler and then it may be hydrolyzed and condensed. Of the two, the latter is preferred.

Surface treatment can be carried out by using an inorganic or organic surface treatment agent. As the examples of the inorganic compound used for surface treatment, inorganic compounds containing cobalt (for example, CoO₂, CO₂O₃ and CO₃O₄), inorganic compounds containing aluminum (for example, Al₂O₃ and Al(OH)₃), inorganic compounds containing zirconium (for example, ZrO₂ and Zr(OH)₄), inorganic compounds containing silicon (for example, SiO₂), and inorganic compounds containing iron (for example, Fe₂O₃) are included. Among them, those containing cobalt, those containing aluminum, and those containing zirconium are particularly preferred, and those containing cobalt, Al(OH)₃ and Zr(OH)₄ are the most preferred.

Examples of the organic compound used for surface treatment include a polyol, an alkanolamine, stearic acid, a silane-coupling agent and a titanate-coupling agent. Among these, silane-coupling agents are most preferred. In particular, surface treatment with at least one of silane-coupling agents (organo silane compounds), partially hydrolyzed products thereof and condensation products thereof is preferred.

As the titanate-coupling agent, metal alkoxides such as, for example, tetramethoxytitanium, tetraethoxytitanium and tetraisopropoxytitanium, and Plane act (KR-TTS, KR-46B, KR-55 and KR-41B, all being the products of Ajinomoto Co., Inc.) are mentioned.

As the organic compound used for surface treatment, polyols, alkanolamines and other ones having an anionic group are preferred, and particularly preferable ones are those having a carboxylic group, a sulfonic acid group or a phosphoric acid group. Stearic acid, lauric acid, oleic acid, linoleic acid and linolenic acid can be preferably used.

The organic compound used for surface treatment preferably has a crosslinkable or polymerizable functional group. As the crosslinkable or polymerizable functional group, ethylenically unsaturated groups which are capable of undergoing addition reaction or polymerization reaction due to radical species (for example, (meth)acrylic group, allyl group, styryl group and vinyloxy group), cationic polymerizable groups, (for example, epoxy group, oxetanyl group and vinyloxy group) and polycondensation reactive groups (for example, hydrolyzable silyl group and N-methylol group) are mentioned. Among these, ethylenically unsaturated groups are preferred. Further, from the viewpoint of enhancing the dispersion stability in a fluorine-containing polymer, a surface treatment agent containing a fluorine atom is preferred.

Such surface treatment agents can be used in combination of two or more of them, and, in particular, combined use of an aluminum-containing inorganic compound with a zirconium-containing inorganic compound is preferred.

In the case where the inorganic particles are silica, use of a coupling agent is particularly preferred. As the coupling agent, an alkoxymetal compound (for example, titanium-coupling agent and silane-coupling agent) is preferably used. Treatment with a silane-coupling agent is particularly effective.

Though the use amount of such a surface treatment agent is not specifically limited, use of from 1 to 100 parts by mass relative to the inorganic particles is preferred, use of from 1 to 50 parts by mass is more preferred, and use of from 2 to 30 parts by mass is most preferred.

Specific compounds as the surface treatment agent and the surface treatment catalyst that can be preferably used in the invention are the organosilane compounds and the catalysts set forth in, for example, WO 2004/017105.

For making the low-refractivity layer have various properties of stain resistance, waterproofness, chemical resistance and lubricity, an anti-staining agent and a lubricant of, for example, known silicone compounds or fluorine-containing compounds may be suitably added to the layer. When the additive is added to the layer, then its amount is preferably from 0.01 to 20% by mass, more preferably from 0.05 to 10% by mass, even more preferably from 0.1 to 5% by mass of the total solid content of the layer.

Preferred examples of the silicone compound are those having a substituent at least in any of terminals and side branches of a compound chain that contains multiple dimethylsilyloxy units as repetitive units. The compound chain containing repetitive dimethylsilyloxy units may contain any other structural unit than dimethylsilyloxy units. Preferably, the compound contains multiple substituents that may be the same or different. Examples of preferred substituents are those containing any of an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group, and amino group. Though not specifically defined, the molecular weight of the compound is preferably at most 100,000, more preferably at most 50,000, most preferably from 3000 to 30,000. Also not specifically defined, the silicone atom content of the silicone compound is preferably at least 18.0% by mass, more preferably from 25.0 to 37.8% by mass, most preferably from 30.0 to 37.0% by mass. Examples of the preferred silicone compounds are Shin-etsu Chemical's X-22-174DX, X-22-2426, X-22-164B, X22-164C, X-22-170DX, X-22-176D, X-22-1821 (all trade names), Chisso's FM-0725, FM-7725, DMS-U22, RMS-033, RMS-083, UMS-182 (all trade names), to which, however, the invention is not limited.

The fluorine-containing compound is preferably a fluoroalkyl group-having compound. Preferably, the fluoroalkyl group has from 1 to 20 carbon atoms, more preferably from 1 to 10 carbon atoms, and it may have a linear structure (e.g., —CF₂CF₃, —CH₂(CF₂)₄H, —CH₂(CF₂)₈CF₃, —CH₂CH₂(CF₂)₄), or a branched structure (e.g., —CH(CF₃)₂, —CH₂CF(CF₃)₂, —CH(CH₃)CF₂CF₃, —CH(CH₃)(CF₂)₅CF₂H), or an alicyclic structure (preferably 5-membered or 6-membered, e.g., a perfluorocyclohexyl group, a perflulrocyclopentyl group, or an alkyl group substituted with any of these); or it may have an ether bond (e.g., —CH₂OCH₂CF₂CF₃, —CH₂CH₂OCH₂C₄F₈H, —CH₂CH₂OCH₂CH₂C₂C₈F₁₇, —CH₂CH₂OCF₂CF₂OCF₂CF₂H). One molecule of the compound may have multiple fluoroalkyl groups.

Preferably, the fluorine-containing compound contains a substituent that contributes to the formation of a bond to the film of the low-refractivity layer or to the compatibility with the film. Also preferably, the compound has multiple substituents of the type, which may be the same or different. Examples of the preferred substituent are an acryloyl group, a methacryloyl group, a vinyl group, an aryl group, a cinnamoyl group, an epoxy group, an oxetanyl group, a hydroxyl group, a polyoxyalkylene group, a carboxyl group, and an amino group. The fluorine-containing compound may be a polymer or an oligomer with a compound not containing a fluorine atom, and its molecular weight is not specifically defined. Also not specifically defined, the fluorine atom content of the fluorine-containing compound is preferably at least 20% by mass, more preferably from 30 to 70% by mass, most preferably from 40 to 70% by mass. Examples of the preferred fluorine-containing compound are Daikin Chemical Industry's R-2020, M-2020, R-3833, M-3833 (all trade names), Dai-Nippon Ink's Megafac F-171, F-172, F-179A, Diffenser MCF-300 (all trade names), to which, however, the invention should not be limited.

For making the layer have dust-resistant and antistatic properties, a dust-resistant or antistatic agent such as known cationic surfactants or polyoxyalkylene compounds may also be added to the layer. The dust-resistant agent and the antistatic agent may be a part of the function of the structural units of the above-mentioned silicone compounds and fluorine-containing compounds. When these are added to the layer as additives thereto, their amount is preferably from 0.01 to 20% by mass, more preferably from 0.05 to 10% by mass, even more preferably from 0.1 to 5% by mass of the total solid content of the low-refractivity layer. Examples of preferred compounds for the agents are Dai-Nippon Ink's Megafac F-150 (trade name) and Toray-Dow Corning's SH-3748 (trade name), but these are not limitative.

### [High/Middle-Refractivity Layer]

Preferably, the antireflection film of the invention has a high/middle-refractivity layer between the transparent support and the low-refractivity layer. The material to constitute the high/middle-refractivity layer is described below.

The refractive index of the high/middle-refractivity layer of the antireflection film of the invention is preferably from 1.50 to 2.40, more preferably from 1.50 to 1.80.

The high/middle-refractivity layer comprises at least a film-forming binder and may contain an inorganic filler for controlling the refractivity of the other layer and for reducing the curing shrinkage of itself.

### <Film-Forming Binder>

For the principal film-forming binder component of the film-forming composition for forming each layer of the high/middle-refractivity layers in the invention, preferably used is an ethylenic unsaturated group-having compound from the viewpoint of the film strength, the coating liquid stability, and the coating film producibility.

The principal film-forming binder means an ingredient that accounts for at least 10% by mass of the film-forming component except an inorganic filler. Preferably, it accounts for from 20% by mass to 100% by mass, more preferably from 30% by mass to 95% by mass.

The film-forming binder is preferably a polymer having a saturated hydrocarbon chain or a polyether chain as the backbone chain thereof, more preferably having a saturated hydrocarbon chain as the backbone chain thereof. Also preferably, the saturated hydrocarbon chain has a crosslinked structure.

The binder polymer that has a saturated hydrocarbon chain as the backbone chain thereof and has a crosslinked structure is preferably a (co)polymer of a monomer having two or more ethylenic unsaturated groups.

For making the film has a higher refractivity, it is desirable that the monomer structure contains an aromatic ring or at least one atom selected from a halogen atom (except fluorine atom), a sulfur atom, a phosphorus atom and a nitrogen atom.

The monomer having at least two ethylenic unsaturated groups include esters of polyalcohols and (meth)acrylic acids (e.g., ethylene glycol di(meth)acrylate, 1,4-cyclohexane diacrylate, pentaerythritol tetra(meth)acrylate, pentaerythritol (meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), vinylbenzenes and their derivatives (e.g., 1,4-divinylbenzene, 2-acryloylethyl 4-vinylbenzoate, 1,4-divinylcyclohexanone), vinylsulfones (e.g., divinylsulfone), acrylamides (e.g., methylenebisacrylamide) and methacrylamides. Two or more such monomers may be combined for use herein. In this description, “(meth)acrylate” means “acrylate or methacrylate”.

Examples of the high-refractivity monomer are bis(4-methacryloylthiophenyl)sulfide, vinylnaphthalene, vinylphenyl sulfide, 4-methacryloxyphenyl-4′-methoxyphenyl thioether. Two or more these monomers may also be combined for use herein.

Polymerization of these ethylenic unsaturated group-having monomers may be attained by irradiating them with ionizing radiation or by heating them in the presence of the above-mentioned photoradical initiator or thermal radical initiator.

In the invention, also usable is a polymer having a polyether as the backbone chain thereof. For it, preferred is a ring-cleaved polymer of a polyfunctional epoxy compound. Ring-cleaving polymerization of a polyfunctional epoxy compound may be attained by irradiating it with ionizing radiation or by heating it in the presence of an optical acid generator, or thermal acid generator.

In place of or in addition to the monomer having at least two ethylenic unsaturated groups, a crosslinking functional group-having monomer may be used for introducing the crosslinking functional group into the polymer, and a crosslinked structure may be introduced into the binder polymer by the reaction of the crosslinking functional group.

Examples of the crosslinking functional group are an isocyanate group, an epoxy group, an aziridine group, an oxazoline group, an aldehyde group, a carbonyl group, a hydrazine group, a carboxyl group, a methylol group, an active methylene group. Vinylsulfonic acids, acid anhydrides, cyanoacrylate derivatives, melamines, etherified methylols, esters, urethanes, metal alkoxides such as tetramethoxysilane may also be utilized as a monomer for introducing a crosslinked structure into the polymer. Also usable is a functional group capable of exhibiting a crosslinking ability as a result of decomposition reaction, such as a blocked isocyanate group may also be used herein. In other words, in the invention, the crosslinking functional group may not be one that is directly reactive but may be one capable of being reactive as a result of decomposition.

The crosslinking functional group-having monomer may form a crosslinked structure by heating it after applied onto a substrate.

### <Inorganic Filler for High/Middle-Refractivity Layer>

Preferably, the high-refractivity layer contains an inorganic filler of at least one metal oxide selected from titanium, zirconium, aluminium, indium, zinc, tin and antimony and having a mean particle size of at most 0.2 μm, more preferably at most 0.1 μm, even more preferably at most 0.06 μm in order to increase the refractivity of the layer and to reduce the curing shrinkage of the layer.

Specific examples of the inorganic filler usable in the high-refractivity layer are TiO₂, ZrO₂, Al₂O₃, In₂O₃, ZnO, SnO₂, Sb₂O₃, ITO, SiO₂. TiO₂ and ZrO₂ are especially preferred in view of their ability to increase the refractivity of the layer. Preferably, the inorganic filler is subjected to surface treatment with a silane coupling agent or a titanium coupling agent. For the treatment, preferably used is a surface-treating agent that may give a functional group capable of reacting with a binder species, to the filler surface.

Among these high refractive index particles, inorganic particles having, as a principal ingredient, TiO₂ containing at least one element selected from the group consisting of cobalt, aluminum and zirconium are particularly preferred. Here, the principal ingredient indicates the one whose content (% by mass) is the largest among the ingredients constituting the particle.

The particle mainly comprising TiO₂ used in the present invention preferably has a refractive index of from 1.90 to 2.80, more preferably from 2.10 to 2.80, and the most preferably from 2.20 to 2.80.

The weight average particle size of the primary particle for the one mainly comprising TiO₂ is preferably from 1 to 200 nm, more preferably from 1 to 150 nm, still more preferably from 1 to 100 nm, and the most preferably from 1 to 80 nm.

With respect to the crystal structure of the particle mainly comprising TiO₂, it is preferred that rutile structure, rutile/anatase mixed crystalline structure, anatase structure, or amorphous structure is principal. Here, the principal structure indicates the one whose content (% by mass) is the largest among the structures constituting the particle.

The weather resistance of the film in accordance with the present invention can be improved by suppressing the photo-catalytic activity of TiO₂ by incorporating at least one element selected from the group consisting of Co (cobalt), Al (aluminum) and Zr (zirconium) in the particle in which TiO₂ is the principal ingredient.

Particularly preferable element is Co (cobalt). In addition, two or more elements may be preferably used in combination.

The inorganic particle whose principal ingredient is TiO₂ may have a core/shell structure via surface treatment, as set forth in Japanese Patent Laid-open No. 2001-166104.

The amount of the inorganic filler to be added to the layer is preferably from 10 to 90% by mass, more preferably from 20 to 80% by mass, even more preferably from 30 to 70% by mass of the total mass of the high-refractivity layer.

Since the filler's particle size is sufficiently smaller than the wavelength of light, the filler does not cause light scattering therearound, and the dispersion formed by dispersing the filler in a binder polymer behaves as an optically uniform substance as a whole.

The refractive index of the bulk of a mixture of a binder and an inorganic filler for the high-refractivity layer of the invention is preferably from 1.48 to 2.00, more preferably from 1.50 to 1.80. In order to control the refractivity within the range as above, the type and the blend ratio of the binder and the inorganic filler shall be suitably determined. Through experiment, anyone skilled in the art could readily and previously know how to determine them.

Preferably, the antireflection film of the invention has a middle-refractivity layer of which the refractivity is lower than that of the high-refractivity layer but higher than the support, in which the middle-refractivity layer may be formed like the high-refractivity layer therein by controlling the amount of the high-refractivity inorganic layer and the high-refractivity monomer that are to be in the high-refractivity layer.

### [Hard Coat Layer, Antiglare Hard Coat]

Preferably, the antireflection film of the invention has a hard coat layer. The hard coat layer may be a non-antiglare hard coat layer or an antiglare hard coat layer, and any one of these is preferred for use in the invention. The antiglare property is described.

### <Antiglare Property>

The antiglare property is generally evaluated in an organoleptic test where a film sample having a black-coated back is used. For objective analysis, its data may be correlated with optically-determined data. The correlation therebetween may vary depending on the coating mode and the layer constitution. In many cases, for example, there may be given a certain correlation between the organoleptic test data and the data of haze, transmitted image sharpness, scattering angle distribution. Preferably, with respect to the antireflection film of the invention, there is given a correlation between the organoleptic test data and the data of transmitted image sharpness.

For reducing the influence of scratches on the film and for evading blurred images, the transmitted image sharpness through the antireflection film of the invention is preferably from 10% to 99%.

When the hard coat layer of the film of the invention has an antiglare property (that is, when it is an antiglare hard coat layer), then the transmitted image sharpness through the layer is preferably from 10% to less than 65%, more preferably from 10% to 55%, most preferably from 15% to 50%. When the hard coat layer of the film of the invention does not have an antiglare property (that is, when it is a non-antiglare hard coat layer), then the transmitted image sharpness through the layer is preferably from 65% to 99%, more preferably from 70% to 88%, most preferably from 80% to 99%.

### <Constitution of Hard Coat>

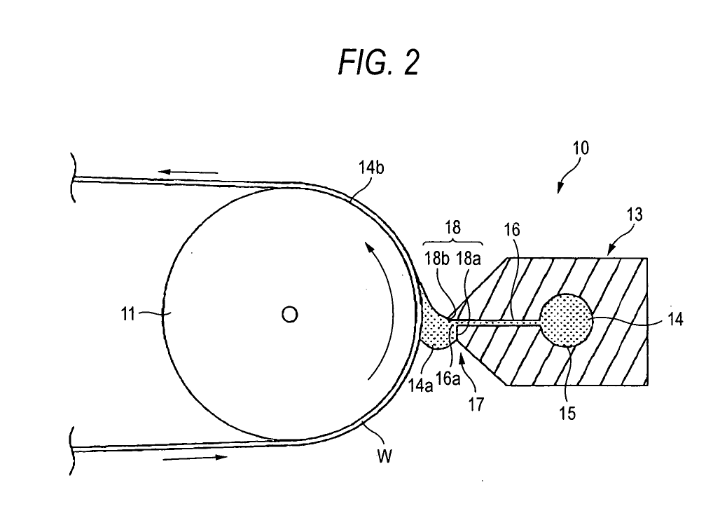

The hard coat layer of the antireflection film is a non-antiglare, or that is, flat hard coat layer for imparting physical strength to the film. As in FIGS. 1A, 1B and 2, the hard coat layer is preferably formed on the surface of a transparent support, especially between a transparent support and the above-mentioned antiglare hard coat layer, or between a transparent support and a high-refractivity layer.

Preferably, the hard coat layer is formed through crosslinking reaction or polymerization of an ionizing radiation-curable compound. For example, a coating composition containing an ionizing radiation-curable polyfunctional monomer or oligomer is applied onto a transparent support, on which the polyfunctional monomer or oligomer is crosslinked or polymerized to form the intended hard coat layer.

The functional group of the ionizing radiation-curable polyfunctional monomer or oligomer is preferably a photopolymerizable, electron ray-polymerizable or radiation-polymerizable functional group, more preferably a photopolymerizable functional group. The photopolymerizable functional group may be an unsaturated polymerizable functional group such as a (meth)acryloyl group, a vinyl group, a styryl group, an allyl group. Above all, preferred is a (meth)acryloyl group. Examples of such polyfunctional monomers are described in JP-A 2003-4903, which are employable herein.

Preferably, the hard coat layer contains an inorganic filler having a mean particle size of at most 200 nm as primary particles thereof. The mean particle size as referred to herein is a mass-average particle size. Particles having a mean particle size of at most 200 nm as primary particles may be in the hard coat layer not detracting from the transparency of the layer.

Examples of the inorganic filler are those mentioned hereinabove for the inorganic filler for the high-refractivity layer, and in addition, particles of silicon dioxide, aluminium oxide, calcium carbonate, barium sulfate, talc, kaolin, calcium sulfate, titanium dioxide, zirconium oxide, tin oxide, ITO, zinc oxide. Preferred are silicon dioxide, titanium dioxide, zirconium oxide, aluminium oxide, tin oxide, ITO, zinc oxide.

Regarding the mean particle size of the primary particles of the inorganic filler and the mean particle size of the actually-dispersed particles in the hard coat layer, referred to are those mentioned hereinabove for the high-refractivity layer. Preferably, the inorganic filler content of the hard coat layer is from 10 to 90% by mass, more preferably from 15 to 80% by mass, even more preferably from 15 to 75% by mass of the total mass of the hard coat layer.

The thickness of the hard coat layer may be suitably varied depending on the use of the film. Preferably, the thickness of the hard coat layer is from 0.2 to 10 μm, more preferably from 0.5 to 7 μm, even more preferably from 0.7 to 5 μm.

Preferably, the strength of the hard coat layer is at least “H” in terms of the pencil hardness in the pencil hardness test according to JIS K5400, more preferably at least 2H, most preferably at least 3H.

Also preferably, the amount of abrasion of the hard coat layer is as small as possible in the test piece before and after a Taber's test according to JIS K5400.

Regarding the oxygen concentration in forming the hard coat layer through crosslinking reaction or polymerization reaction of an ionizing radiation-curable compound, referred to is the same as described hereinabove for the high-refractivity layer.

### <Constitution of Antiglare Hard Coat Layer>

The antiglare hard coat layer is described below.

The antiglare hard coat layer contains a binder for imparting a hard coat property to the film and contains mat particles for imparting an antiglare property thereto, and may optionally contain an inorganic filler for increasing the refractivity of the film, for preventing the film from shrinking by crosslinking and for increasing the strength of the film.

The binder is preferably a binder polymer having a saturated hydrocarbon chain or a polyether chain as the backbone chain thereof, more preferably a binder polymer having a saturated hydrocarbon chain as the backbone chain thereof. Also preferably, the binder polymer has a crosslinked structure.

As the binder polymer having a saturated hydrocarbon chain as the backbone chain thereof, preferred is a polymer of an ethylenic unsaturated monomer. As the binder polymer having a saturated hydrocarbon chain as the backbone chain thereof and having a crosslinked structure, preferred is a (co)polymer of a monomer having at least two ethylenic unsaturated groups.

For increasing the refractivity of the binder polymer, it is desirable that the monomer structure contains an aromatic ring, and at least one atom selected from a halogen atom (except fluorine atom), a sulfur atom, a phosphorus atom and a nitrogen atom.

As the monomer having at least two ethylenic unsaturated group, preferably used herein are the polyfunctional monomers described in JP-A 2003-4903.

Examples of the high-refractivity monomer are bis(4-methacryloylthiophenyl) sulfide, vinylnaphthalene, vinylphenyl sulfide, 4-methacryloxyphenyl-4′-methoxyphenyl thioether. Two or more these monomers may also be combined for use herein.

The antiglare hard coat layer may be formed by preparing a coating liquid that contains an ethylenic unsaturated group-having monomer as a binder polymer-forming material, a photoradical initiator or a thermal radical initiator, and mat agent particles and an inorganic filler, applying the coating liquid onto a transparent support and curing it thereon through polymerization by ionizing radiation or heat.

For the photoradical initiator, preferably used are those mentioned hereinabove. Some photo-cleavable photoradical initiators are commercially available, and usable herein. For example, Nippon Ciba-Geigy's Irgacure (651, 184, 907) are preferred for use herein.

Preferably, the amount of the photoradical initiator to be used herein is from 0.1 to 15 parts by mass relative to 100 parts by mass of the monofunctional monomer, more preferably from 1 to 10 parts by mass.

In addition to the photoradical initiator, an optical sensitizer may also be used. Examples of the optical sensitizer are n-butylamine, triethylamine, tri-n-butyl phosphine, Michler's ketone, thioxanthone.

The thermal radical initiator usable herein includes organic or inorganic peroxides, and organic azo and diazo compounds.

Concretely, the organic peroxides include benzoyl peroxide, halogenobenzoyl peroxide, lauroyl peroxide, acetyl peroxide, dibutyl peroxide, cumene hydroperoxide, butyl hydroperoxide; the inorganic peroxides include hydrogen peroxide, ammonium persulfate, potassium persulfate; the azo compounds include 2-azobisisobutyronitrile, 2-azobispropionitrile, 2-azobiscyclohexane-dinitrile; and the diazo compounds include diazoaminobenzene, and p-nitrobenzene-diazonium.

The antiglare hard coat layer may also be formed by preparing a coating liquid that contains a polyfunctional epoxy compound, an optical acid generator or a thermal acid generator, mat agent particles and an inorganic filler, then applying the coating liquid onto a transparent support and curing it by polymerization through exposure to ionizing radiation or to heat.

In place of or in addition to the monomer that has at least two ethylenic unsaturated groups, a monomer that has a crosslinking functional group may be used so as to introduce the crosslinking functional group into the polymer, and through the reaction of the crosslinking functional group, a crosslinked structure may be introduced into the binder polymer.

Examples of the crosslinking functional group are an isocyanate group, an epoxy group, an aziridine group, an oxazoline group, an aldehyde group, a carbonyl group, a hydrazine group, a carboxyl group, a methylol group, and an active methylene group. Vinylsulfonic acids, acid anhydrides, cyanoacrylate derivatives, melamines, etherified methylols, esters and urethanes, and metal alkoxides such as tetramethoxysilane may also be used as monomers for introducing a crosslinked structure into the polymer. A functional group that may be crosslinkable as a result of decomposition reaction, such as a blocked isocyanate group may also be used. Accordingly, in the invention, the crosslinking functional group may not be one that is directly reactive, but may be one that becomes reactive as a result of decomposition.

The polymer having such a crosslinking functional group may be, after applied onto a support, heated to form the intended crosslinked structure.

The mat agent particles are used for the purpose of imparting an antiglare property to the hard coat layer. Preferably, their mean particle size is from 0.5 to 10 μm, more preferably from 0.5 to 7.0 μm.

The amount of the mat agent particles to be in the layer is preferably from 10 to 1000 mg/m², more preferably from 100 to 700 mg/m². The particle size and the amount of the mat agent particles may have an influence on the antiglare property of the layer, and therefore they may be controlled depending on the layer thickness and the intended antiglare property of the layer.

Preferred examples of the mat agent particles are inorganic compound particles such as silica particles, TiO₂ particles; and resin particles such s acrylic particles, crosslinked acrylic particles, methacrylic particles, crosslinked methacrylic particles, polystyrene particles, crosslinked styrene particles, melamine resin particles, benzoguanamine resin particles. Above all, preferred are crosslinked styrene particles, crosslinked acrylic particles, silica particles.

Regarding their shape, the mat agent particles may be spherical or amorphous, but preferably, they are monodispersed. Two or more different types of mat agent particles having a different particle size may be combined for use herein.

The particle size distribution of the mat agent particles may be determined according to a Coulter counter method in terms of a particle number distribution thereof. Preferably, the antiglare hard coat layer additionally contains an inorganic filler of at least one metal oxide that has a mean particle size of at most 200 nm, preferably at most 100 nm, more preferably at most 60 nm in the form of their dispersion, in addition to the above-mentioned mat agent particles for further increasing the refractivity and the elasticity of the layer. For the inorganic filler, herein usable are the inorganic particles concretely illustrated in JP-A 2003-4903 that are to be in the antiglare layer therein. Preferably, the mean particle size of the primary particles of the inorganic filler is from 1 to 200 nm, more preferably from 2 to 100 nm, even more preferably from 3 to 50 nm.

Also preferably, the inorganic filler may be subjected to surface treatment with a silane coupling agent or a titanium coupling agent. For the treatment, preferably used is a surface-treating agent that may give a functional group capable of reacting with a binder species, to the filler surface.

The amount of the inorganic filler to be added to the layer is preferably from 10 to 90% by mass, more preferably from 20 to 80% by mass, even more preferably from 30 to 70% by mass of the total mass of the antiglare hard coat layer.

Since the filler's particle size is sufficiently smaller than the wavelength of light, the filler does not cause light scattering therearound, and the dispersion formed by dispersing the filler in a binder polymer behaves as an optically uniform substance as a whole.

The refractive index of the bulk of a mixture of a binder and an inorganic filler for the antiglare hard coat layer of the invention is preferably from 1.48 to 2.00, more preferably from 1.50 to 1.80.

Preferably, the difference in the refractive index between the mat agent particles and the binder (refractive index of mat agent particles—refractive index of binder) is from 0.03 to 0.2, more preferably from 0.05 to 0.1. The difference of at least 0.03 enables efficient expression of the antiglare property of the layer; and the difference of at most 0.2 prevents too much increase in the whitish appearance of the layer and prevents cost increase in producing the film.

The refractive index of the binder is preferably from 1.48 to 1.8; and the refractive index of the mat agent particles is preferably from 1.3 to 1.8.

The binder refractivity may be determined with an Abbe's refractometer (by Atago) or an ellipsometer (by Nippon Bunko).

In order to control the refractivity within the range as above, the type and the blend ratio of the binder and the inorganic filler shall be suitably determined. Through experiment, anyone skilled in the art could readily and previously know how to determine them.

Preferably, the thickness of the antiglare hard coat layer is from 1 to 10 μm, more preferably from 2 to 6 μm.

### <Light-Scattering Layer>

Preferably, the antireflection film of the invention has a light-scattering layer. We, the present inventors have confirmed that the scattered light intensity distribution determined by a goniophotometer is correlated with the effect of improving the viewing angle of displays. Specifically, when the light emitted by a backlight is diffused to a higher degree by the light-diffusive film disposed on the surface of the polarizing plate on the viewing side, then the viewing angle characteristics are more bettered. However, if the light is too much diffused, then it may cause some problems in that the backward scattering may increase and the front brightness may decrease, or the scattering may be too great and the image sharpness may be thereby lowered. Accordingly, it is necessary to control the scattered light intensity distribution to fall within a predetermined range. Given that situation, we, the present inventors have further studied and, as a result, have found that, in order to attain the desired visibility characteristic, the scattered light intensity at a light-outgoing angle of 30° in a scattered light profile, which is specifically correlated with the viewing angle-improving effect of displays, is preferably from 0.01% to 0.2%, more preferably from 0.02% to 0.15%, most preferably from 0.03% to 0.1%, relative to the light intensity at a light-outgoing angle of 0°.

The scattered light profile can be formed by analyzing the light-scattering film by the use of an automatically angle-varying photometer, GP-5 Model by Murakami Color Technology Laboratory.

In point of the layer classification of the antireflection film of the invention, the light-scattering layer may correspond to at least any of an antiglare hard coat layer or a high-refractivity layer depending on the transmitted image sharpness through the layer or the refractivity value of the layer.

### [Antistatic Layer]

The antireflection film of the invention may have a transparent antistatic layer of a conductive material for preventing the film from being electrostatically charged. An independent transparent antistatic layer may be provided in the film, or a conductive material may be added to the antiglare hard coat layer, the light-diffusive layer, the high-refractivity layer, the middle-refractivity layer or the low-refractivity layer of the film to thereby make the layer additionally have an antistatic function. Preferably, an antistatic layer is formed between the hard coat layer and the transparent support of the film.

The conductive material preferably comprises particles of a metal oxide or nitride. Examples of the metal oxide or nitride are tin oxide, indium oxide, zinc oxide, and titanium nitride. Of those, especially preferred are tin oxide and indium oxide. The conductive material may comprise such a metal oxide or nitride as the principal ingredient thereof and may contain any other element. The principal ingredient is meant to indicate an ingredient of which the content (% by mass) is the largest of all the constitutive ingredients of the particles. Examples of the other elements are Ti, Zr, Sn, Sb, Cu, Fe, Mn, Pb, Cd, As, Cr, Hg, Zn, Al, Mg, Si, P, S, B, Nb, In, V and halogen atoms. For increasing the conductivity of tin oxide and indium oxide, it is desirable to add any of Sb, P, B, Nb, In, V and halogen atoms thereto. Preferred are antimony-tin oxide, indium-tin oxide, zinc antimonate.

Except these, also preferred for use herein are metal particles ionic polymer compounds, polyoxyalkylene compounds and cationic surfactants. Regarding the antistatic capability thereof, the surface specific resistivity of the antistatic layer is preferably at most 10¹¹ Ω/square (25° C., 60% RH), more preferably at most 10¹⁰ Ω/square. Preferably, the haze of the antistatic layer is at most 20%.

### [Other Layers]

The antireflection film of the invention may further have any other layers of a stain-resistant layer, an overcoat layer, an adhesive layer, an undercoat layer, a shield layer, a lubricant layer, a moisture-resistant layer, etc. These layers may be formed by suitable combination of the above-mentioned film-forming binder, fluoropolymer, inorganic filler, organosilane hydrolyzate and/or partial condensate, silicone-type or fluorine-containing anti-staining agent, lubricant, and/or known polymer, latex, surfactant, etc.

### [Surface-Modifying Agent]

In the invention, it is desirable to add any one of a fluorine-containing surfactant or a silicone-type surfactant or both of the two to each layer of constituting the antireflection film or to a specific layer-forming composition for the film, for the purpose of ensuring the surface uniformity of the film not having any troubles of coating unevenness, drying unevenness or spot defects. In particular, a fluorine-containing surfactant is preferred for that purpose, as it may well exhibit its effect of preventing surface troubles such as coating unevenness, drying unevenness or spot defects of the antireflection film of the invention even though its amount added to the film is smaller.

One object of the surface-modifying agent to be added to the film of the invention is for improving the surface uniformity of the film and for ensuring the high-speed coatability of the layer-forming composition to thereby increase the producibility of the film.

Preferred examples of the fluorine-containing surfactant are fluoroaliphatic group-containing copolymers (these may be abbreviated as “fluoropolymers”). For the fluoropolymers, useful are copolymers of an acrylic resin or a methacrylic resin that contains repetitive units corresponding to the following monomer (i) and a vinylic monomer copolymerizing with it (repetitive units corresponding to a monomer of the following formula (ii)).

(i) Fluoroaliphatic group-containing monomer of the following formula (a):

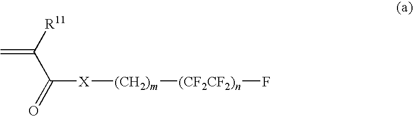

In formula (a), R¹¹ represents a hydrogen atom or a methyl group; X represents an oxygen atom, a sulfur atom or —N(R¹²)—; m indicates an integer of from 1 to 6; n indicates an integer of from 2 to 4; R¹² represents a hydrogen atom or an alkyl group having from 1 to 4 carbon atoms, concretely a methyl group, an ethyl group, a propyl group or a butyl group, preferably a hydrogen atom or a methyl group. X is preferably an oxygen atom.

(ii) Monomer of the following formula (b) capable of copolymerizing with the above (i):

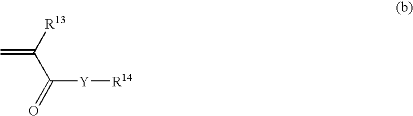

In formula (b), R¹³ represents a hydrogen atom or a methyl group; Y represents an oxygen atom, a sulfur atom or —N(R¹⁵)—; R¹⁵ represents a hydrogen atom or an alkyl group having from 1 to 4 carbon atoms, concretely a methyl group, an ethyl group, a propyl group or a butyl group, preferably a hydrogen atom or a methyl group. Y is preferably an oxygen atom, —N(H)— or —N(CH₃)—.

R¹⁴ represents an optionally-substituted, linear, branched or cyclic alkyl group having from 4 to 20 carbon atoms. Not limited thereto, the substituent for the alkyl group of R¹⁴ includes a hydroxyl group, an alkylcarbonyl group, an arylcarbonyl group, a carboxyl group, an alkylether group, an arylether group, a halogen atom such as a fluorine atom, a chlorine atom or a bromine atom, a nitro group, a cyano group, and an amino group. Preferred examples of the linear, branched or cyclic alkyl group having from 4 to 20 carbon atoms are a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group and an eicosyl group that may be linear or branched; a monocyclic cycloalkyl group such as a cyclohexyl group, a cycloheptyl group; and a polycyclic cycloalkyl group such as a bicycloheptyl group, a bicyclodecyl group, a tricycloundecyl group, a tetracyclododecyl group, an adamantyl group, a norbornyl group, a tetracyclodecyl group.

The amount of the fluoroaliphatic group-having monomer of formula (a) to be in the fluorine-containing surfactant for use in the invention may be at least 10 mol % based on the constitutive monomers of the fluoroaliphatic group-containing copolymer, preferably from 15 to 70 mol %, more preferably from 20 to 60 mol %.

The mass-average molecular weight of the fluoroaliphatic group-having copolymer for use in the invention is preferably from 3,000 to 100,000, more preferably from 5,000 to 80,000.

The amount of the fluoroaliphatic group-having copolymer that may be used in the invention is preferably from 0.001 to 5% by mass of the coating liquid, preferably from 0.005 to 3% by mass, more preferably from 0.01 to 1% by mass. If the amount of the fluoroaliphatic group-having copolymer in the coating liquid is smaller than 0.001% by mass, then the copolymer may be ineffective; and if larger than 5% by mass, then it may have any negative influence on the coating layer in that the coating layer could not be well dried or the properties (e.g., reflectivity, scratch resistance) of the coating layer may be worsened.

Examples of specific structures of the fluorine-containing surfactant that comprises a fluoroaliphatic group-having monomer of formula (a) are shown below, to which, however, the invention should not be limited. In the formulae, the numeral indicates the molar fraction of each monomer component. Mw indicates the mass-average molecular weight of the polymer.

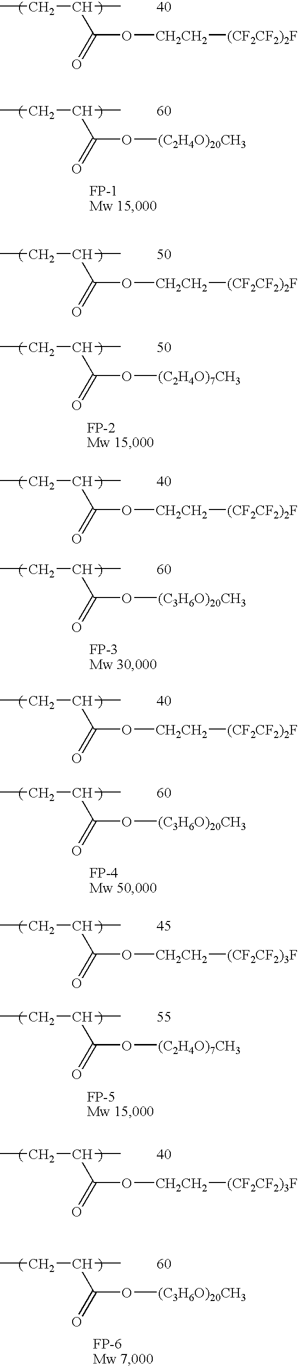

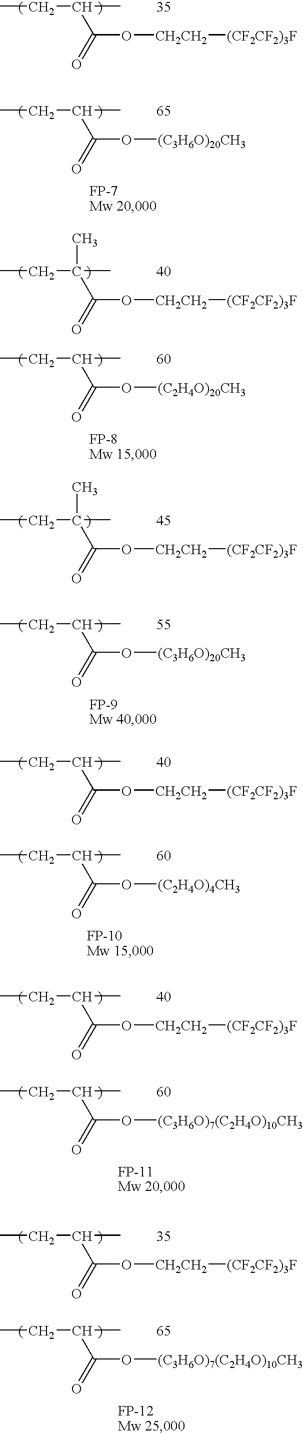

However, using the above-mentioned fluorine-containing surfactant in the underlying layer below the low-refractivity layer in the film of the invention (for example, it is an antiglare hard coat layer, and the following description is to demonstrate an embodiment having an antiglare hard coat layer of the type) may cause some problems in that an F atom-containing functional group may segregate in the surface of the antiglare hard coat layer whereby the surface energy of the antiglare hard coat layer may lower and the antireflection capability of the low-refractivity layer overcoated on the antiglare hard coat layer may worsen. The may be because the wettability of the curing composition to form the low-refractivity layer may worsen and therefore the low-refractivity layer formed may have fine unevenness that could not be detected by visual observation.

To solve the problem, we, the present inventors have found that the structure and the amount of the fluorine-containing surfactant to be added should be specifically so defined that the surface energy of the antiglare hard coat layer could be preferably from 20 mN·m⁻¹ to 50 mN·m⁻¹, more preferably from 30 mN·m⁻¹ to 40 mN·m⁻¹. To realize the surface energy level as above, it is necessary that the ratio of the fluorine atom-derived peak to the carbon atom-derived peak, F/C, determined through X-ray photoelectron spectrometry falls between 0.1 and 1.5.

Apart from the above, a different method may be employed. Concretely, when the upper layer is formed, a fluorine-containing surfactant capable of being extracted out in a solvent in forming the upper layer is selected so as to prevent the surfactant from being segregated in the surface of the lower layer (=interface), and the adhesiveness between the upper layer and the lower layer is ensured. As a result, even in a mode of high-speed coating, the antireflection film formed can still has planar surface uniformity and has good scratch resistance. Examples of the material are copolymers of an acrylic resin or a methacrylic resin that contains repetitive units corresponding to a fluoroaliphatic group-having monomer of the following formula (c), and a vinylic monomer copolymerizable with it (of the following formula (d)).

(iii) Fluoroaliphatic group-containing monomer of the following formula (c):

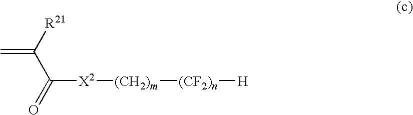

In formula (c), R²¹ represents a hydrogen atom, a halogen atom or a methyl group, preferably a hydrogen atom or a methyl group. X² represents an oxygen atom, a sulfur atom or —N(R²²)—, preferably an oxygen atom or —N(R²²)—, more preferably an oxygen atom. m indicates an integer of from 1 to 6 (preferably from 1 to 3, more preferably 1); n indicates an integer of from 1 to 18 (preferably from 4 to 12, more preferably from 6 to 8). R²² represents a hydrogen atom or an optionally-substituted alkyl group having from 1 to 8 carbon atoms, preferably a hydrogen atom or an alkyl group having from 1 to 4 carbon atoms, more preferably a hydrogen atom or a methyl group. X is preferably an oxygen atom.

The fluorine-containing surfactant may contain two or more fluoroaliphatic group-containing monomers of formula (c) as the constitutive components thereof

(iv) Monomer of the following formula (d) capable of copolymerizing with the above (iii):

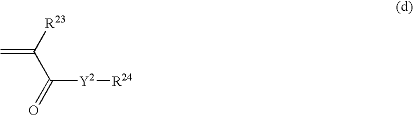

In formula (d), R²³ represents a hydrogen atom, a halogen atom or a methyl group, preferably a hydrogen atom or a methyl group. Y² represents an oxygen atom, a sulfur atom or —N(R²⁵)—, preferably an oxygen atom or —N(R²⁵)—, more preferably an oxygen atom. R²⁵ represents a hydrogen atom or an alkyl group having from 1 to 8 carbon atoms, preferably a hydrogen atom or an alkyl group having from 1 to 4 carbon atoms, more preferably a hydrogen atom or a methyl group.

R²⁴ represents an optionally-substituted, linear, branched or cyclic alkyl group having from 1 to 20 carbon atoms, a poly(alkyleneoxy) group-containing alkyl group, or an optionally-substituted aromatic group (e.g., phenyl, naphthyl). Preferably, it is a linear, branched or cyclic alkyl group having from 1 to 12 carbon atoms, or an aromatic group having from 6 to 18 carbon atoms in total, more preferably a linear, branched or cyclic alkyl group having from 1 to 8 carbon atoms.

Examples of specific structures of the fluorine-containing polymer that comprises repetitive units corresponding to the fluoroaliphatic group-containing monomer of formula (c) are shown below, to which, however, the invention should not be limited. In the formulae, the numeral indicates the molar fraction of each monomer component. Mw indicates the mass-average molecular weight of the polymer.

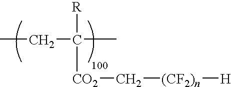

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

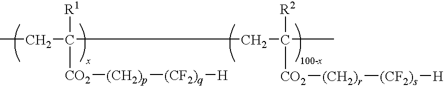

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

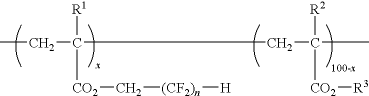

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉(n) | 7000 |
| FP-150 | 95 | H | 4 | H | C₆H₁₃(n) | 5000 |
| FP-151 | 90 | CH₃ | 4 | H | CH₂CH(C₂H₅)C₄H₉(n) | 15000 |
| FP-152 | 70 | H | 6 | CH₃ | C₂H₅ | 18000 |
| FP-153 | 90 | H | 6 | CH₃ | 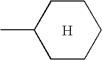 | 12000 |
| FP-154 | 80 | H | 6 | H | C₄H₉(sec) | 9000 |
| FP-155 | 90 | H | 6 | H | C₁₂H₂₅(n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉(n) | 5000 |
| FP-160 | 50 | H | 8 | H | C₄H₉(n) | 16000 |
| FP-161 | 80 | H | 8 | CH₃ | C₄H₉(iso) | 13000 |
| FP-162 | 80 | H | 8 | CH₃ | C₄H₉(t) | 9000 |
| FP-163 | 60 | H | 8 | H | 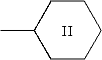 | 7000 |
| FP-164 | 80 | H | 8 | H | CH₂CH(C₂H₅)C₄H₉(n) | 8000 |
| FP-165 | 90 | H | 8 | H | C₁₂H₂₅(n) | 6000 |
| FP-166 | 80 | CH₃ | 8 | CH₃ | C₄H₉(sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₃H₆O)₇—H | 24000 |
| FP-173 | 70 | CH₃ | 4 | H | —(C₃H₆O)₁₃—H | 18000 |
| FP-174 | 90 | H | 6 | H | —(CH₂CH₂O)₂—H | 21000 |
| FP-175 | 90 | H | 6 | CH₃ | —(CH₂CH₂O)₈—H | 9000 |
| FP-176 | 80 | H | 6 | H | —(CH₂CH₂O)₂—C₄H₉(n) | 12000 |
| FP-177 | 80 | H | 6 | H | —(C₃H₆O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 80 | H | 8 | CH₃ | —(CH₂CH₂O)₈—H | 12000 |
| FP-182 | 95 | H | 8 | H | —(CH₂CH₂O)₉—CH₃ | 20000 |
| FP-183 | 90 | H | 8 | H | —(C₃H₆O)₇—H | 8000 |
| FP-184 | 95 | H | 8 | H | —(C₃H₆O)₂₀—H | 15000 |
| FP-185 | 90 | F | 8 | H | —(C₃H₆O)₁₂—H | 12000 |
| FP-186 | 80 | H | 8 | CH₃ | —(CH₂CH₂O)₂—H | 20000 |
| FP-187 | 95 | CH₃ | 8 | H | —(CH₂CH₂O)₉—CH₃ | 17000 |
| FP-188 | 90 | CH₃ | 8 | H | —(C₃H₆O)₇—H | 34000 |
| FP-189 | 80 | H | 10 | H | —(CH₂CH₂O)₃—H | 19000 |
| FP-190 | 90 | H | 10 | H | —(C₃H₆O)₇—H | 8000 |
| FP-191 | 80 | H | 12 | H | —(CH₂CH₂O)₇—CH₃ | 7000 |
| FP-192 | 95 | CH₃ | 12 | H | —(C₃H₆O)₇—H | 10000 |

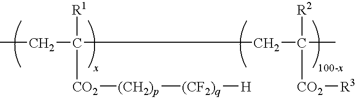

| | x | R¹ | p | q | R² | R³ | Mw |
|---|---|---|---|---|---|---|---|
| FP- | 80 | H | 2 | 4 | H | C₄H₉(n) | 18000 |
| 193 | | | | | | | |
| FP- | 90 | H | 2 | 4 | H | —(CH₂CH₂O)₉—CH₃ | 16000 |
| 194 | | | | | | | |
| FP- | 90 | CH₃ | 2 | 4 | F | C₆H₁₃(n) | 24000 |
| 195 | | | | | | | |
| FP- | 80 | CH₃ | 1 | 6 | F | C₄H₉(n) | 18000 |
| 196 | | | | | | | |
| FP- | 95 | H | 2 | 6 | H | —(C₃H₆O)₇—H | 21000 |
| 197 | | | | | | | |
| FP- | 90 | CH₃ | 3 | 6 | H | —CH₂CH₂OH | 9000 |
| 198 | | | | | | | |
| FP- | 75 | H | 1 | 8 | F | CH₃ | 12000 |
| 199 | | | | | | | |
| FP- | 80 | H | 2 | 8 | H | CH₂CH(C₂H₅)C₄H₉(n) | 34000 |
| 200 | | | | | | | |
| FP- | 90 | CH₃ | 2 | 8 | H | —(C₃H₆O)₇—H | 11000 |
| 201 | | | | | | | |
| FP- | 80 | H | 3 | 8 | CH₃ | CH₃ | 18000 |
| 202 | | | | | | | |
| FP- | 90 | H | 1 | 10 | F | C₄H₉(n) | 27000 |
| 203 | | | | | | | |
| FP- | 95 | H | 2 | 10 | H | —(CH₂CH₂O)₉—CH₃ | 12000 |
| 204 | | | | | | | |
| FP- | 85 | CH₃ | 2 | 10 | CH₃ | C₄H₉(n) | 20000 |
| 205 | | | | | | | |
| FP- | 80 | H | 1 | 12 | H | C₆H₁₃(n) | 8000 |
| 206 | | | | | | | |
| FP- | 90 | H | 1 | 12 | H | —(C₃H₆O)₁₃—H | 15000 |
| 207 | | | | | | | |
| FP- | 60 | CH₃ | 3 | 12 | CH₃ | C₂H₅ | 12000 |
| 208 | | | | | | | |
| FP- | 60 | H | 1 | 16 | H | CH₂CH(C₂H₅)C₄H₉(n) | 20000 |
| 209 | | | | | | | |
| FP- | 80 | CH₃ | 1 | 16 | H | —(CH₂CH₂O)₂—C₄H₉(n) | 17000 |
| 210 | | | | | | | |
| FP- | 90 | H | 1 | 18 | H | —CH₂CH₂OH | 34000 |
| 211 | | | | | | | |
| FP- | 60 | H | 3 | 18 | CH₃ | CH₃ | 19000 |
| 212 | | | | | | | |

When a low-refractivity layer is overcoated on the antiglare hard coat layer and when the reduction in the surface energy is prevented at that time, then the antireflection capability of the film may be prevented from worsening. When the antiglare hard coat layer is formed, it is desirable that a fluoropolymer is used so as to lower the surface tension of the coating liquid and to increase the surface uniformity of the layer formed, and it is also desirable that the producibility is kept high by employing a rapid coating method. After the formation of the antiglare hard coat layer, the layer is then subjected to surface treatment such as corona treatment, UV treatment, thermal treatment, saponification treatment or solvent treatment, preferably to corona treatment whereby the surface free energy is prevented from lowering. Accordingly, the surface energy of the antiglare hard coat layer before the formation of the low-refractivity layer thereon is controlled to fall within the above-mentioned range, and the intended object can be thereby attained.

A thixotropic agent may be added to the coating compositions for forming the constitutive layers in the invention. The thixotropic agent includes silica and mica having a size of at most 0.1 μm. In general, the amount of the agent to be added is preferably from 1 to 10 parts by mass or so relative to 100 parts by mass of the total amount of the other constitutive substances.

### <Transparent Support>

For the transparent support of the antireflection film of the invention, preferred is a plastic film. The polymer to form the plastic film includes cellulose acylates (e.g., triacetyl cellulose, diacetyl cellulose, cellulose acetate propionate, cellulose acetate butyrate, typically Fiji Photo Film's TAC-TD80U, TD80UL), polyamides, polycarbonates, polyesters (e.g., polyethylene terephthalate, polyethylene naphthalate), polystyrenes, polyolefins, norbornene resins (Arton: trade name by JSR), amorphous polyolefins (Zeonex: trade name by Nippon Zeon). Of those, preferred are triacetyl cellulose, polyethylene terephthalate, norbornene resins, amorphous polyolefins; and more preferred is triacetyl cellulose.

Single-layered or multi-layered cellulose acylate films may be used herein. The single-layered cellulose acylate film may be produced according to a drum-casting or band-casting process as in JP-A 7-11055. The latter multi-layered cellulose acylate film may be produced according to a co-casting process as in JP-A 61-94725 and JP-B 62-43846. Briefly, starting flakes are dissolved in a solvent of halogenohydrocarbons (e.g., dichloromethane), alcohols (e.g., methanol, ethanol, butanol), esters (e.g., methyl formate, methyl acetate), ethers (e.g., dioxane, dioxolane, diethyl ether), and various additives of plasticizer, UV absorbent, antioxidant, lubricant and peeling promoter are optionally added thereto to prepare a solution (dope). The dope is cast onto a support of a horizontal endless metal belt or a rotary drum, through a dope supply unit (die). In this stage, a single dope is cast onto it to form a single-layered film; and a high-concentration cellulose ester dope is co-cast along with low-concentration dopes on both sides thereof, onto the support to form a multi-layered film thereon. Then, after the film has been dried in some degree on the support and has become tough, it is peeled away from the support, and then led through a drying zone by the use of a conveyor system so that the solvent is evaporated away from it.

Dichloromethane is one typical example of the solvent to dissolve cellulose acylate in the manner as above. However, from the viewpoint of the global environment protection and the working environment safety, it is desirable that the solvent does not substantially contain a halogenohydrocarbon such as dichloromethane. The wording “does not substantially contain” means that the proportion of the halogenohydrocarbon in the organic solvent is less than 5% by mass (preferably less than 2% by mass).

Various types of cellulose acylate films (e.g., triacetylcellulose film) mentioned above and methods for producing them are described in Hatsumei Kyokai's Disclosure Bulletin No. 2001-1745 (issued Mar. 15, 2001).

Preferably, the thickness of the cellulose acylate film for use herein is from 40 μm to 120 μm. In view of the handling aptitude and the coating aptitude thereof, the thickness of the film is more preferably around 80 μm. However, the recent tendency towards thinner display devices requires thinner polarizing plates, and from the viewpoint of the need for such thinner polarizing plates, it is desirable that the thickness of the cellulose acylate film is from 40 μm to 60 μm or so. When such a thin cellulose acylate film is used as the transparent support of the antireflection film of the invention, it is desirable that the solvent for the layer that is to be formed directly on the cellulose acylate film, as well as the thickness of the layer and the crosslinking shrinkage thereof is optimized to thereby evade the problem that may detract from the above-mentioned handling aptitude and the coating aptitude of the film support.

The antireflection film of the invention may be formed according to the method mentioned below, to which, however, the invention should not be limited.

### [Preparation of Coating Liquids]

Coating liquids that contain the components of forming the constitutive layers are first prepared. In this stage, the increase in the water content of the coating liquids may be prevented by minimizing the vaporization of the solvent from the liquids. Preferably, the water content of the coating liquids is at most 5% by mass, more preferably at most 2% by mass. The solvent evaporation may be inhibited by improving the airtight sealability of the tank into which the materials for a coating liquid are put and by minimizing the air contact area of the coating liquid during the transference of the liquid. If desired, a method of reducing the water content of a coating liquid may be employed during or before or after the coating operation with the liquid.

It is desirable that the coating liquid for an antiglare hard coat layer or the like on which a low-refractivity layer is directly formed is filtered so as to almost completely (at least 90%) remove the impurities corresponding to the dry film thickness (50 nm to 120 nm or so) of the low-refractivity layer directly formed thereon. When an antiglare hard coat layer is formed below a low-refractivity layer, then the mat agent to be added to the layer may be equivalent to or larger than the film thickness of the low-refractivity layer, and therefore it is desirable that the filtration is effected for the intermediate liquid comprising all the constitutive materials except the mat agent to be therein. In case where a filter capable of removing the impurities having such a small size is unavailable, then it is desirable that almost all the impurities corresponding to at least the wet film thickness (1 to 10 μm or so) of the directly overlying layer are removed through filtration. According to the method, the spot defects of the directly overlying layer may be reduced.

### [Coating]

Next, the coating liquid for forming each layer is applied onto a transparent support according to various coating methods of an extrusion method (die-coating method) or a microgravure coating method, and then heated and dried. Next, this is exposed to light and/or heat, whereby the monomer and the curable resin to form the layer are cured. Accordingly, the constitutive layers are thus formed on the transparent support.

For producing the antireflection film of the invention at high producibility, preferably employed is an extrusion method (die-coating method). A die coater is described below, which is favorably used for forming a layer having a small wet coating amount (at most 20 ml/m²) such as a low-refractivity layer.

### <Constitution of Die Coater>

FIG. 2 is a schematic cross-sectional view of a die coater (coating device) with a slot die, which is favorably used in the invention.

The coater 10 jets out a coating liquid 14 as a bead 14a, through the slot die 13 onto the web W continuously running as supported by a backup roll 11, whereby a coating film 14b is formed on the web W.

A pocket 15 and a slot 16 are formed inside the slot die 13. The cross section of the pocket 15 is formed of a curve and a line. For example, as in FIG. 2, it may be nearly circular or semicircular. The pocket 15 is a space for holding a coating liquid therein, and is so designed that its cross section is expanded in the cross direction of the slot die 13, and, in general, its effective extension length is equal to or somewhat larger than the coating width. The supply of the coating liquid 14 to the pocket 15 is effected from the side face of the slot die 13 or from the face center on the side opposite to the side of the slot opening 16a. A stopper is provided to the pocket 15 so as to prevent the coating liquid 14 from leaking out.

The slot 16 is a passage for the coating liquid 14 from the pocket 15 to the web W, and like the pocket 15, it has a cross-section profile in the cross direction of the slot die 13. The opening 16a positioned on the web side is generally so controlled that its width may be nearly the same as the coating width, by the use of a width control plate (not shown). At the slot tip, the angle between the slot 16 and the tangential line in the web-running direction of the backup roll 11 is preferably from 30° to 90°.

The tip lip 17 of the slot die 13 at which the opening 16a of the slot 16 is positioned is tapered, and the tapered tip is leveled to be a land 18. Of the land 18, the upstream in the running direction of the web W relative to the slot 16 is referred to as an upstream lip land 18a, and the downstream is as a downstream lip land 18b.

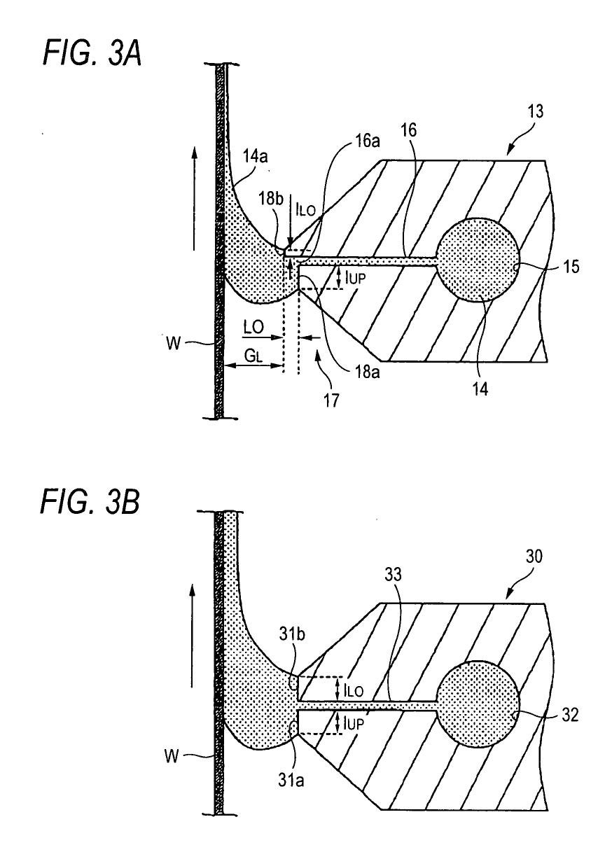

With reference to FIGS. 3A and 3B, a coating device favorably used in producing the antireflection film of the invention is described, as compared with an ordinary coating device.

FIGS. 3A and 3B shows the cross-sectional profile of the slit die 13, as compared with that of an ordinary one. (A) shows the slit die 13 for use in the invention (enlarged view of FIG. 2); and (B) shows an ordinary slot die 30. In the ordinary slot die 30, the distance between the web and the upstream lip land 31a is the same as that between the web and the downstream lip land 31b. In (B), the reference numeral 32 indicates a pocket and 33 indicates a slot. As opposed to this, in the slot die 13 for use in the invention, the downstream lip land length I_{LO} is short, and accordingly, it enables accurate coating to form a wet film thickness of 20 μm or less.

Though not specifically defined, the land length I_{UP} of the upstream lip land 18a is preferably from 500 μm to 1 mm. The land length I_{LO} of the downstream lip land 18b may be from 30 μm to 100 μm, preferably from 30 μm to 80 μm, more preferably from 30 μm to 60 μm. In case where the downstream lip land length I_{LO} is shorter than 30 μm, then the edge or the land of the tip lip may be readily chipped and the coating film may have streaks, and at last the coating may be impossible. If so, in addition, there may occur other problems in that the wet line position on the downstream side may be difficult to set and the coating liquid may often spread broadly on the downstream side. The wetting expansion of the coating liquid on the downstream side means unevenness of the wetting line, and it has heretofore been known that this may cause a problem of defect formation such as formation of streaks on the coated surface. On the other hand, if the downstream lip land length I_{LO} is longer than 100 μm, then it is impossible to form beads themselves and, as a result, it is impossible to form a thin layer.

The downstream lip land 18b has an overbite shape that is nearer to the web W than the upstream lip land 18a, and therefore the degree of reduced pressure around the lip may be further reduced and it is possible to form beads suitable for thin-film formation. The difference between the distance from the downstream lip land 18b to the web W and the distance from the upstream lip land 18a to the web W (this is hereinafter referred to as “overbite length LO”) is preferably from 30 μm to 120 μm, more preferably from 30 μm to 100 μm, even more preferably from 30 μm to 80 μm. When the slot die 13 has such an overbite shape, then the gap G_{L} between the tip lip 17 and the web W is the gap between the downstream lip land 18b and the web W.

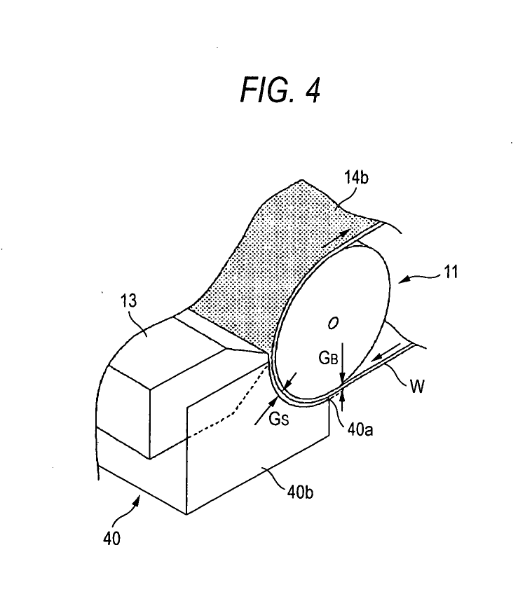

With reference to FIG. 4, the coating process is generally described below.

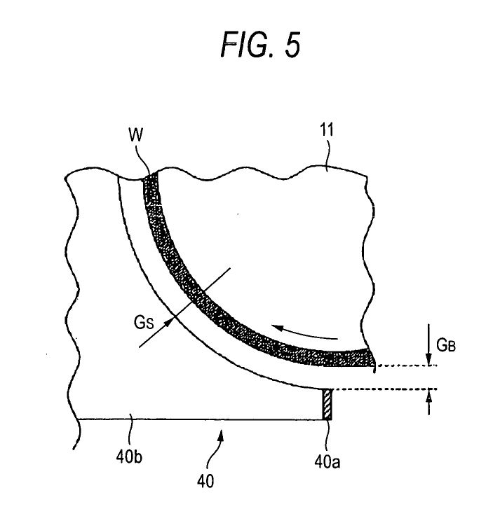

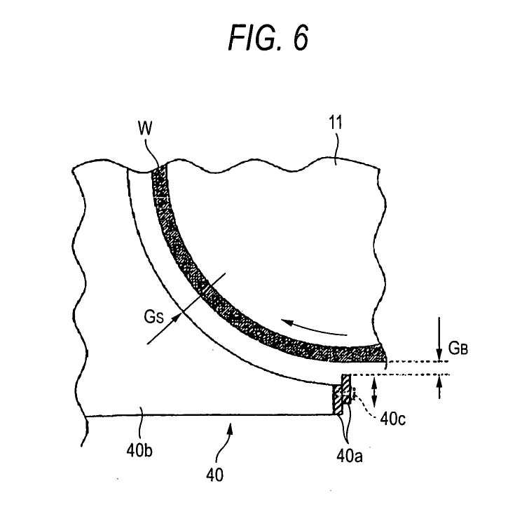

FIG. 4 is a perspective view showing the slot die and around it, used in the coating process in the invention. On the side opposite to the running direction side of the web W, disposed is a vacuum chamber 40 at the non-contact position in order that sufficient pressure reduction control may be attained for the bead 14a. The vacuum chamber 40 comprises a back plate 40a and a side plate 40b for keeping its operation efficiency, and there exist gaps G_{B} and G_{S} between the back plate 40a and the web W and between the side plate 40b and the web W, respectively. FIG. 5 and FIG. 6 each show a cross section of the vacuum chamber 40 and the web W that are in adjacent to each other. The side plate and the back plate may be integrated with the chamber body, as in FIG. 5; or they may be so designed that they are fitted to each other via a screw 40c or the like in order that the gap could be varied as in FIG. 6. In any structure, the distance between the back plate 40a and the web W, and the gap actually formed between the side plate 40b and the web W are defined as gaps G_{B} and G_{S}, respectively. The gap G_{B} between the back plate 40a of the vacuum chamber 40 and the web W is the distance between the uppermost edge of the back plate 40a and the web W, when the vacuum chamber 40 is positioned below the web W and the slot die 13 as in FIG. 4.

Preferably, the vacuum chamber is so positioned that the gap G_{B} between the back plate 40a and the web W could be larger than the gap G_{L} between the tip lip 17 of the slot die 13 and the web W. In that condition, the change in the pressure reduction around the beads owing to the eccentricity of the backup roll 11 can be prevented. For example, when the gap G_{L} between the tip lip 17 of the slot die 13 and the web W is from 30 μm to 100 μm, then the gap G_{B} between the back plate 40a and the web W is preferably from 100 μm to 500 μm.

### <Materials, Accuracy>

When the length of the tip lip in the web-running direction on the web-running side is larger, then it is more unfavorable to bead formation; and when the length varies at any sites in the cross direction of the slot die, then the beads may be unstable owing to some external disturbance. Accordingly, it is desirable that the length fluctuation range in the cross direction of the slot die is controlled to fall within at most 20 μm.

Regarding the material of the tip lip of the slot die, if the tip lip is formed of a material like stainless steel, then it may be deformed during the stage of die working, and, in that condition, even though the length in the web-running direction of the slot die tip lip is controlled to be from 30 to 100 μm as so mentioned hereinabove, the tip lip accuracy could not be satisfactory. Accordingly, for ensuring high working accuracy, it is important that an ultra-hard material such as that described in Japanese Patent No. 2817053 is used for it. Concretely, it is desirable that at least the tip lip of the slot die is formed of an ultra-hard alloy with carbide crystals bonding to each other and having a mean particle size of at most 5 μm. The ultra-hard alloy comprises, for example, carbide crystal grains such as tungsten carbide (WC) bonding to each other with a bonding metal of cobalt, in which the bonding metal may be titanium, tantalum, niobium or their mixture. Preferably, the mean particle size of the WC crystals is at most 3 μm.

For realizing high-accuracy coating in forming the layer, the fluctuation of the gap between the length of the tip lip land on the web-running direction side and the web, in the cross direction of the slot die is also an important factor. It is desirable that a good combination of the two factors, or that is, a straightness within a range capable of suppressing the gap fluctuation in some degree is attained. Preferably, the straightness of the tip lip and the backup roll may be such that the fluctuation range of the gap in the cross direction of the slot die could be at most 5 μm.

### <Coating Speed>

When the accuracy of the backup roll and the tip lip as above is attained, then the coating system preferably employed in the invention enables a stable film thickness in a high-speed coating mode. In addition, since the coating system in the invention is a pre-metering system, it readily ensures a stable film thickness even in a high-speed coating mode. For the coating liquid that is used in a small amount to form the antireflection film as in the invention, the coating system employed in the invention is good since it enables high-speed coating to give a stable film thickness. Any other coating system may also be employed herein, but in a dip coating process, vibration of the coating liquid in a liquid tank is inevitable, and it may cause stepwise coating unevenness. In a reverse roll-coating process, the coating rolls used may be decentered or deflected thereby also causing stepwise coating unevenness. In addition, since these coating methods are post-metering methods, they could hardly ensure a stable film thickness. It is desirable that the coating liquid is applied at a speed of 25 m/min or more according to the above-mentioned coating method with a die coater, from the viewpoint of the producibility.

### <Wet Coating Amount>

In forming a low-refractivity layer, it is desirable that the coating liquid for it is applied onto a transparent support directly or via any other layer to give a wet coating film thickness of from 1 to 10 μm, more preferably from 2 to 5 μm.

### [Drying]

The web with the low-refractivity layer thus formed on a transparent support (hereinafter referred to as “substrate film”) directly or via any other layer is then transferred into a heating zone in which the solvent is evaporated away. Preferably, the temperature in the drying zone is from 25° C. to 140° C. Also preferably, the former half of the drying zone is at a relatively low temperature and the latter half thereof is at a relatively high temperature. However, it is desirable that the drying temperature is not higher than a temperature at which the other components than the solvent in the coating composition of each layer may begin to evaporate away. For example, some commercially-available optical radical generators that may be combined with a UV-curable resin may evaporate away to a degree of tens % or so thereof, within a few minutes in hot air at 120° C.; and some monofunctional or difunctional acrylate monomers may begin to evaporate away in hot air at 100° C. In such a case, it is desirable that the drying temperature is not higher than a temperature at which the other components than the solvent in the coating composition of each layer may begin to evaporate away, as so mentioned hereinabove.

Preferably, the dry air speed for drying the substrate film coated with the coating composition for each layer is from 0.1 to 2 m/sec when the solid concentration in the coating composition is from 1 to 50%, for preventing the drying unevenness.

Also preferably, the temperature difference between the substrate film coated with the coating composition for each layer and the conveyor roll that is in contact with the film on the side opposite to the coated side thereof, in the drying zone where the coating layer is dried, is from 0° C. to 20° C., for preventing the drying unevenness owing to the thermal conduction unevenness on the transfer roll.

### [Curing]

After the drying zone for solvent evaporation, the web is led through a curing zone where the coating layer is cured through exposure to at least any of ionizing radiation or heat. For example, when the coating layer is a UV-curable one, then it is preferably cured through exposure to UV rays from a UV lamp at from 10 mJ/cm² to 1000 mJ/cm². In this step, the exposure distribution in the cross direction of the web is preferably from 50 to 100% of the maximum exposure at the center of the web, including both edges of the web, more preferably from 80 to 100%. Further, when the curing zone must be purged with nitrogen gas or the like so as to lower the oxygen concentration therein for promoting the surface curing of the web, then the oxygen concentration in the zone is preferably from 0.01% to 5% and the oxygen concentration distribution in the cross direction of the web is preferably at most 2%.

For the antireflection film having an antiglare such as an antiglare hard coat layer and a low-refractivity layer, it is desirable that, when the curing degree (100—residual functional group content) of the antiglare layer has reached a certain value less than 100%, then a low-refractivity layer of the invention is formed on the antiglare layer and the low-refractivity layer is cured through exposure to any of ionizing radiation or heat in such a manner that the curing degree of the underlying antiglare layer could be higher than that before the formation of the low-refractivity layer thereon. In that condition, the adhesiveness between the antiglare layer and the low-refractivity layer is increased.

The antireflection film of the invention produced in the manner as above may be used in fabricating a polarizing plate, and the polarizing plate may be used in image display devices such as liquid-crystal display devices. In this case, the polarizing plate is disposed on the outermost surface of the display panel, by providing an adhesive layer on one side thereof. Preferably, the antireflection film of the invention is used as at least one of the two protective films between which a polarizer is sandwiched in a polarizing plate.

Since the antireflection film of the invention serves also as a protective film, the production cost of the polarizing plate may be reduced. In addition, since the antireflection film of the invention is positioned as the outermost layer of the display panel, external light reflection on the panel may be prevented and the polarizing plate may have good scratch resistance and good stain resistance.

When the antireflection film of the invention is used as one of two surface-protective films for a polarizer to construct a polarizing plate, then the antireflection film is preferably so modified that the surface of the transparent support thereof on the side opposite to the side having the low-refractivity layer, or that is, the surface of the transparent support that is to be stuck to a polarizer is hydrophilicated, whereby the adhesiveness of the adhering surface of the film may be improved.

### [Saponification]

### (1) Method of Dipping in Alkali Solution:

An antireflection film is dipped in an alkali solution under a suitable condition, whereby the entire surface of the film reactive with alkali is saponified. Not requiring any specific equipment, this method is favorable in view of its cost. The alkali solution is preferably an aqueous sodium hydroxide solution. Preferably, its concentration is from 0.5 to 3 mol/liter, more preferably from 1 to 2 mol/liter. Also preferably, the temperature of the alkali solution is from 30 to 75° C., more preferably from 40 to 60° C.

The combination of the saponification conditions is preferably a combination of relatively mild conditions, and it may be suitably defined depending on the material and the constitution of the antireflection film to be processed and on the intended contact angle of the treated surface.

After dipped in such an alkali solution, it is desirable that the film is well rinsed with water or dipped in a dilute acid to neutralize the alkali component so that no alkali component may remain in the film.

Through the saponification treatment, the surface of the transparent support on the side not having an antireflection layer thereon is thereby hydrophilicated. The hydrophilicated surface of the transparent support of the antireflection film is stuck to a polarizer.

The hydrophilicated surface is effective for improving the adhesiveness of the film to an adhesive layer comprising polyvinyl alcohol as the principal ingredient thereof.

The saponification treatment is more desirable when the contact angle to water of the surface of the transparent support on the side opposite to the side thereof to be coated with a low-refractivity layer is smaller, from the viewpoint of the adhesiveness of the support surface to a polarizer. On the other hand, however, the surface and even the inside of the low-refractivity layer-coated support are damaged by alkali in the dipping method, and therefore it is important that the reaction is limited to the necessary minimum condition. For the index of the damage to the constitutive layer to be caused by alkali, the contact angle to water of the transparent support on the side opposite to the layer-coated side thereof may be employed. When the transparent support is formed of a triacetyl cellulose film, then the contact angle is preferably from 10 degrees to 50 degrees, more preferably from 30 degrees to 50 degrees, even more preferably from 40 degrees to 50 degrees. If the angle is larger than 50 degrees, then it is unfavorable since there may occur a problem in the adhesiveness of the support to a polarizer; but if smaller than 10 degrees, then it is also unfavorable since the damage to the antireflection film may be too large and the physical strength of the film may be lowered.

### (2) Method of Applying Alkali Solution to Film:

For evading the damages to the films in the above-mentioned dipping method, preferably employed is a method of applying an alkali solution to the support only on the surface thereof not coated with an antireflection layer, under a suitable condition, then heating it, rinsing it with water and drying it. The application as referred to herein means that the alkali solution or the like processing solution is applied to only the surface to be saponified with it, therefore including not only coating operation but also spraying or contacting with a belt that contains the processing solution. Since this method additionally requires an apparatus and a step of applying an alkali solution to the film, it is inferior to the dipping method (1) in point of its process cost. On the other hand, in this method, since the alkali solution is contacted with only the surface of the film to be saponified with it, the method may be applicable even to a film having, on the opposite side thereof, a layer of a material poorly resistant to alkali. For example, a layer formed through vapor deposition or a layer formed through sol-gel reaction may be damaged by an alkali solution, as corroded, dissolved or stripped, and therefore the layer of the type is undesirable for the dipping method. However, since the layer is not brought into contact with an alkali solution in the coating method, there occurs no problem in employing the method for the film coated with the layer of the type.

In any saponification method of above (1) or (2), the rolled support may be unrolled and processed for saponification after the formation of the coating layer thereon, and therefore, the saponification treatment may be carried out as a step of the series of the process of producing the antireflection film mentioned above. In addition, the thus-processed film may be laminated with a support of a polarizing plate that has been unrolled also in one series of the production method. Accordingly, the production method is more efficient in producing polarizing plates than a method where sheets are processed to fabricate polarizing plates.

(3) Method of Saponification by Protecting Antireflection Layer with Laminate Film:

Like in the above (2), when the low-refractivity layer is poorly resistant to alkali, then another method may be employed which is as follows: After the final layer has been formed, a laminate film is stuck to the surface of the film coated with the final layer, and then this is dipped in an alkali solution whereby only the triacetylcellulose surface on the side opposite to the side coated with the final layer could be hydrophilicated, and then the laminate film is peeled away. Also in this method, the necessary hydrophilication for the polarizing plate-protective film may be attained with no damage to the low-refractivity layer of the film, only on the side of the triacetylcellulose film opposite to the side thereof coated with the final layer. As compared with the method (2), the method (3) gives a waste of the laminate film used therein, but its advantage is that it does not require any specific device for applying an alkali solution to the film to be processed therein.

(4) Method of Dipping in Alkali Solution after Formation of Low-Refractivity Layer:

When the antireflection film has two or more layers including the low-refractivity layer on a transparent support and when the layers underlying the low-refractivity layer are resistant to alkali but the low-refractivity layer is not resistant to it, then another method may be employable which is as follows: After the layers to be below the low-refractivity layer have been formed, the film is dipped in an alkali solution so that both its surfaces are hydrophilicated, and then a low-refractivity layer is formed on the underlying layer. Though complicated in some degree, the method is especially favorable when the low-refractivity layer to be formed has a hydrophilic layer, for example, when the layer is a fluorine-containing film layer formed through sol-gel reaction, since the interlayer adhesiveness between the underlying layer and the low-refractivity layer of the type is improved by the method.

### (5) Method of Forming Antireflection Layer on Previously-Saponified Triacetylcellulose Film:

A triacetylcellulose film is previously saponified by dipping in an alkali solution, and then and a low-refractivity layer may be formed on any one surface thereof directly or via any other layer. In case where the film is saponified by dipping in an alkali solution, the interlayer adhesiveness between the constitutive layer on the transparent support and the surface of the triacetyl cellulose film hydrophilicated through the saponification may be worsened. In such a case, only the surface of the film to be coated with the constitutive layer may be subjected to corona discharge treatment or glow discharge treatment after the saponification to thereby remove the hydrophilicated surface from it, and then the necessary constitutive layer may be formed on the thus-treated surface of the film. On the other hand, when the constitutive layer has a hydrophilic group, then its interlayer adhesiveness to the film may be good.

A polarizing plate that comprises the antireflection film of the invention, and a liquid-crystal display device comprising the polarizing plate are described below.

### [Polarizing Plate]

Generally. A polarizing plate comprises a polarizer and two protective films for protecting both sides of the polarizer. A preferred polarizing plate of the invention has the antireflection film of the invention as at least one of the protective films for the polarizer (polarizing plate-protective films) therein. Preferably, the polarizing plate-protective film is so designed that the contact angle to water on the surface the transparent support thereof opposite to the surface coated with the antireflection layer formed thereon, or that is, on the surface of the support that is to be stuck to a polarizer, is from 10 degrees to 50 degrees, as so mentioned hereinabove.

Using the antireflection film of the invention as a polarizing plate-protective film gives a polarizing plate having good antireflection function, good scratch resistance and good stain resistance, and it greatly reduces the production cost and makes it possible to produce thin display devices.

When a polarizing plate is fabricated, using the antireflection film of the invention as one of the polarizing plate-protective films therein and using an optically-compensatory film having an optically-anisotropic layer-containing optically-compensatory layer, which will be mentioned hereinunder, as the other of the protective films, and when the thus-fabricated polarizing plate is used in constructing a liquid-crystal display device, then the image visibility and the contrast of the device in a light room may be improved, and the viewing angle in every direction thereof may be greatly broadened.

### [Optically-Compensatory Layer]

The optically-compensatory film has an optically-anisotropic layer-containing optically-compensatory layer on a transparent support. For the transparent support of the optically-compensatory film, usable is the same transparent support as that mentioned hereinabove for the antireflection film of the invention. Providing an optically-compensatory layer (retardation layer) in a polarizing plate may improve the viewing angle characteristic of the liquid-crystal display panel having the polarizing plate therein.

The optically-compensatory layer may be any known one, but for broadening the viewing angle of the display panel comprising the layer, it preferably has a layer with optical anisotropy (optically-anisotropic layer) of a compound having a structural unit of a discotic compound, in which the angle between the discotic compound and the transparent support varies relative to the distance (in the depth direction) from the transparent support.

Preferably, the angle increases with the increase in the distance between the optically-anisotropic layer of the discotic compound and the transparent support.

When the optically-compensatory layer-having optically-compensatory film serves as the protective layer for a polarizer, then it is desirable that the surface of the layer on which it is to be stuck to a polarizer (the surface thereof on the side of the transparent support) is saponified, and the saponification for it may be carried out preferably in the same manner as above.

### [Polarizer]

The polarizer for use herein may be any known one, or may be cut out from a long polarizer of which the absorption axis is neither parallel nor vertical to the machine direction of the film. A long polarizer of which the absorption axis is neither parallel nor vertical to the machine direction thereof may be fabricated according to the method mentioned below.

Briefly, a long polymer film continuously fed out from a production line is, while held at its both edges by holding units, stretched under tension to be a polarizer. Concretely, the film is stretched at least by 1.1 to 20.0 times in the cross direction of the film in the manner as follows: The running speed difference in the machine direction between the holding units at the edges of the film being stretched is within 3%; and the film-running direction is so curved, with the edges of the film being kept held, that the angle between the film-running direction at the outlet in the step of holding the edges of the film, and the substantially-stretching direction of the film could be from 20 to 70°. In particular, the angle is preferably 45° from the viewpoint of the producibility of the stretched film.

The stretching method for polymer films is described in detail in JP-A 2002-86554, paragraphs [0020] to [0030].

### [Image Display Device]

The antireflection film of the invention may be used in image display devices such as liquid-crystal displays (LCD), plasma display panels (PDP), electroluminescent displays (ELD) and cathode-ray tube displays (CRT). Since the antireflection film of the invention has a transparent support, the side of the transparent support of the film may be fitted to the image display panel of an image-display device comprising it.

In case where the antireflection film of the invention is used as a surface-protective film on one side of a polarizer, then it is favorable for transmission-mode, reflection-mode or semitransmission-mode liquid-crystal display devices such as twisted nematic (TN)-mode, super-twisted nematic (STN)-mode, vertical alignment (VA)-mode, in-plain switching (IPS)-mode, or optically-compensatory bent cell (OCB)-mode devices. In particular, the antireflection film is favorably used in VA, IPS and OCB for large-size liquid-crystal TVs. It is also favorable to TN and STN for middle and small-sized low-definition display devices. Regarding its use in large-size liquid-crystal TVs, the antireflection film is especially favorable for those having a width across corners of a display panel of at least 20 inches and having the definition level of at least XGA (at most 1024×768 in a display device having an aspect ratio of 3:4).

The antireflection film of the invention substantially has no internal haze, and therefore, it may be unfavorable to display devices that have a diagonal size of 20 inches and have a definition level of more than XGA (1024×768 in a display device having an aspect ratio of 3:4) and that are specifically desired to have a good antiglare property, since the glaring level of the film may be over an acceptable level. The glaring level depends on the pixel size and the surface roughness profile of the antiglare film on the surface of the panel. Accordingly, the antireflection film of the invention may be favorably used in display devices having a size of 30 inches and having a definition level of at most UXGA (1600×1200 in a display device having an aspect ratio of 3:4), or in display devices having a size of 40 inches and having a definition level of at most QXGA (2048×1536 in a display device having an aspect ratio of 3:4).

The VA-mode liquid-crystal cell includes, in addition to (1) a narrow-sense VA-mode liquid-crystal cell where rod-shaped liquid-crystalline molecules are aligned substantially vertically in the absence of voltage application thereto but are aligned substantially horizontally in the presence of voltage application thereto (as in JP-A 2-176625); (2) a multi-domain VA-mode (MVA-mode) liquid crystal cell for viewing angle enlargement (as in SID97, Digest of Tech. Papers (preprint) 28 (1997), 845), (3) an n-ASM-mode liquid-crystal cell where rod-shaped liquid-crystalline molecules are substantially vertically aligned in the absence of voltage application thereto but are aligned for twisted multi-domain alignment in the presence of voltage application thereto (as in a preprint in the Japan Liquid-Crystal Discussion Meeting, 58-59 (1998), and (4) a survival-mode liquid crystal cell (as announced in LCD International 98).

The OCB-mode liquid-crystal cell is for a liquid-crystal display device in which rod-shaped liquid-crystalline molecules are aligned substantially in the opposite direction (symmetrically) in the upper part and the lower part of the liquid-crystal cell, or that is, the liquid-crystal cell has a bent alignment mode. This is disclosed in U.S. Pat. Nos. 4,583,825 and 5,410,422. In this, the rod-shaped liquid-crystalline molecules are symmetrically aligned in the upper part and the lower part of the liquid-crystal cell, and the bent alignment-mode liquid-crystal cell of the type has a self-optically-compensatory function. Accordingly, the liquid-crystal mode is referred to as an OCB (optically-compensatory bent) liquid-crystal mode. The bent alignment-mode liquid-crystal display device has the advantage of rapid response speed.

In the ECB-mode liquid-crystal cell, rod-shaped liquid-crystalline molecules are substantially horizontally aligned in the absence of voltage application thereto, and the cell mode is most popularly used in color TFT liquid-crystal display devices. This is described in many references, for example, as in “EL, PDP, LCD Displays” issued by Toray Research Center (2001).

### EXAMPLES

The invention is described in more detail with reference to the following Examples, to which, however, the invention should not be limited. In the Examples, “part” and “%” are all by mass.

### Production Examples

### Production of Fluoropolymer (P-2)

40 g of ethyl acetate, 14.7 g of hydroxyethyl vinyl ether, 0.49 g of dilauryl peroxide and 0.97 g of Silaplane FM-0721 (by Chisso) were fed into a 100-ml stainless autoclave equipped with a stirrer, and the system was degassed and purged with nitrogen gas. 27.5 g of hexafluoropropylene (HFP) was introduced into the autoclave and heated up to 65° C. The pressure when the inner temperature of the autoclave reached 65° C. was 8.5 kg/cm². While the temperature was kept as such, the reaction was continued for 8 hours; and when the pressure reached 3.8 kg/cm², heating the system was stopped and this was left cooled. After the inner temperature lowered to room temperature, the unreacted monomer was expelled away, then the autoclave was opened, and the reaction liquid was taken out. Thus obtained, the reaction liquid was poured into a great excessive amount of hexane, the solvent was removed through decantation, and the precipitated polymer was taken out. The polymer was washed with a small amount of hexane to remove the remaining monomer. After dried, 21 g of the following copolymer (a-2) of hexafluoropropylene/hydroxyethylvinyl ether (1/1 (by mol) was obtained, containing 2.2% by mass of a polydimethylsiloxane structure introduced into the backbone chain thereof. Next, 20 g of the polymer was dissolved in 100 ml of N,N-dimethylacetamide, 11.4 g of acrylic acid chloride was dropwise added thereto with cooling with ice, and then this was stirred at room temperature for 10 hours. Ethyl acetate was added to the reaction liquid, washed with water, and the organic layer was extracted out and concentrated. The resulting polymer solution was reprecipitated from hexane to obtain 18 g of a perfluorocopolymer (P-2). The number-average molecular weight of the thus-obtained polymer was 31,000.

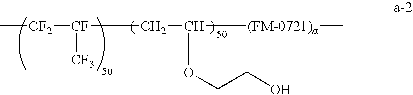

In this, the numeral indicates a molar ratio; FM-0721 represents a polymerization unit derived from Silaplane FM-0721; a=2.2% by mass. The other fluoropolymers for use in the invention may be produced in the same manner as above (a indicates the molar fraction (%) of the polymerization unit including polysiloxane to the mass of all the other components).

Production of Comparative Compound (a-3):

A comparative compound (a-3) mentioned below was produced in the same manner as that for (P-2), for which, however, Silaplane FM-0721 was not added but 0.55 g of dilauroyl peroxide was added. The polymer had a refractive index of 1.421.

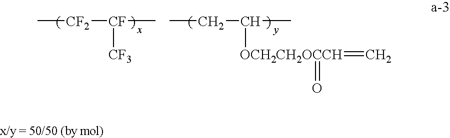

### [Preparation of Inorganic Particles (C-1)]

360 g of tetraethoxysilane (TEOS, having an SiO₂ concentration of 28% by mass) was mixed with 530 g of methanol, and 100 g of ion-exchanged water and aqueous ammonia (containing 28% of ammonia) were separately dropwise added to the mixture at 25° C., and stirred and ripened for 24 hours. This was heated in an autoclave at 180° C. for 4 hours, and using an ultrafilter, the solvent was substituted with methanol to prepare a dispersion of inorganic particles having a solid concentration of 20% by mass. By observation with a transmission electronic microscope, it was confirmed that the particles are porous particles.

900 g of ion-exchanged water and 800 g of ethanol were added to 100.0 g of the thus-obtained dispersion of porous particles, and the resulting mixture was heated at 30° C. Then, 360 g of tetraethoxysilane (having an SiO₂ concentration of 28% by mass) and 626 g of aqueous 28% ammonia were added thereto, whereby a silica outer sheath layer of a hydrolyzed polycondensate of tetraethoxysilane was formed on the surface of each particle. Next, this was concentrated up to a solid concentration of 5% by weight, using an evaporator, and then aqueous ammonia having a concentration of 15% by mass was added to it to thereby make it have a pH of 10. Then, this was heated in an autoclave at 180° C. for 4 hours, and using an ultrafilter, the solvent was substituted with ethanol to prepare a dispersion of inorganic particles (C-1) having a solid concentration of 20% by mass. The mean particle size was 40 nm and the refractive index was 1.30.

### [Preparation of Inorganic Particles (C-2)]

90 g of silica sol having a mean particle size of 5 nm and having an SiO₂ concentration of 20% by mass was mixed with 1710 g of ion-exchanged water to prepare a reaction mother liquid, and this was heated at 95° C. The reaction mother liquid has a pH of 10.5. 24,900 g of aqueous sodium silicate solution having an SiO₂ concentration of 1.5% by mass and 36,800 g of an aqueous sodium aluminate solution having an Al₂O₃ concentration of 0.5% by mass were simultaneously added to the mother liquid. During this, the reaction liquid was kept at 91° C. After the addition, the reaction liquid was cooled to room temperature, and washed through an ultrafilter to prepare a dispersion (A) of SiO₂/Al₂O₃ core particles having a solid concentration of 20% by mass (first preparation step).

Next, 500 g of the dispersion (A) of core particles was collected, 1,700 g of ion-exchanged water was added to it and heated at 98° C. Kept at the temperature, 2,100 g of a silicate solution (having an SiO₂ concentration of 3.5% by mass) that had been prepared by alkali removal from an aqueous sodium silicate solution with a cation-exchange resin was added to it, thereby forming a silica-protective film on the surface of the core particle. Thus obtained, the dispersion of the silica protective film-having core particles was washed through an ultrafilter, then this was controlled to have a solid concentration of 13% by mass, and 1,125 g ion-exchanged water was added to 500 g of the dispersion of core particles. Further, concentrated hydrochloric acid (35.5%) was dropwise added to it to thereby make it have a pH of 1.0, and then this was subjected to treatment for aluminium removal. Next, with adding 10 liters of aqueous hydrochloric acid solution having a pH of 3 and 5 liters of ion-exchanged water thereto, the aluminium salt having been dissolved through the ultrafilter was separated, and a particle precursor dispersion was thus prepared (second preparation step).

A mixture of 1500 g of the particle precursor dispersion, 500 g of ion-exchanged water and 1,750 g of ethanol was heated at 30° C., and then 70 g of tetraethoxysilane (having an SiO₂ concentration of 28% by mass) and 626 g of aqueous 28% ammonia were added thereto at a controlled speed, whereby a silica outer sheath layer of a hydrolyzed polycondensate of tetraethoxysilane was formed on the surface of the particle precursor. Thus were prepared particles having pores inside the outer sheath layer thereof. Next, using an evaporator, this was concentrated up to a solid concentration of 5% by mass, and aqueous ammonia having a concentration of 15% by mass was added thereto so as to make it have a pH of 10. This was heated in an autoclave at 180° C. for 4 hours, and using an ultrafilter, the solvent was substituted with ethanol to prepare a dispersion of hollow silica particle sol (porous inorganic particles) having a solid concentration of 20% by mass (C-2) (third preparation step). The mean particle size was 40 nm and the refractive index was 1.30.

### [Preparation of Inorganic Oxide Particles (C-3)]

As non-porous silica particles, commercially-available silica particle dispersion having a mean particle size of 50 nm (IPA-ST-L, by Nissan Chemical, having a silica solid concentration of 30% by mass, with a solvent of isopropyl alcohol) was diluted with isopropyl alcohol to have a silica solid concentration of 20% by mass.

[Preparation of Sol (a)]

In a reactor equipped with a stirrer and a reflux condenser, 120 parts of methyl ethyl ketone, 100 parts of acryloyloxypropyltrimethoxysilane (KBM-5103, produced by Shin-etsu Chemical Industry), and 3 parts of diisopropoxyaluminiumethyl acetacetate (trade name, Kerope EP-32 by Hope Pharmaceutical) were mixed, and 30 parts of ion-exchanged water was added to it and reacted at 60° C. for 4 hours, and then this was cooled to room temperature to obtain a sol (a). Its mass-average molecular weight was 1600. Of those over oligomer components in this, the components having a molecular weight of from 1,000 to 20,000 accounted for 100%. Its gas chromatography confirmed the absence of the starting compound, acryloyloxypropyltrimethoxysilane, in the sol. This was conditioned with methyl ethyl ketone to have a solid concentration of 29%. Thus prepared, this is a sol (a).

### [Preparation of Dispersion (A-2)]

500 parts of the hollow silica particle sol (C-2) (having a silica concentration of 20% by mass, ethanol dispersion) was subjected to solvent substitution through reduced pressure distillation under a pressure of 20 kPa with adding isopropyl alcohol thereto thereby making the resulting sol have a nearly constant silica content. To 500 parts of the thus-obtained silica dispersion (having a silica concentration of 20% by mass), added were 30 parts of acryloyloxypropyltrimethoxysilane (KBM-5103, by Shin-etsu Chemical Industry) and 1.5 parts of diisopropoxyaluminiumethyl acetate (trade name, Kerope EP-32 by Hope Pharmaceutical), and then 9 parts of ion-exchanged water was added to it. This was reacted at 60° C. for 8 hours, and then cooled to room temperature, and 1.8 parts of acetylacetone was added thereto. 500 g of the dispersion was subjected to solvent substitution through reduced pressure distillation under a pressure of 20 kPa with adding cyclohexanone thereto thereby making the resulting dispersion have a nearly constant silica content. No impurity formed in the dispersion, and when the dispersion was conditioned with cyclohexanone to have a solid concentration of 20% by mass, then its viscosity was 5 mPa·s at 25° C. The remaining amount of isopropyl alcohol in the thus-obtained dispersion (A-2) was determined through analysis with gas chromatography, and was 1.5%.

In the same manner as that for the dispersion (A-2), other dispersions (A-1) and (A-3) were prepared each containing the other inorganic particles (C-1) and (C-3), respectively.

### Example 1

### Preparation of Coating Liquids (Ln-1 to Ln-20) for Low-Refractivity Layer

The components shown in Table 3 below were mixed, and diluted with cyclohexane and methyl ethyl ketone in a ratio of 10/90 of cyclohexane/methyl ethyl ketone so that the resulting mixture could have an overall solid concentration of 5% by mass, thereby preparing coating liquids (Ln-1 to Ln-20).

In the Table, the parenthesized numeral indicates the amount of the component in terms of part by mass. IRG907 is a radical polymerization initiator, Ciba-Geigy's Irgacure 907 (trade name).

TABLE 3
Composition of Coating Liquid for Forming Low refractivity Layer

| | | Dispersion of | | |
|---|---|---|---|---|
| | | Inorganic | | |
| Coating Liquid | Fluoropolymer | Particles | Sol | Initiator |
| Ln1 (the invention) | P-3 (95) | — | sol (a) (5) | IRG907 (3) |
| Ln2 (the invention) | P-4 (95) | — | sol (a) (5) | IRG907 (3) |
| Ln3 (the invention) | P-5 (95) | — | sol (a) (5) | IRG907 (3) |
| Ln4 (comparative example) | a-2 (95) | — | sol (a) (5) | IRG907 (3) |
| Ln5 (comparative example) | a-3 (95) | — | sol (a) (5) | IRG907 (3) |
| Ln6 (the invention) | P-3 (56) | A-1 (39) | sol (a) (5) | IRG907 (3) |
| Ln7 (the invention) | P-4 (56) | A-1 (39) | sol (a) (5) | IRG907 (3) |
| Ln8 (the invention) | P-5 (56) | A-1 (39) | sol (a) (5) | IRG907 (3) |
| Ln9 (comparative example) | a-2 (56) | A-1 (39) | sol (a) (5) | IRG907 (3) |
| Ln10 (comparative example) | a-3 (56) | A-1 (39) | sol (a) (5) | IRG907 (3) |
| Ln11 (the invention) | P-3 (56) | A-2 (39) | sol (a) (5) | IRG907 (3) |
| Ln12 (the invention) | P-4 (56) | A-2 (39) | sol (a) (5) | IRG907 (3) |
| Ln13 (the invention) | P-5 (56) | A-2 (39) | sol (a) (5) | IRG907 (3) |
| Ln14 (comparative example) | a-2 (56) | A-2 (39) | sol (a) (5) | IRG907 (3) |
| Ln15 (comparative example) | a-3 (56) | A-2 (39) | sol (a) (5) | IRG907 (3) |
| Ln16 (the invention) | P-3 (56) | A-3 (39) | sol (a) (5) | IRG907 (3) |
| Ln17 (the invention) | P-4 (56) | A-3 (39) | sol (a) (5) | IRG907 (3) |
| Ln18 (the invention) | P-5 (56) | A-3 (39) | sol (a) (5) | IRG907 (3) |
| Ln19 (comparative example) | a-2 (56) | A-3 (39) | sol (a) (5) | IRG907 (3) |
| Ln20 (comparative example) | a-3 (56) | A-3 (39) | sol (a) (5) | IRG907 (3) |

### [Preparation of Coating Liquid (A) for Hard Coat Layer]

170 parts by mass of a commercial product, UV-curable resin (Kayarad DCPA-20, by Nippon Kayaku) was diluted with a mixed solvent of 135 parts by mass of methyl ethyl ketone and 15 parts by mass of cyclohexanone. Further, 10 parts by mass of a polymerization initiator (Irgacure 184, by Ciba Speciality Chemicals) was added to it, and mixed and stirred. Next, 20 parts by mass of an organosilane compound, KBM-5103 (by Shin-etsu Chemical Industry) was added to it and stirred with an air disperser for 120 minutes to completely dissolve the solute, thereby giving a hard coat layer coating liquid (A).

### [Preparation of Coating Liquid (B) for Antiglare Hard Coat Layer]

25.4 g of a mixture of dipentaerythritol pentaacrylate and dipentaerythritol hexaacrylate (DPHA, by Nippon Kayaku) was diluted with 46.3 g of methyl isobutyl ketone. Further, 1.3 g of a polymerization initiator (Irgacure 184, by Ciba Speciality Chemicals) was added to it, and mixed with stirring. Next, 0.04 g of a fluorine-containing surface modifier (FP-149) described in this specification, 5.2 g of a silane coupling agent (KBM-5103, by Shin-etsu Chemical Industry), and 0.50 g of cellulose acetate butyrate having a molecular weight of 40,000 (CAB-531-1, by Eastman Chemical) were added to it, and stirred with an air disperser for 120 minutes to thereby completely dissolve the solute. The resulting solution was applied onto a substrate and cured with UV rays, and the coating film thus formed had a refractive index of 1.520.

Finally, 21.0 g of a 30% dispersion in methyl isobutyl ketone of crosslinked poly(acryl-styrene) particles (copolymerization ratio=50/50, refractive index 1.536), which had been dispersed with a Polytron disperser at 10000 rpm for 20 minutes to have a mean particle size of 3.5 μm, was added to the solution, and then the mixture was filtered through a polypropylene filter having a pore size of 30 μm to prepare a coating liquid (B) for antiglare hard coat layer.

### [Preparation of Coating Liquid (C) for Antiglare Hard Coat Layer]

50 parts by weight of a commercial product, UV-curable resin (PETA, by Nippon Kayaku, having a refractive index of 1.51), 2 parts by weight of a photopolymerization initiator, (by Ciba-Geigy, trade name of Irgacure 184), 4 parts by weight of first translucent particles, acryl-styrene beads having a mean particle size (by Sohken Chemical, having a refractive index of 1.55), 0.5 parts by weight of second translucent particles, styrene beads having a mean particle size of 3.5 μm (by Sohken Chemical, having a refractive index of 1.60), 10 parts by weight of an organosilane compound, KBM-5103 (trade name, by Shin-etsu Chemical Industry), and 0.04 parts by weight of a fluorine-containing surface modifier (FP-149) described in this specification were mixed with 38.5 parts by weight of a solvent (toluene), and stirred with an air disperser for 10 minutes.

The mixture was filtered through a polypropylene filter having a pore size of 30 μm to prepare a coating liquid (C) for antiglare hard coat layer.

### [Fabrication of Antireflection Film (206)]

Using an ultrasonic dust remover, a triacetyl cellulose film (TD-80UF, produced by Fuji Photo Film) having a thickness of 80 μm was processed for static elimination on its side to be coated with a coating liquid. Using a die coater having a constitution mentioned below, the coating liquid (A) for hard coat layer was applied onto it, at a coating speed of 30 m/min. The coating amount of the layer was 17.5 ml/m². The reduced pressure in the vacuum chamber was 0.3 kPa. For the coating, the gap G_{L} between the downstream lip land 18b and the web W was 100 μm. The coated web was then dried at 80° C., and then irradiated with UV rays from a 160 W/cm air-cool metal halide lamp (produced by Eyegraphics) under nitrogen purging to make the ambient atmosphere have an oxygen concentration of at most 0.1% by volume. The illuminance was 400 mW/cm² and the irradiation dose was 500 mJ/cm². Thus, the coating layer was cured to be a hard coat layer having a thickness of 7 μm, and the thus-coated film was wound up.

### (Constitution of Die Coater)

The slot die 13 shown in FIG. 3A has an upstream lip land length I_{UP} of 0.5 mm, and a downstream lip land length I_{LO} of 50 μm; the length in the web-running direction of the opening of the slot 16 is 150 μm; and the slot 16 has a length of 50 mm.

The gap between the upstream lip land 18a and the web W is longer by 50 μm than the gap between the downstream lip land 18b and the web W (the overbite length is 50 μm); and the gap G_{L} between the downstream lip land 18b and the web W is 50 μm.

The gap G_{S} between the side plate 40b of the vacuum chamber 40 and the web W, and the gap G_{B} between the back plate 40a and the web W are both 200 μm.

To the thus-obtained hard coat film 206, applied was the coating liquid Ln6 for low-refractivity layer, using a microgravure roll having a gravure pattern of 180 lines/inch to a depth of 40 μm and having a diameter of 50 mm, and a doctor blade. The number of the gravure roll revolution was 30 rpm, and the film traveling speed was 15 m/min. This was dried at 120° C. for 150 seconds, and then at 140° C. for 8 minutes, and then irradiated with UV rays from a 240 W/cm air-cool metal halide lamp (produced by Eyegraphics) under nitrogen purging. The illuminance was 400 mW/cm² and the irradiation dose was 900 mJ/cm². Thus, a low-refractivity layer having a thickness of 100 nm was formed to complete an antireflection film (206).

### [Fabrication of Antireflection Films (201) to (205), and (207) to (220)]

Antireflection films (201) to (205), and (207) to (220) were fabricated in the same manner as that for the antireflection film (206), for which, however, the low-refractivity layer coating liquid (Ln6) used for the antireflection film (206) was changed to (Ln1) to (Ln5), and (Ln7) to (Ln20), respectively.

### [Fabrication of Antiglare Antireflection Films (301), (311)]

Antireflection films (301) and (311) were fabricated in the same manner as that for the antireflection films (201) and (211), for which, however, the hard coat coating liquid (A) used in the step of forming the hard coat layer in the fabrication of antireflection films (201) and (211) was changed to the antiglare hard coat layer forming liquid (B) and the reduced pressure in the vacuum chamber was changed to 0.5 kPa.

### [Fabrication of Antiglare Antireflection Film (411)]

Using an ultrasonic dust remover, a triacetyl cellulose film (TD-80UF, produced by Fuji Photo Film) having a thickness of 80 μm was processed for static elimination on its side to be coated with a coating liquid. To this, applied was the above-mentioned, antiglare hard coat layer coating liquid (C), using a microgravure roll having a gravure pattern of 135 lines/inch to a depth of 60 μm and having a diameter of 50 mm, and a doctor blade. The film traveling speed was 10 m/min. This was dried at 60° C. for 150 seconds, and then irradiated with UV rays from a 160 W/cm air-cool metal halide lamp (produced by Eyegraphics) under nitrogen purging. The illuminance was 400 mW/cm², and the irradiation dose was 100 mJ/cm². The coating layer was thus cured to give an antiglare hard coat layer. Thus coated, the film was wound up. The number of the gravure roll revolution was so controlled that the thickness of the cured antiglare hard coat layer could be 6.0 μm, and a hard coat film (411) was thus fabricated. A low refractivity layer coating liquid (Ln11) was applied onto it and cured thereon in the same manner as that for the other samples, and an antireflection film (411) was thus fabricated.

### (Saponification of Antireflection Film)

Thus obtained, the antireflection films were saponified under a standard saponification condition mentioned below, and dried.

### (1) Alkali Bath:

Aqueous, 1.5 mol/liter sodium hydroxide solution,

55° C.-120 seconds.

### (2) First Rinsing Bath:

Tap water,

60 seconds.

### (3) Neutralization Bath:

0.05 mol/liter sulfuric acid,

30° C.-20 seconds.

### (4) Second Rinsing Bath:

Tap water,

60 seconds.

### (5) Drying:

120° C.,

60 seconds.

### [Quality Evaluation of Coated Films]

Thus obtained, the antireflection film samples (201) to (220), (301), (311) and (411) were evaluated for their properties mentioned below. The results are shown in Table 4, Table 5 and Table 6.

### (1) Mean Refractivity:

The back of each film sample was roughened with sand paper, and then processed with black ink to remove back reflection. The mirror spectral reflectivity of the surface of the thus-processed film sample was measured at an incident angle of 5° within a wavelength range of from 380 to 780 nm, using a spectrophotometer (by Nippon Bunkoh). The result was given as an arithmetic mean value of the mirror reflectance at 450 to 650 nm.

### (2) Pencil Hardness:

The antireflection film was conditioned at a temperature of 25° C. and at a humidity of 60% RH, and then tested for the pencil hardness thereof according to JIS K5400.

### (3) Scratch Resistance Test:

Using a steel wool abrasive #0000, the film surface was rubbed 10 times under a load of 500 g, and then the level at which the surface was scratched was confirmed. The tested films were evaluated according to the following criteria.

A: No scratch at all.

B: Fine scratches found.

C: Fine scratched found more remarkably.

D: Scratches remarkable.

### (4) Resistance to Fingerprint and Felt Pen Ink:

This is to demonstrate the stain resistance of the surface of the films. The film samples were conditioned at a temperature of 25° C. and at a humidity of 60% RH for 2 hours. Then, a fingerprint and felt pen ink were given to the surface of the sample, and then they were wiped off by a piece of cleaning cloth reciprocated three times. Thus cleaned up, the surface was observed, and the samples were evaluated for their stain resistance to fingerprint and felt pen ink.

A: Fingerprint and felt pen ink completely wiped away.

B: some fingerprint and felt pen ink remained as visible.

C: Almost all fingerprint and felt pen ink could not be wiped away.

According to the foregoing evaluation criteria, B or higher grades were of practically preferable levels.

### (5) Haze:

The whole haze (H), the inner haze (Hi) and the surface haze (Hs) of the films obtained herein were measured according to the method mentioned below.

[1] The whole haze (H) of the film is measured according to JIS-K7136.

[2] Some drops of silicone oil are applied to the surface of the low-refractivity layer and the back of the film, and the film is sandwiched between two glass plates having a thickness of 1 mm (micro slide glass Lot. No. S 9111, by Matsunami), whereby the two glass plates and the film are completely optically adhered to each other. With the surface haze removed in that condition, the haze of the film is measured. Silicone oil alone is sandwiched between the two glass plates and the haze of the combined structure is measured. The latter haze value is subtracted from the former haze value, and this is the inner haze (Hi) of the film.

[3] The inner haze (Hi) computed in the above [2] is subtracted from the whole haze (H) measured in the above [1], and this is the surface haze (Hs) of the film.

### (6) Image Sharpness:

According to JIS K7105, the transmitted image sharpness through the film is measured at an optical comb width of 0.5 mm.

### (7) Center Line Average Height:

According to JIS-B0601, the center line average height Ra of the film is measured.

### (8) Antiglare Property:

Light from a nude fluorescent lamp with no louver (8000 cd/m²) is reflected on the film at an angle or 45 degrees, and the reflected image is observed in the direction of an angle of −45 degrees, and the degree of the blurred reflected image is evaluated according to the following criteria:

A: The outline of the fluorescent light is not seen at all.

B: The outline of the fluorescent light is seen slightly.

C: Though the fluorescent light is blurred, its outline is seen.

D: The fluorescent light is not almost blurred at all.

TABLE 4

| Antireflection | Low-Refractivity Layer | Refractive Index of | Mean | Pencil | Scratch | Fingerprint | Felt Pen Ink |
|---|---|---|---|---|---|---|---|
| Film | Coating Liquid | Low-Refractivity Layer | Reflectance | Hardness | Resistance | Resistance | Resistance |
| 201 (the invention) | Ln1 | 1.42 | 1.89 | 3H | B | A | A |
| 202 (the invention) | Ln2 | 1.43 | 1.91 | 3H | B | A | A |
| 203 (the invention) | Ln3 | 1.42 | 1.90 | 3H | B | A | A |
| 204 (comparative example) | Ln4 | 1.43 | 1.97 | H or less | D | A | A |
| 205 (comparative example) | Ln5 | 1.42 | 1.93 | 3H | B | C | C |
| 206 (the invention) | Ln6 | 1.38 | 1.57 | 3H | A | B | B |
| 207 (the invention) | Ln7 | 1.39 | 1.58 | 3H | A | B | B |
| 208 (the invention) | Ln8 | 1.37 | 1.58 | 3H | A | B | B |
| 209 (comparative example) | Ln9 | 1.37 | 1.56 | H or less | D | B | B |
| 210 (comparative example) | Ln10 | 1.38 | 1.57 | 3H | A | C | C |
| 211 (the invention) | Ln11 | 1.38 | 1.55 | 3H | A | B | B |
| 212 (the invention) | Ln12 | 1.37 | 1.58 | 3H | A | B | B |
| 213 (the invention) | Ln13 | 1.36 | 1.58 | 3H | A | B | B |
| 214 (comparative example) | Ln14 | 1.37 | 1.58 | H or less | D | B | B |
| 215 (comparative example) | Ln15 | 1.38 | 1.58 | 3H | A | C | C |
| 216 (the invention) | Ln16 | 1.46 | 1.93 | 3H | A | B | B |
| 217 (the invention) | Ln17 | 1.46 | 1.97 | 3H | A | B | B |
| 218 (the invention) | Ln18 | 1.46 | 1.96 | 3H | A | B | B |
| 219 (comparative example) | Ln19 | 1.46 | 1.91 | H or less | D | B | B |
| 220 (comparative example) | Ln20 | 1.46 | 1.95 | 3H | A | C | C |

TABLE 5
Optical Properties of Antiglare Antireflection Film

| Antiglare | | | | | | | |
|---|---|---|---|---|---|---|---|
| Antireflection | Mean | Inner Haze | Surface Haze | Whole Haze | | Image | Antiglare |
| Film | Reflectance (%) | (%) | (%) | (%) | Ra (μm) | Sharpness (%) | Property |
| 301 (the | 1.87 | 10.0 | 5.2 | 15.2 | 0.18 | 15.3 | A |
| invention) | | | | | | | |
| 311 (the | 1.61 | 10.2 | 4.9 | 15.1 | 0.18 | 16.2 | A |
| invention) | | | | | | | |
| 411 (the | 1.63 | 35.0 | 5.9 | 40.9 | 0.20 | 15.0 | A |
| invention) | | | | | | | |

TABLE 6
Scratch Resistance and Stain Resistance of Antiglare Antireflection Film

| Antiglare | | | | |
|---|---|---|---|---|
| Antireflection | Pencil | Scratch | Fingerprint | Felt Pen Ink |
| Film | Hardness | Resistance | Resistance | Resistance |
| 301 (the invention) | 3H | B | A | A |
| 311 (the invention) | 3H | A | A | A |
| 411 (the invention) | 3H | A | A | A |

The results in this Example confirm that the antireflection film samples of the invention (201) to (203), (206) to (208), (211) to (213), (216) to (218) have better scratch resistance and better stain resistance than the comparative samples (204), (205), (209), (210), (214), (215), (219), (220) not satisfying the requirements of the invention, and have favorable antireflection capability suitable to antireflection films. In particular, it is understood that the samples (206) to (215) having hollow silica particles or porous silica particles are better as having a lower reflectivity.

The samples of the invention (301), (311), (411) where a low-refractivity layer and an antiglare hard coat layer are combined have favorable antiglare capability, not losing their scratch resistance and stain resistance at all.

### Example 2

### Preparation of Coating Liquids (Ln401 to 409) for Forming Low Refractivity Layer

Coating liquids (Ln401 to 409) were prepared by mixing each ingredient shown in Table 7 below and diluting the mixture with cyclohexane and methyl ethyl ketone in such a manner that the solid concentration of the entire coating liquid is 5% by mass and the ratio of cyclohexane to methyl ethyl ketone is 10:90.

TABLE 7

| | | Inorganic Fine | | | |
|---|---|---|---|---|---|
| | | Particle | | Polyfunctional | |
| Coating Liquid | Fluoropolymer | Dispersion | Sol | Acrylate | Initiator |
| Ln401 (The Invention) | P-2 (90) | — | Sol a (5) | DPHA (5) | IRG 369 (3) |
| Ln402 (The Invention) | P-2 (85) | MEK-ST-L (5) | Sol a (5) | DPHA (5) | IRG 369 (3) |
| Ln403 (The Invention) | P-2 (85) | MEK-ST (5) | Sol a (5) | DPHA (5) | IRG 369 (3) |
| Ln404 (The Invention) | P-2 (51) | A-2 (39) | Sol a (5) | DPHA (5) | IRG 369 (3) |
| Ln405 (The Invention) | P-2 (46) | A-2 (39) | Sol a (5) | DPHA (5) | IRG 369 (3) |
| | | MEK-ST-L (5) | | | |
| Ln406 (The Invention) | P-2 (51) | A-2 (39) | Sol a (5) | DPHA (5) | IRG 184 (3) |
| Ln407 (The Invention) | P-2 (51) | A-2 (39) | Sol a (5) | DPHA (5) | IRG 907 (3) |
| Ln408 (The Invention) | P-2 (51) | A-2 (39) | Sol a (5) | DPHA (5) | IRGOXE01 (3) |
| Ln409 (The Invention) | P-2 (51) | A-2 (39) | Sol a (5) | DPHA (5) | KIP 150 (3) |

In the table, the values in the parentheses represent parts by mass of the solid component for each ingredient.

The compounds used are shown hereinafter.

MEK-ST (a product of Nissan Chemical Industries, Ltd., solid concentration of silica: 30% by mass, solvent: methyl ethyl ketone, average particle size: 12 nm)
MEK-ST-L (a product of Nissan Chemical Industries, Ltd., belonging to the MEK-ST products group with a different particle size from that of MEK-ST, solid concentration of silica: 30% by mass, solvent: methyl ethyl ketone, average particle size: 50 nm)
Polymerization initiator: IRG 184 (Irgacure 184, a product of Ciba Specialty Chemicals, molecular weight: 204), IRG 907 (Irgacure 907, a product of Ciba Specialty Chemicals K. K., molecular weight: 279), IRG 369 (Irgacure 369, a product of Ciba Specialty Chemicals K. K., molecular weight: 367), IRGOXE 01 (Irgacure OXE 01, a product of Ciba Specialty Chemicals K. K, molecular weight: 451), KIP 150 (Ezacure KIP 150, a product of Fratelli Lamberti Co., Ltd), oligo(2-hydroxy-2-methyl-1-(4-(1-methylvinyl)phenyl)propane), n=4-6, average molecular weight: about 1000)
DPHA (a mixture of dipentaerithritol hexaacrylate and dipentaerithritol pentaacrylate, a product of Nippon Kayaku Co., Ltd.)
Sol a: the same as in Preparation of Sol (a) above

### [Fabrication of Antireflection Film (501)]

Hard Coat Film 501 was fabricated in the same manner as in Hard Coat Film 206 except that, in the fabrication of Hard Coat Film 206 of Example 1, the coating liquid for forming hard coat layer was changed to Coating Liquid B for Forming Antiglare Hard Coat Layer.

On Hard Coat Film 501 obtained in this manner, Coating Liquid Ln 401 for Forming Low-refractivity Layer was coated by using a doctor blade and a microgravure roll of 50 mm in diameter having a gravure pattern with a line number of 180 per inch and a depth of 40 μm at the rotation of the roll of 30 rpm and with a feeding speed of 15 m/min, and then dried for 150 sec at 120° C. Thereafter, the coated layer was irradiated with ultraviolet rays under a nitrogen-purged atmosphere by using an air-cooled metallic halide lamp of 240 W/cm (made by Eyegraphics Co., Ltd.) at an illuminance of 400 mW/cm² and an exposure of 400 mJ/cm², thereby forming a low-refractivity layer with a thickness of 95 nm. In this way Antireflection Film (501) was fabricated.

### [Fabrication of Antireflection Films (502) to (509)]

Antireflection Films 502 to 509 were fabricated in the same manner as in Antireflection Film (501) except that, in the fabrication of Antireflection Film (501), the coating liquid for forming low-refractivity layer Ln401 was changed to Coating Liquids Ln402 to Ln409.

### [Performance Evaluation of Coated Films]

Antireflection film samples (501) to (509) thus obtained were evaluated for their properties mentioned below in addition to the evaluation in Example 1.

(9) Resistance to Rubbing with Gum Eraser

By using a rubbing tester, a rubbing test was conducted under the following conditions.

Environmental conditions for evaluation: 25° C., 60% RH

Rubbing material: Plastic eraser (MONO, a product of Tombow Pencil Co., Ltd), fixed at the rubbing tip (1 cm×1 cm) of the tester in contact with the sample

Shifting distance (one way): 4 cm

Rubbing speed: 2 cm/sec

Load: 100 to 800 g/cm²

Contact area at the tip: 1 cm×1 cm

Number of rubbing: 100 reciprocations

Evaluation is made by coating an oil-based black ink on the rear side of the sample after the rubbing and visually observing the damage at the rubbed portion with reflection light or examining the difference in the amount of reflected light between the rubbed portion and non-rubbed portion.

A: No damage is seen even when observed extremely carefully.

AB: Weak damages are faintly seen when observed extremely carefully.

B: Weak damages are seen.

BC: Damages of medium degree are seen.

C: There are damages recognizable at a glance.

CC: The whole area is damaged.

The load was increased from 100 g/cm² to 800 g/cm² with a step of 100 g/cm², and the resistance to rubbing with gum eraser was evaluated in terms of such a load that gives an evaluation of grade AB or better defined above. Practically, a load of at least 300 g/cm² is required, and higher load values thus defined are more preferred.

The evaluation results are shown in Table 8.

TABLE 8

| | | | | | Resistance to | |
|---|---|---|---|---|---|---|
| Antireflection | Low-Refractivity Layer | Refractivity of | Mean | Scratch | Eraser | Fingerprint |
| film | Coating Liquid | Low-Refractivity Layer | Reflectance | Resistance | Rubbing | Resistance |
| 501 (The Invention) | Ln501 | 1.42 | 1.89 | B | 400 | A |
| 502 (The Invention) | Ln502 | 1.43 | 1.91 | A | 700 | A |
| 503 (The Invention) | Ln503 | 1.43 | 1.91 | B | 500 | A |
| 504 (The Invention) | Ln504 | 1.38 | 1.61 | A | 600 | A |
| 505 (The Invention) | Ln505 | 1.39 | 1.62 | A | 800 | A |
| 506 (The Invention) | Ln506 | 1.38 | 1.61 | B | 300 | B |
| 507 (The Invention) | Ln507 | 1.38 | 1.61 | B | 500 | A |
| 508 (The Invention) | Ln508 | 1.38 | 1.61 | A | 700 | A |
| 509 (The Invention) | Ln509 | 1.38 | 1.61 | A | 700 | A |

From the present examples, it is seen that the samples containing inorganic fine particles satisfying the proffered definition of the invention in the low-refractivity layer exhibit improved resistance to rubbing with gum eraser, and that scratch resistance and resistance to rubbing with gum eraser can be improved by increasing the molecular weight of the photo-polymerization initiator used for the layer.

The antireflection film of the invention was used for a polarizing plate, and applied to a liquid-crystal display device so as to be located on its outermost surface. The image display device preventing external light reflection and having an extremely high visibility is obtained.

### INDUSTRIAL APPLICABILITY

The antireflection film of the invention has a sufficient antireflection property and has excellent scratch resistance and stain resistance. The image display device comprising the antireflection film of the invention, and the image display device comprising the polarizing plate with the antireflection film of the invention are free from problems of external light reflection and ambient scene reflection thereon and have an extremely high visibility.

1. An antireflection film comprising:
a transparent support; and
a low-refractivity layer as an outermost layer of the antireflection film, the low-refractivity layer being formed by a fluoropolymer-containing composition,
wherein the fluoropolymer is a copolymer represented by formula (1) in which its backbone chain comprises only carbon atoms: 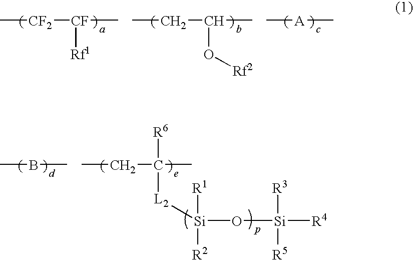
wherein Rf¹ represents a perfluoroalkyl group having from 1 to 5 carbon atoms; Rf² represents a linear, branched or alicyclic structure-having fluoroalkyl group having from 1 to 30 carbon atoms and optionally having an ether bond; A represents a constitutive unit having a reactive group capable of participating in crosslinking reaction; B represents a constitutive component; R¹ and R² may be the same or different, each representing an alkyl group or an aryl group; p indicates an integer of from 10 to 500; R³ to R⁵ each independently represent a substituted or unsubstituted monovalent organic group or a hydrogen atom; R⁶ represents a hydrogen atom or a methyl group; L₂ represents a linking group having from 1 to 20 carbon atoms, or a single bond; a to d each indicate molar fraction (%) of the respective constitutive components except the polysiloxane-containing polymerization unit, satisfying 10≦a+b≦55, 10≦a≦55, 0≦b≦45, 10≦c≦50, 0≦d≦40; e indicates a mass fraction (%) of the polysiloxane-containing polymerization unit to the mass of all the other components, satisfying 0.01≦e≦20.

2. The antireflection film as claimed in claim 1,
wherein the low-refractivity layer comprises at least one type of inorganic particles having a mean particle size of from 30% to 100% of a thickness of the low-refractivity layer.

3. The antireflection film as claimed in claim 2,
wherein the inorganic particles are hollow silica particles having a refractive index of from 1.17 to 1.40.

4. The antireflection film as claimed in claim 1,
wherein the reactive group capable of participating in crosslinking reaction in the fluoropolymer is a (meth)acryloyl group.

5. The antireflection film as claimed in claim 1,
wherein the fluoropolymer-containing composition further comprises a monomer having a tri-functional or more poly-functional group capable of curing with ionizing radiation in one molecule.

6. The antireflection film as claimed in claim 1,
wherein the fluoropolymer has a number-average molecular weight of 20,000 or more.

7. A polarizing plate comprising:
a polarizer; and
two protective films for protecting both sides of the polarizer,
wherein one of the two protective films is an antireflection film of claim 1.

8. An image display device comprising an antireflection film of claim 1 as the outermost surface of a display panel.

9. An image display comprising a polarizing plate of claim 7 as the outermost surface of a display panel.
